(19) United States
(12) Patent Application Publication
(10) Pub. No.: US 2023/0328285 A1
(43) Pub. Date: Oct. 12, 2023

(54) POINT CLOUD DATA TRANSMISSION METHOD, POINT CLOUD DATA TRANSMISSION DEVICE, POINT CLOUD DATA RECEPTION METHOD, AND POINT CLOUD DATA RECEPTION DEVICE

(71) Applicant: LG ELECTRONICS INC., Seoul (KR)

(72) Inventors: Hyunmook OH, Seoul (KR); Sejin OH, Seoul (KR)

(21) Appl. No.: 18/026,926

(22) PCT Filed: Sep. 17, 2021
(86) PCT No.: PCT/KR2021/012840

§ 371 Date: Mar. 17, 2023

(30) Foreign Application Priority Data
Sep. 17, 2020 (KR) 10-2020-0119774

(51) Int. Cl. H04N 19/60; H04N 19/597; H04N 19/17; H04N 19/70

(52) U.S. Cl. CPC H04N 19/60; H04N 19/597; H04N 19/17; H04N 19/70; H04N 19/13

(57) ABSTRACT

A point cloud data transmission method according to embodiments may comprise the steps of: encoding point cloud data; and transmitting a bitstream including the point cloud data. In addition, a point cloud data transmission device according to embodiments may comprise: an encoder for encoding point cloud data; and a transmitter for transmitting a bitstream including the point cloud data. In addition, a point cloud data reception method according to embodiments may comprise the steps of: receiving a bitstream including point cloud data; and decoding the point cloud data. In addition, a point cloud data reception device according to embodiments may comprise: a reception unit for receiving a bitstream including point cloud data; and a decoder for decoding the point cloud data.

A point cloud data transmission method according to embodiments may comprise the steps of: encoding point cloud data; and transmitting a bitstream including the point cloud data. In addition, a point cloud data transmission device according to embodiments may comprise: an encoder for encoding point cloud data; and a transmitter for transmitting a bitstream including the point cloud data. In addition, a point cloud data reception method according to embodiments may comprise the steps of: receiving a bitstream including point cloud data; and decoding the point cloud data. In addition, a point cloud data reception device according to embodiments may comprise: a reception unit for receiving a bitstream including point cloud data; and a decoder for decoding the point cloud data.

### TECHNICAL FIELD

Embodiments relate to a method and device for processing point cloud content.

### BACKGROUND

Point cloud content is content represented by a point cloud, which is a set of points belonging to a coordinate system representing a three-dimensional space. The point cloud content may express media configured in three dimensions, and is used to provide various services such as virtual reality (VR), augmented reality (AR), mixed reality (MR), and self-driving services. However, tens of thousands to hundreds of thousands of point data are required to represent point cloud content. Therefore, there is a need for a method for efficiently processing a large amount of point data.

### SUMMARY

Embodiments provide a device and method for efficiently processing point cloud data. Embodiments provide a point cloud data processing method and device for addressing latency and encoding/decoding complexity.

The technical scope of the embodiments is not limited to the aforementioned technical objects, and may be extended to other technical objects that may be inferred by those skilled in the art based on the entire contents disclosed herein.

To achieve these objects and other advantages and in accordance with the purpose of the disclosure, as embodied and broadly described herein, a method of transmitting point cloud data may include encoding the point cloud data, and transmitting a bitstream containing the point cloud data. A method of receiving point cloud data according to embodiments may include receiving a bitstream containing point cloud data and decoding the point cloud data.

Devices and methods according to embodiments may process point cloud data with high efficiency.

The devices and methods according to the embodiments may provide a high-quality point cloud service.

The devices and methods according to the embodiments may provide point cloud content for providing general-purpose services such as a VR service and a self-driving service.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. For a better understanding of various embodiments described below, reference should be made to the description of the following embodiments in connection with the accompanying drawings. The same reference numbers will be used throughout the drawings to refer to the same or like parts. In the drawings:

FIG. 1 shows an exemplary point cloud content providing system according to embodiments;

FIG. 2 is a block diagram illustrating a point cloud content providing operation according to embodiments;

FIG. 3 illustrates an exemplary process of capturing a point cloud video according to embodiments;

FIG. 4 illustrates an exemplary point cloud encoder according to embodiments;

FIG. 5 shows an example of voxels according to embodiments;

FIG. 6 shows an example of an octree and occupancy code according to embodiments;

FIG. 7 shows an example of a neighbor node pattern according to embodiments;

FIG. 8 illustrates an example of point configuration in each LOD according to embodiments;

FIG. 9 illustrates an example of point configuration in each LOD according to embodiments;

FIG. 10 illustrates a point cloud decoder according to embodiments;

FIG. 11 illustrates a point cloud decoder according to embodiments;

FIG. 12 illustrates a transmission device according to embodiments;

FIG. 13 illustrates a reception device according to embodiments;

FIG. 14 illustrates an exemplary structure operable in connection with point cloud data transmission/reception methods/devices according to embodiments;

FIG. 15 is an exemplary block diagram illustrating a point cloud data transmission device according to embodiments;

FIG. 16 is an exemplary block diagram illustrating a point cloud data reception device according to embodiments;

FIG. 17 illustrates an example of coordinate conversion of point cloud data according to embodiments;

FIG. 18 shows an example of a fan-shaped coordinate system according to embodiments;

FIG. 19 illustrates an example of a coordinate transformation process of point cloud data according to embodiments;

FIG. 20 illustrates an example of a coordinate system projection process of point cloud data according to embodiments;

FIG. 21 schematically illustrates a LiDAR structure for acquiring point cloud data according to embodiments;

FIG. 22 shows a head position of LiDAR and a position of laser according to embodiments;

FIG. 23 illustrates projected point cloud data according to embodiments;

FIG. 24 illustrates a method of using position index information in inverse projection according to embodiments;

FIG. 25A shows an example of encoded point cloud data according to embodiments;

FIG. 25B shows an example of syntax of a sequence parameter set according to embodiments;

FIG. 26 shows an example of syntax of a tile inventory according to embodiments;

FIG. 27 shows an example of syntax of a general attribute slice bitstream and an attribute slice header according to embodiments;

FIGS. 28 and 29 show an example of syntax of projection info according to embodiments;

FIG. 30 shows a table indicating improvement in prediction-lift transform attribute coding performance by coordinate transformation according to embodiments;

FIG. 31 shows a table indicating improvement in RAHT transform attribute coding performance by coordinate transformation according to embodiments;

FIG. 32 shows an example of syntax of an attribute parameter set according to embodiments;

FIG. 33 illustrates an example of converting point cloud data into indexes according to embodiments;

FIG. 34 shows an example of a method of approximating point cloud data according to embodiments;

FIG. 35 illustrates an example of a method of maintaining an index interval based on a scale factor for point cloud data according to embodiments;

FIG. 36 illustrates an example of a laser index-based neighbor point search method for point cloud data according to embodiments;

FIG. 37 illustrates an example of converting point cloud data into indexes according to embodiments;

FIG. 38 illustrates an example of a method of approximating point cloud data according to embodiments;

FIG. 39 illustrate that the azimuthal angles of lasers included in a LiDAR according to embodiments are different from each other;

FIG. 40 illustrates an example of a method of grouping point cloud data according to embodiments;

FIG. 41 shows an example of syntax of a sequence parameter set according to embodiments;

FIG. 42 shows an example of syntax of a geometry parameter set according to embodiments;

FIG. 43 shows an example of syntax of an attribute parameter set according to embodiments;

FIG. 44 shows an example of syntax of a general geometry slice bitstream and a geometry slice header according to embodiments;

FIG. 45 shows an example of syntax of a general attribute slice bitstream and an attribute slice header according to embodiments;

FIGS. 46 to 48 show an example of syntax of projection info according to embodiments;

FIGS. 49A and 49B are block diagrams illustrating a point cloud data transmission device according to embodiments;

FIG. 50 illustrates an example of a method of transmitting point cloud data according to embodiments;

FIGS. 51A and 51B are block diagrams illustrating a point cloud data reception device according to embodiments;

FIG. 52 shows an example of a method of receiving point cloud data according to embodiments;

FIG. 53 illustrates an example of a method of transmitting point cloud data according to embodiments; and

FIG. 54 illustrates an example of a method of receiving point cloud data according to embodiments.

### DETAILED DESCRIPTION

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that may be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

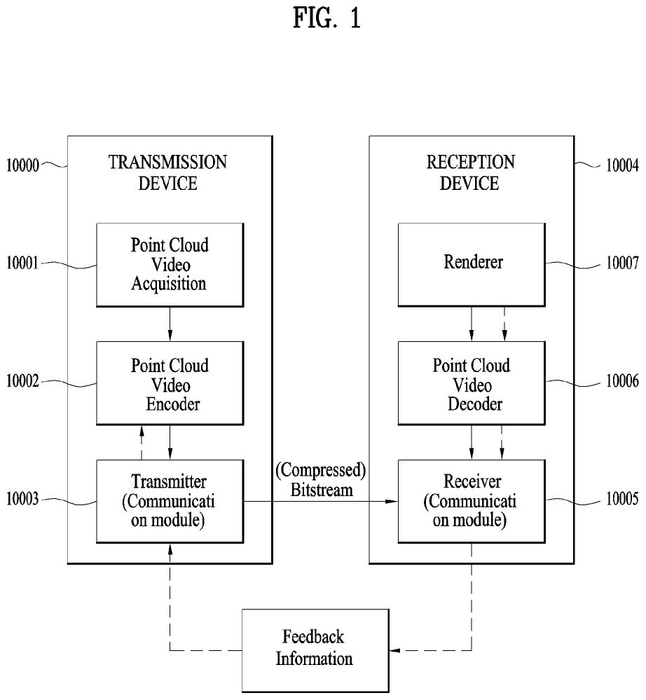

FIG. 1 shows an exemplary point cloud content providing system according to embodiments.

The point cloud content providing system illustrated in FIG. 1 may include a transmission device 10000 and a reception device 10004. The transmission device 10000 and the reception device 10004 are capable of wired or wireless communication to transmit and receive point cloud data.

The point cloud data transmission device 10000 according to the embodiments may secure and process point cloud video (or point cloud content) and transmit the same. According to embodiments, the transmission device 10000 may include a fixed station, a base transceiver system (BTS), a network, an artificial intelligence (AI) device and/or system, a robot, an AR/VR/XR device and/or server. According to embodiments, the transmission device 10000 may include a device, a robot, a vehicle, an AR/VR/XR device, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The transmission device 10000 according to the embodiments includes a point cloud video acquirer 10001, a point cloud video encoder 10002, and/or a transmitter (or communication module) 10003.

The point cloud video acquirer 10001 according to the embodiments acquires a point cloud video through a processing process such as capture, synthesis, or generation. The point cloud video is point cloud content represented by a point cloud, which is a set of points positioned in a 3D space, and may be referred to as point cloud video data or point cloud data. The point cloud video according to the embodiments may include one or more frames. One frame represents a still image/picture. Therefore, the point cloud video may include a point cloud image/frame/picture, and may be referred to as a point cloud image, frame, or picture.

The point cloud video encoder 10002 according to the embodiments encodes the acquired point cloud video data. The point cloud video encoder 10002 may encode the point cloud video data based on point cloud compression coding. The point cloud compression coding according to the embodiments may include geometry-based point cloud compression (G-PCC) coding and/or video-based point cloud compression (V-PCC) coding or next-generation coding. The point cloud compression coding according to the embodiments is not limited to the above-described embodiment. The point cloud video encoder 10002 may output a bitstream containing the encoded point cloud video data. The bitstream may contain not only the encoded point cloud video data, but also signaling information related to encoding of the point cloud video data.

The transmitter 10003 according to the embodiments transmits the bitstream containing the encoded point cloud video data. The bitstream according to the embodiments is encapsulated in a file or segment (for example, a streaming segment), and is transmitted over various networks such as a broadcasting network and/or a broadband network. Although not shown in the figure, the transmission device 10000 may include an encapsulator (or an encapsulation module) configured to perform an encapsulation operation. According to embodiments, the encapsulator may be included in the transmitter 10003. According to embodiments, the file or segment may be transmitted to the reception device 10004 over a network, or stored in a digital storage medium (e.g., USB, SD, CD, DVD, Blu-ray, HDD, SSD, etc.). The transmitter 10003 according to the embodiments is capable of wired/wireless communication with the reception device 10004 (or the receiver 10005) over a network of 4G, 5G, 6G, etc. In addition, the transmitter may perform a necessary data processing operation according to the network system (e.g., a 4G, 5G or 6G communication network system). The transmission device 10000 may transmit the encapsulated data in an on-demand manner.

The reception device 10004 according to the embodiments includes a receiver 10005, a point cloud video decoder 10006, and/or a renderer 10007. According to embodiments, the reception device 10004 may include a device, a robot, a vehicle, an AR/VR/XR device, a portable device, a home appliance, an Internet of Things (IoT) device, and an AI device/server which are configured to perform communication with a base station and/or other wireless devices using a radio access technology (e.g., 5G New RAT (NR), Long Term Evolution (LTE)).

The receiver 10005 according to the embodiments receives the bitstream containing the point cloud video data or the file/segment in which the bitstream is encapsulated from the network or storage medium. The receiver 10005 may perform necessary data processing according to the network system (for example, a communication network system of 4G, 5G, 6G, etc.). The receiver 10005 according to the embodiments may decapsulate the received file/segment and output a bitstream. According to embodiments, the receiver 10005 may include a decapsulator (or a decapsulation module) configured to perform a decapsulation operation. The decapsulator may be implemented as an element (or component) separate from the receiver 10005.

The point cloud video decoder 10006 decodes the bitstream containing the point cloud video data. The point cloud video decoder 10006 may decode the point cloud video data according to the method by which the point cloud video data is encoded (for example, in a reverse process of the operation of the point cloud video encoder 10002). Accordingly, the point cloud video decoder 10006 may decode the point cloud video data by performing point cloud decompression coding, which is the inverse process of the point cloud compression. The point cloud decompression coding includes G-PCC coding.

The renderer 10007 renders the decoded point cloud video data. The renderer 10007 may output point cloud content by rendering not only the point cloud video data but also audio data. According to embodiments, the renderer 10007 may include a display configured to display the point cloud content. According to embodiments, the display may be implemented as a separate device or component rather than being included in the renderer 10007.

The arrows indicated by dotted lines in the drawing represent a transmission path of feedback information acquired by the reception device 10004. The feedback information is information for reflecting interactivity with a user who consumes the point cloud content, and includes information about the user (e.g., head orientation information, viewport information, and the like). In particular, when the point cloud content is content for a service (e.g., self-driving service, etc.) that requires interaction with the user, the feedback information may be provided to the content transmitting side (e.g., the transmission device 10000) and/or the service provider. According to embodiments, the feedback information may be used in the reception device 10004 as well as the transmission device 10000, or may not be provided.

The head orientation information according to embodiments is information about the user's head position, orientation, angle, motion, and the like. The reception device 10004 according to the embodiments may calculate the viewport information based on the head orientation information. The viewport information may be information about a region of a point cloud video that the user is viewing. A viewpoint is a point through which the user is viewing the point cloud video, and may refer to a center point of the viewport region. That is, the viewport is a region centered on the viewpoint, and the size and shape of the region may be determined by a field of view (FOV). Accordingly, the reception device 10004 may extract the viewport information based on a vertical or horizontal FOV supported by the device in addition to the head orientation information. Also, the reception device 10004 performs gaze analysis or the like to check the way the user consumes a point cloud, a region that the user gazes at in the point cloud video, a gaze time, and the like. According to embodiments, the reception device 10004 may transmit feedback information including the result of the gaze analysis to the transmission device 10000. The feedback information according to the embodiments may be acquired in the rendering and/or display process. The feedback information according to the embodiments may be secured by one or more sensors included in the reception device 10004. According to embodiments, the feedback information may be secured by the renderer 10007 or a separate external element (or device, component, or the like). The dotted lines in FIG. 1 represent a process of transmitting the feedback information secured by the renderer 10007. The point cloud content providing system may process (encode/decode) point cloud data based on the feedback information. Accordingly, the point cloud video data decoder 10006 may perform a decoding operation based on the feedback information. The reception device 10004 may transmit the feedback information to the transmission device 10000. The transmission device 10000 (or the point cloud video data encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) the entire point cloud data, and provide point cloud content to the user.

According to embodiments, the transmission device 10000 may be called an encoder, a transmission device, a transmitter, or the like, and the reception device 10004 may be called a decoder, a receiving device, a receiver, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to the point cloud data.

The elements of the point cloud content providing system illustrated in FIG. 1 may be implemented by hardware, software, a processor, and/or a combination thereof.

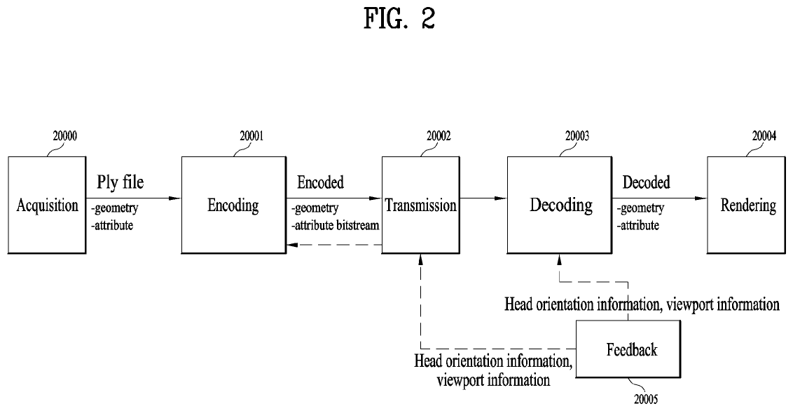

FIG. 2 is a block diagram illustrating a point cloud content providing operation according to embodiments.

The block diagram of FIG. 2 shows the operation of the point cloud content providing system described in FIG. 1. As described above, the point cloud content providing system may process point cloud data based on point cloud compression coding (e.g., G-PCC).

The point cloud content providing system according to the embodiments (for example, the point cloud transmission device 10000 or the point cloud video acquirer 10001) may acquire a point cloud video (20000). The point cloud video is represented by a point cloud belonging to a coordinate system for expressing a 3D space. The point cloud video according to the embodiments may include a Ply (Polygon File format or the Stanford Triangle format) file. When the point cloud video has one or more frames, the acquired point cloud video may include one or more Ply files. The Ply files contain point cloud data, such as point geometry and/or attributes. The geometry includes positions of points. The position of each point may be represented by parameters (for example, values of the X, Y, and Z axes) representing a three-dimensional coordinate system (e.g., a coordinate system composed of X, Y and Z axes). The attributes include attributes of points (e.g., information about texture, color (in YCbCr or RGB), reflectance r, transparency, etc. of each point). A point has one or more attributes. For example, a point may have an attribute that is a color, or two attributes that are color and reflectance. According to embodiments, the geometry may be called positions, geometry information, geometry data, or the like, and the attribute may be called attributes, attribute information, attribute data, or the like. The point cloud content providing system (for example, the point cloud transmission device 10000 or the point cloud video acquirer 10001) may secure point cloud data from information (e.g., depth information, color information, etc.) related to the acquisition process of the point cloud video.

The point cloud content providing system (for example, the transmission device 10000 or the point cloud video encoder 10002) according to the embodiments may encode the point cloud data (20001). The point cloud content providing system may encode the point cloud data based on point cloud compression coding. As described above, the point cloud data may include the geometry and attributes of a point. Accordingly, the point cloud content providing system may perform geometry encoding of encoding the geometry and output a geometry bitstream. The point cloud content providing system may perform attribute encoding of encoding attributes and output an attribute bitstream. According to embodiments, the point cloud content providing system may perform the attribute encoding based on the geometry encoding. The geometry bitstream and the attribute bitstream according to the embodiments may be multiplexed and output as one bitstream. The bitstream according to the embodiments may further contain signaling information related to the geometry encoding and attribute encoding.

The point cloud content providing system (for example, the transmission device 10000 or the transmitter 10003) according to the embodiments may transmit the encoded point cloud data (20002). As illustrated in FIG. 1, the encoded point cloud data may be represented by a geometry bitstream and an attribute bitstream. In addition, the encoded point cloud data may be transmitted in the form of a bitstream together with signaling information related to encoding of the point cloud data (for example, signaling information related to the geometry encoding and the attribute encoding). The point cloud content providing system may encapsulate a bitstream that carries the encoded point cloud data and transmit the same in the form of a file or segment.

The point cloud content providing system (for example, the reception device 10004 or the receiver 10005) according to the embodiments may receive the bitstream containing the encoded point cloud data. In addition, the point cloud content providing system (for example, the reception device 10004 or the receiver 10005) may demultiplex the bitstream.

The point cloud content providing system (e.g., the reception device 10004 or the point cloud video decoder 10005) may decode the encoded point cloud data (e.g., the geometry bitstream, the attribute bitstream) transmitted in the bitstream. The point cloud content providing system (for example, the reception device 10004 or the point cloud video decoder 10005) may decode the point cloud video data based on the signaling information related to encoding of the point cloud video data contained in the bitstream. The point cloud content providing system (for example, the reception device 10004 or the point cloud video decoder 10005) may decode the geometry bitstream to reconstruct the positions (geometry) of points. The point cloud content providing system may reconstruct the attributes of the points by decoding the attribute bitstream based on the reconstructed geometry. The point cloud content providing system (for example, the reception device 10004 or the point cloud video decoder 10005) may reconstruct the point cloud video based on the positions according to the reconstructed geometry and the decoded attributes.

The point cloud content providing system according to the embodiments (for example, the reception device 10004 or the renderer 10007) may render the decoded point cloud data (20004). The point cloud content providing system (for example, the reception device 10004 or the renderer 10007) may render the geometry and attributes decoded through the decoding process, using various rendering methods. Points in the point cloud content may be rendered to a vertex having a certain thickness, a cube having a specific minimum size centered on the corresponding vertex position, or a circle centered on the corresponding vertex position. All or part of the rendered point cloud content is provided to the user through a display (e.g., a VR/AR display, a general display, etc.).

The point cloud content providing system (e.g., the reception device 10004) according to the embodiments may secure feedback information (20005). The point cloud content providing system may encode and/or decode point cloud data based on the feedback information. The feedback information and the operation of the point cloud content providing system according to the embodiments are the same as the feedback information and the operation described with reference to FIG. 1, and thus detailed description thereof is omitted.

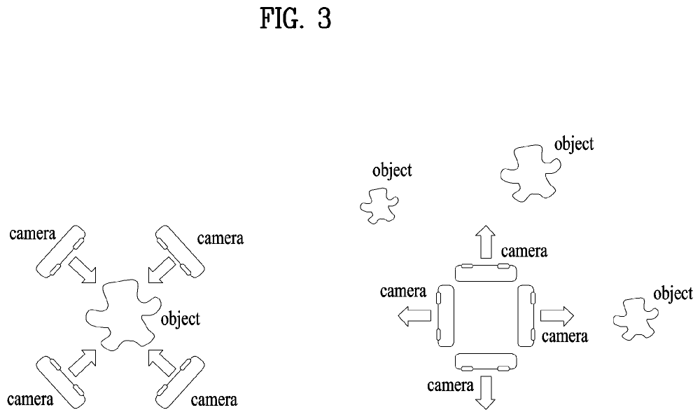

FIG. 3 illustrates an exemplary process of capturing a point cloud video according to embodiments.

FIG. 3 illustrates an exemplary point cloud video capture process of the point cloud content providing system described with reference to FIGS. 1 to 2.

Point cloud content includes a point cloud video (images and/or videos) representing an object and/or environment located in various 3D spaces (e.g., a 3D space representing a real environment, a 3D space representing a virtual environment, etc.). Accordingly, the point cloud content providing system according to the embodiments may capture a point cloud video using one or more cameras (e.g., an infrared camera capable of securing depth information, an RGB camera capable of extracting color information corresponding to the depth information, etc.), a projector (e.g., an infrared pattern projector to secure depth information), a LiDAR, or the like. The point cloud content providing system according to the embodiments may extract the shape of geometry composed of points in a 3D space from the depth information and extract the attributes of each point from the color information to secure point cloud data. An image and/or video according to the embodiments may be captured based on at least one of the inward-facing technique and the outward-facing technique.

The left part of FIG. 3 illustrates the inward-facing technique. The inward-facing technique refers to a technique of capturing images a central object with one or more cameras (or camera sensors) positioned around the central object. The inward-facing technique may be used to generate point cloud content providing a 360-degree image of a key object to the user (e.g., VR/AR content providing a 360-degree image of an object (e.g., a key object such as a character, player, object, or actor) to the user).

The right part of FIG. 3 illustrates the outward-facing technique. The outward-facing technique refers to a technique of capturing images an environment of a central object rather than the central object with one or more cameras (or camera sensors) positioned around the central object. The outward-facing technique may be used to generate point cloud content for providing a surrounding environment that appears from the user's point of view (e.g., content representing an external environment that may be provided to a user of a self-driving vehicle).

As shown in the figure, the point cloud content may be generated based on the capturing operation of one or more cameras. In this case, the coordinate system may differ among the cameras, and accordingly the point cloud content providing system may calibrate one or more cameras to set a global coordinate system before the capturing operation. In addition, the point cloud content providing system may generate point cloud content by synthesizing an arbitrary image and/or video with an image and/or video captured by the above-described capture technique. The point cloud content providing system may not perform the capturing operation described in FIG. 3 when it generates point cloud content representing a virtual space. The point cloud content providing system according to the embodiments may perform post-processing on the captured image and/or video. In other words, the point cloud content providing system may remove an unwanted area (for example, a background), recognize a space to which the captured images and/or videos are connected, and, when there is a spatial hole, perform an operation of filling the spatial hole.

The point cloud content providing system may generate one piece of point cloud content by performing coordinate transformation on points of the point cloud video secured from each camera. The point cloud content providing system may perform coordinate transformation on the points based on the coordinates of the position of each camera. Accordingly, the point cloud content providing system may generate content representing one wide range, or may generate point cloud content having a high density of points.

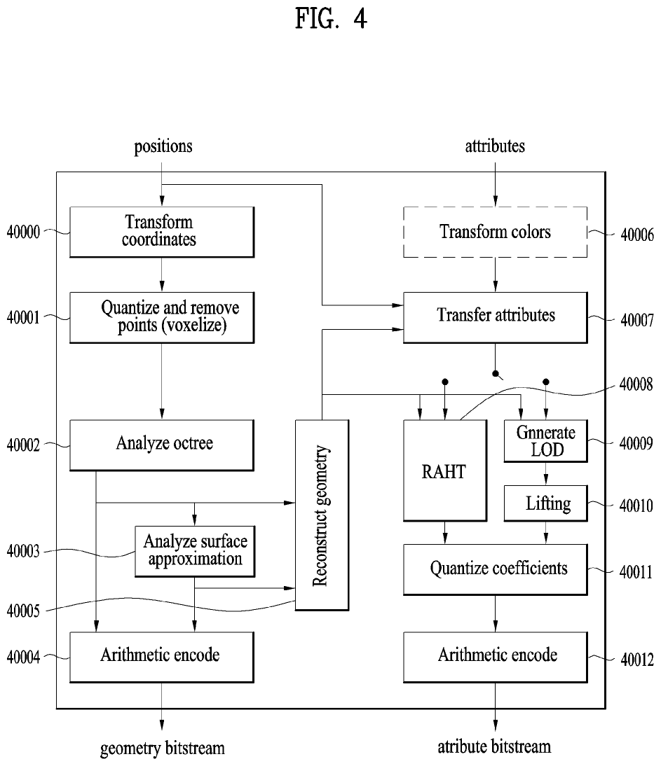

FIG. 4 illustrates an exemplary point cloud encoder according to embodiments.

FIG. 4 shows an example of the point cloud video encoder 10002 of FIG. 1. The point cloud encoder reconstructs and encodes point cloud data (e.g., positions and/or attributes of the points) to adjust the quality of the point cloud content (to, for example, lossless, lossy, or near-lossless) according to the network condition or applications. When the overall size of the point cloud content is large (e.g., point cloud content of 60 Gbps is given for 30 fps), the point cloud content providing system may fail to stream the content in real time. Accordingly, the point cloud content providing system may reconstruct the point cloud content based on the maximum target bitrate to provide the same in accordance with the network environment or the like.

As described with reference to FIGS. 1 and 2, the point cloud encoder may perform geometry encoding and attribute encoding. The geometry encoding is performed before the attribute encoding.

The point cloud encoder according to the embodiments includes a coordinate transformer (Transform coordinates) 40000, a quantizer (Quantize and remove points (voxelize)) 40001, an octree analyzer (Analyze octree) 40002, and a surface approximation analyzer (Analyze surface approximation) 40003, an arithmetic encoder (Arithmetic encode) 40004, a geometry reconstructor (Reconstruct geometry) 40005, a color transformer (Transform colors) 40006, an attribute transformer (Transform attributes) 40007, a RAHT transformer (RAHT) 40008, an LOD generator (Generate LOD) 40009, a lifting transformer (Lifting) 40010, a coefficient quantizer (Quantize coefficients) 40011, and/or an arithmetic encoder (Arithmetic encode) 40012.

The coordinate transformer 40000, the quantizer 40001, the octree analyzer 40002, the surface approximation analyzer 40003, the arithmetic encoder 40004, and the geometry reconstructor 40005 may perform geometry encoding. The geometry encoding according to the embodiments may include octree geometry coding, predictive tree geometry coding, direct coding, trisoup geometry encoding, and entropy encoding. The direct coding and trisoup geometry encoding are applied selectively or in combination. The geometry encoding is not limited to the above-described example.

As shown in the figure, the coordinate transformer 40000 according to the embodiments receives positions and transforms the same into coordinates. For example, the positions may be transformed into position information in a three-dimensional space (for example, a three-dimensional space represented by an XYZ coordinate system). The position information in the three-dimensional space according to the embodiments may be referred to as geometry information.

The quantizer 40001 according to the embodiments quantizes the geometry. For example, the quantizer 40001 may quantize the points based on a minimum position value of all points (for example, a minimum value on each of the X, Y, and Z axes). The quantizer 40001 performs a quantization operation of multiplying the difference between the minimum position value and the position value of each point by a preset quantization scale value and then finding the nearest integer value by rounding the value obtained through the multiplication. Thus, one or more points may have the same quantized position (or position value). The quantizer 40001 according to the embodiments performs voxelization based on the quantized positions to reconstruct quantized points. As in the case of a pixel, which is the minimum unit containing 2D image/video information, points of point cloud content (or 3D point cloud video) according to the embodiments may be included in one or more voxels. The term voxel, which is a compound of volume and pixel, refers to a 3D cubic space generated when a 3D space is divided into units (unit=1.0) based on the axes representing the 3D space (e.g., X-axis, Y-axis, and Z-axis). The quantizer 40001 may match groups of points in the 3D space with voxels. According to embodiments, one voxel may include only one point. According to embodiments, one voxel may include one or more points. In order to express one voxel as one point, the position of the center of a voxel may be set based on the positions of one or more points included in the voxel. In this case, attributes of all positions included in one voxel may be combined and assigned to the voxel.

The octree analyzer 40002 according to the embodiments performs octree geometry coding (or octree coding) to present voxels in an octree structure. The octree structure represents points matched with voxels, based on the octal tree structure.

The surface approximation analyzer 40003 according to the embodiments may analyze and approximate the octree. The octree analysis and approximation according to the embodiments is a process of analyzing a region containing a plurality of points to efficiently provide octree and voxelization.

The arithmetic encoder 40004 according to the embodiments performs entropy encoding on the octree and/or the approximated octree. For example, the encoding scheme includes arithmetic encoding. As a result of the encoding, a geometry bitstream is generated.

The color transformer 40006, the attribute transformer 40007, the RAHT transformer 40008, the LOD generator 40009, the lifting transformer 40010, the coefficient quantizer 40011, and/or the arithmetic encoder 40012 perform attribute encoding. As described above, one point may have one or more attributes. The attribute encoding according to the embodiments is equally applied to the attributes that one point has. However, when an attribute (e.g., color) includes one or more elements, attribute encoding is independently applied to each element. The attribute encoding according to the embodiments includes color transform coding, attribute transform coding, region adaptive hierarchical transform (RAHT) coding, interpolation-based hierarchical nearest-neighbor prediction (prediction transform) coding, and interpolation-based hierarchical nearest-neighbor prediction with an update/lifting step (lifting transform) coding. Depending on the point cloud content, the RAHT coding, the prediction transform coding and the lifting transform coding described above may be selectively used, or a combination of one or more of the coding schemes may be used. The attribute encoding according to the embodiments is not limited to the above-described example.

The color transformer 40006 according to the embodiments performs color transform coding of transforming color values (or textures) included in the attributes. For example, the color transformer 40006 may transform the format of color information (for example, from RGB to YCbCr). The operation of the color transformer 40006 according to embodiments may be optionally applied according to the color values included in the attributes.

The geometry reconstructor 40005 according to the embodiments reconstructs (decompresses) the octree, the predictive tree and/or the approximated octree. The geometry reconstructor 40005 reconstructs the octree/voxels based on the result of analyzing the distribution of points. The reconstructed octree/voxels may be referred to as reconstructed geometry (restored geometry).

The attribute transformer 40007 according to the embodiments performs attribute transformation to transform the attributes based on the reconstructed geometry and/or the positions on which geometry encoding is not performed. As described above, since the attributes are dependent on the geometry, the attribute transformer 40007 may transform the attributes based on the reconstructed geometry information. For example, based on the position value of a point included in a voxel, the attribute transformer 40007 may transform the attribute of the point at the position. As described above, when the position of the center of a voxel is set based on the positions of one or more points included in the voxel, the attribute transformer 40007 transforms the attributes of the one or more points. When the trisoup geometry encoding is performed, the attribute transformer 40007 may transform the attributes based on the trisoup geometry encoding.

The attribute transformer 40007 may perform the attribute transformation by calculating the average of attributes or attribute values of neighboring points (e.g., color or reflectance of each point) within a specific position/radius from the position (or position value) of the center of each voxel. The attribute transformer 40007 may apply a weight according to the distance from the center to each point in calculating the average. Accordingly, each voxel has a position and a calculated attribute (or attribute value).

The attribute transformer 40007 may search for neighboring points existing within a specific position/radius from the position of the center of each voxel based on the K-D tree or the Morton code. The K-D tree is a binary search tree and supports a data structure capable of managing points based on the positions such that nearest neighbor search (NNS) may be performed quickly. The Morton code is generated by presenting coordinates (e.g., (x, y, z)) representing 3D positions of all points as bit values and mixing the bits. For example, when the coordinates indicating the position of a point are (5, 9, 1), the bit values for the coordinates are (0101, 1001, 0001). Mixing the bit values according to the bit index in order of z, y, and x yields 010001000111. This value is expressed as a decimal number of 1095. That is, the Morton code value of the point having coordinates (5, 9, 1) is 1095. The attribute transformer 40007 may order the points based on the Morton code values and perform NNS through a depth-first traversal process. After the attribute transformation operation, the K-D tree or the Morton code is used when the NNS is needed in another transformation process for attribute coding.

As shown in the figure, the transformed attributes are input to the RAHT transformer 40008 and/or the LOD generator 40009.

The RAHT transformer 40008 according to the embodiments performs RAHT coding for predicting attribute information based on the reconstructed geometry information. For example, the RAHT transformer 40008 may predict attribute information of a node at a higher level in the octree based on the attribute information associated with a node at a lower level in the octree.

The LOD generator 40009 according to the embodiments generates a level of detail (LOD) to perform prediction transform coding. The LOD according to the embodiments is a degree of detail of point cloud content. As the LOD value decrease, it indicates that the detail of the point cloud content is degraded. As the LOD value increases, it indicates that the detail of the point cloud content is enhanced. Points may be classified by the LOD.

The lifting transformer 40010 according to the embodiments performs lifting transform coding of transforming the attributes a point cloud based on weights. As described above, lifting transform coding may be optionally applied.

The coefficient quantizer 40011 according to the embodiments quantizes the attribute-coded attributes based on coefficients.

The arithmetic encoder 40012 according to the embodiments encodes the quantized attributes based on arithmetic coding.

Although not shown in the figure, the elements of the point cloud encoder of FIG. 4 may be implemented by hardware including one or more processors or integrated circuits configured to communicate with one or more memories included in the point cloud providing device, software, firmware, or a combination thereof. The one or more processors may perform at least one of the operations and/or functions of the elements of the point cloud encoder of FIG. 4 described above. Additionally, the one or more processors may operate or execute a set of software programs and/or instructions for performing the operations and/or functions of the elements of the point cloud encoder of FIG. 4. The one or more memories according to the embodiments may include a high speed random access memory, or include a non-volatile memory (e.g., one or more magnetic disk storage devices, flash memory devices, or other non-volatile solid-state memory devices).

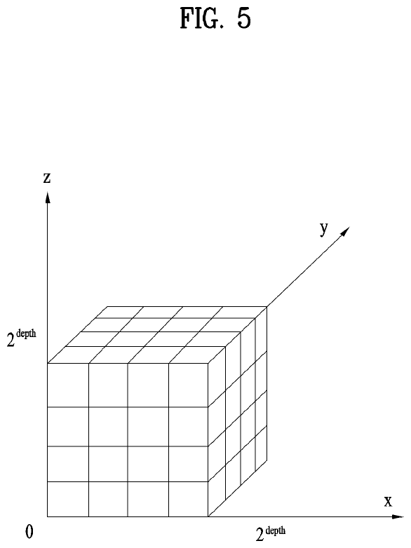

FIG. 5 shows an example of voxels according to embodiments.

FIG. 5 shows voxels positioned in a 3D space represented by a coordinate system composed of three axes, which are the X-axis, the Y-axis, and the Z-axis. As described with reference to FIG. 4, the point cloud encoder (e.g., the quantizer 40001) may perform voxelization. Voxel refers to a 3D cubic space generated when a 3D space is divided into units (unit=1.0) based on the axes representing the 3D space (e.g., X-axis, Y-axis, and Z-axis). FIG. 5 shows an example of voxels generated through an octree structure in which a cubical axis-aligned bounding box defined by two poles (0, 0, 0) and (2^{d}, 2^{d}, 2^{d}) is recursively subdivided. One voxel includes at least one point. The spatial coordinates of a voxel may be estimated from the positional relationship with a voxel group. As described above, a voxel has an attribute (such as color or reflectance) like pixels of a 2D image/video. The details of the voxel are the same as those described with reference to FIG. 4, and therefore a description thereof is omitted.

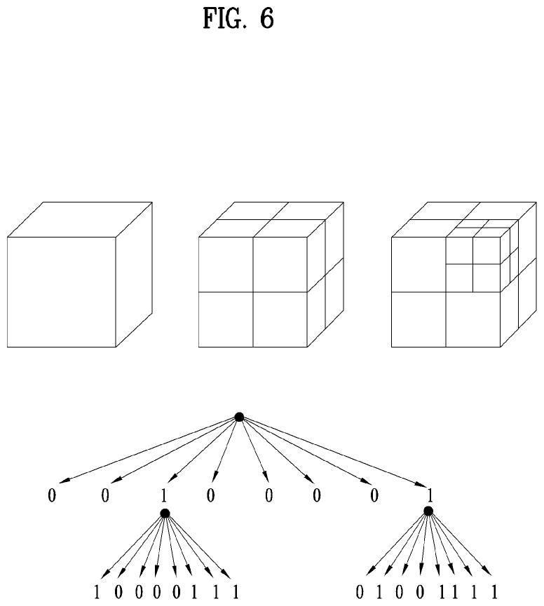

FIG. 6 shows an example of an octree and occupancy code according to embodiments.

As described with reference to FIGS. 1 to 4, the point cloud content providing system (point cloud video encoder 10002) or the point cloud encoder (for example, the octree analyzer 40002) performs octree geometry coding (or octree coding) based on an octree structure to efficiently manage the region and/or position of the voxel.

The upper part of FIG. 6 shows an octree structure. The 3D space of the point cloud content according to the embodiments is represented by axes (e.g., X-axis, Y-axis, and Z-axis) of the coordinate system. The octree structure is created by recursive subdividing of a cubical axis-aligned bounding box defined by two poles (0, 0, 0) and (2^{d}, 2^{d}, 2^{d}) Here, 2^{d} may be set to a value constituting the smallest bounding box surrounding all points of the point cloud content (or point cloud video). Here, d denotes the depth of the octree. The value of d is determined in the following equation. In the following equation, (x^{int}ₙ, y^{int}ₙ, z^{int}ₙ) denotes the positions (or position values) of quantized points.

d=Ceil(Log 2(Max(xₙ^{int},yₙ^{int},zₙ^{int},n=1, . . . ,N)+1))

As shown in the middle of the upper part of FIG. 6, the entire 3D space may be divided into eight spaces according to partition. Each divided space is represented by a cube with six faces. As shown in the upper right of FIG. 6, each of the eight spaces is divided again based on the axes of the coordinate system (e.g., X-axis, Y-axis, and Z-axis). Accordingly, each space is divided into eight smaller spaces. The divided smaller space is also represented by a cube with six faces. This partitioning scheme is applied until the leaf node of the octree becomes a voxel.

The lower part of FIG. 6 shows an octree occupancy code. The occupancy code of the octree is generated to indicate whether each of the eight divided spaces generated by dividing one space contains at least one point. Accordingly, a single occupancy code is represented by eight child nodes. Each child node represents the occupancy of a divided space, and the child node has a value in 1 bit. Accordingly, the occupancy code is represented as an 8-bit code. That is, when at least one point is contained in the space corresponding to a child node, the node is assigned a value of 1. When no point is contained in the space corresponding to the child node (the space is empty), the node is assigned a value of 0. Since the occupancy code shown in FIG. 6 is 00100001, it indicates that the spaces corresponding to the third child node and the eighth child node among the eight child nodes each contain at least one point. As shown in the figure, each of the third child node and the eighth child node has eight child nodes, and the child nodes are represented by an 8-bit occupancy code. The figure shows that the occupancy code of the third child node is 10000111, and the occupancy code of the eighth child node is 01001111. The point cloud encoder (for example, the arithmetic encoder 40004) according to the embodiments may perform entropy encoding on the occupancy codes. In order to increase the compression efficiency, the point cloud encoder may perform intra/inter-coding on the occupancy codes. The reception device (for example, the reception device 10004 or the point cloud video decoder 10006) according to the embodiments reconstructs the octree based on the occupancy codes.

The point cloud encoder (for example, the point cloud encoder of FIG. 4 or the octree analyzer 40002) according to the embodiments may perform voxelization and octree coding to store the positions of points. However, points are not always evenly distributed in the 3D space, and accordingly there may be a specific region in which fewer points are present. Accordingly, it is inefficient to perform voxelization for the entire 3D space. For example, when a specific region contains few points, voxelization does not need to be performed in the specific region.

Accordingly, for the above-described specific region (or a node other than the leaf node of the octree), the point cloud encoder according to the embodiments may skip voxelization and perform direct coding to directly code the positions of points included in the specific region. The coordinates of a direct coding point according to the embodiments are referred to as direct coding mode (DCM). The point cloud encoder according to the embodiments may also perform trisoup geometry encoding, which is to reconstruct the positions of the points in the specific region (or node) based on voxels, based on a surface model. The trisoup geometry encoding is geometry encoding that represents an object as a series of triangular meshes. Accordingly, the point cloud decoder may generate a point cloud from the mesh surface. The direct coding and trisoup geometry encoding according to the embodiments may be selectively performed. In addition, the direct coding and trisoup geometry encoding according to the embodiments may be performed in combination with octree geometry coding (or octree coding).

To perform direct coding, the option to use the direct mode for applying direct coding should be activated. A node to which direct coding is to be applied is not a leaf node, and points less than a threshold should be present within a specific node. In addition, the total number of points to which direct coding is to be applied should not exceed a preset threshold. When the conditions above are satisfied, the point cloud encoder (or the arithmetic encoder 40004) according to the embodiments may perform entropy coding on the positions (or position values) of the points.

The point cloud encoder (for example, the surface approximation analyzer 40003) according to the embodiments may determine a specific level of the octree (a level less than the depth d of the octree), and the surface model may be used staring with that level to perform trisoup geometry encoding to reconstruct the positions of points in the region of the node based on voxels (Trisoup mode). The point cloud encoder according to the embodiments may specify a level at which trisoup geometry encoding is to be applied. For example, when the specific level is equal to the depth of the octree, the point cloud encoder does not operate in the trisoup mode. In other words, the point cloud encoder according to the embodiments may operate in the trisoup mode only when the specified level is less than the value of depth of the octree. The 3D cube region of the nodes at the specified level according to the embodiments is called a block. One block may include one or more voxels. The block or voxel may correspond to a brick. Geometry is represented as a surface within each block. The surface according to embodiments may intersect with each edge of a block at most once.

One block has 12 edges, and accordingly there are at least 12 intersections in one block. Each intersection is called a vertex (or apex). A vertex present along an edge is detected when there is at least one occupied voxel adjacent to the edge among all blocks sharing the edge. The occupied voxel according to the embodiments refers to a voxel containing a point. The position of the vertex detected along the edge is the average position along the edge of all voxels adjacent to the edge among all blocks sharing the edge.

Once the vertex is detected, the point cloud encoder according to the embodiments may perform entropy encoding on the starting point (x, y, z) of the edge, the direction vector (Δx, Δy, Δz) of the edge, and the vertex position value (relative position value within the edge). When the trisoup geometry encoding is applied, the point cloud encoder according to the embodiments (for example, the geometry reconstructor 40005) may generate restored geometry (reconstructed geometry) by performing the triangle reconstruction, up-sampling, and voxelization processes.

The vertices positioned at the edge of the block determine a surface that passes through the block. The surface according to the embodiments is a non-planar polygon. In the triangle reconstruction process, a surface represented by a triangle is reconstructed based on the starting point of the edge, the direction vector of the edge, and the position values of the vertices. The triangle reconstruction process is performed by: i) calculating the centroid value of each vertex, ii) subtracting the center value from each vertex value, and iii) estimating the sum of the squares of the values obtained by the subtraction.

$$[ \begin{matrix}{μ}_{x} \\ {μ}_{y} \\ {μ}_{z}\end{matrix} ] = \frac{1}{n} {Σ}_{i = 1}^{n} [ \begin{matrix}{x}_{i} \\ {y}_{i} \\ {z}_{i}\end{matrix} ] ; \qquad i )$$

$$[ \begin{matrix}\begin{matrix}{\overline{x}}_{i} \\ {\overline{y}}_{i}\end{matrix} \\ {\overline{z}}_{i}\end{matrix} ] = [ \begin{matrix}\begin{matrix}{x}_{i} \\ {y}_{i}\end{matrix} \\ {z}_{i}\end{matrix} ] - [ \begin{matrix}{μ}_{x} \\ {μ}_{y} \\ {μ}_{z}\end{matrix} ] ; \qquad ii )$$

$$[ \begin{matrix}{σ}_{x}^{2} \\ {σ}_{y}^{2} \\ {σ}_{z}^{2}\end{matrix} ] = {Σ}_{i = 1}^{n} [ \begin{matrix}\begin{matrix}{\overline{x}}_{i}^{2} \\ {\overline{y}}_{i}^{2}\end{matrix} \\ {\overline{z}}_{i}^{2}\end{matrix} ] \qquad iii )$$

The minimum value of the sum is estimated, and the projection process is performed according to the axis with the minimum value. For example, when the element x is the minimum, each vertex is projected on the x-axis with respect to the center of the block, and projected on the (y, z) plane. When the values obtained through projection on the (y, z) plane are (ai, bi), the value of θ is estimated through atan2(bi, ai), and the vertices are ordered based on the value of θ. The table below shows a combination of vertices for creating a triangle according to the number of the vertices. The vertices are ordered from 1 to n. The table below shows that for four vertices, two triangles may be constructed according to combinations of vertices. The first triangle may consist of vertices 1, 2, and 3 among the ordered vertices, and the second triangle may consist of vertices 3, 4, and 1 among the ordered vertices.

Triangles formed from vertices ordered 1, . . . , n

n triangles

3 (1,2,3)

4 (1,2,3), (3,4,1)

5 (1,2,3), (3,4,5), (5,1,3)

6 (1,2,3), (3,4,5), (5,6,1), (1,3,5)

7 (1,2,3), (3,4,5), (5,6,7), (7,1,3), (3,5,7)

8 (1,2,3), (3,4,5), (5,6,7), (7,8,1), (1,3,5), (5,7,1)

9 (1,2,3), (3,4,5), (5,6,7), (7,8,9), (9,1,3), (3,5,7), (7,9,3)

10 (1,2,3), (3,4,5), (5,6,7), (7,8,9), (9,10,1), (1,3,5), (5,7,9), (9,1,5)

11 (1,2,3), (3,4,5), (5,6,7), (7,8,9), (9,10,11), (11,1,3), (3,5,7), (7,9,11), (11,3,7)

12 (1,2,3), (3,4,5), (5,6,7), (7,8,9), (9,10,11), (11,12,1), (1,3,5), (5,7,9), (9,11,1), (1,5,9)

The upsampling process is performed to add points in the middle along the edge of the triangle and perform voxelization. The added points are generated based on the upsampling factor and the width of the block. The added points are called refined vertices. The point cloud encoder according to the embodiments may voxelize the refined vertices. In addition, the point cloud encoder may perform attribute encoding based on the voxelized positions (or position values).

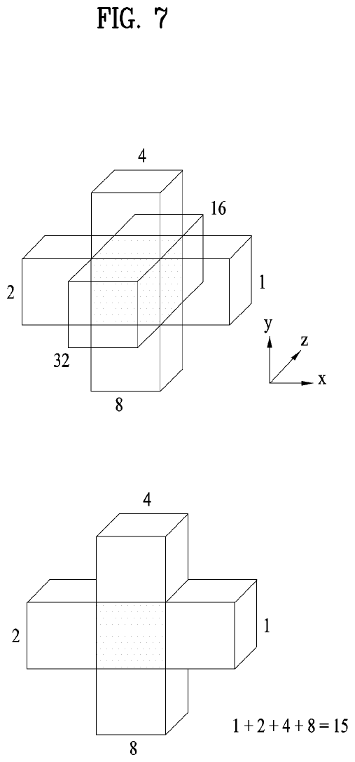

FIG. 7 shows an example of a neighbor node pattern according to embodiments.

In order to increase the compression efficiency of the point cloud video, the point cloud encoder according to the embodiments may perform entropy coding based on context adaptive arithmetic coding.

As described with reference to FIGS. 1 to 6, the point cloud content providing system or the point cloud encoder (for example, the point cloud video encoder 10002, the point cloud encoder or arithmetic encoder 40004 of FIG. 4) may perform entropy coding on the occupancy code immediately. In addition, the point cloud content providing system or the point cloud encoder may perform entropy encoding (intra encoding) based on the occupancy code of the current node and the occupancy of neighboring nodes, or perform entropy encoding (inter encoding) based on the occupancy code of the previous frame. A frame according to embodiments represents a set of point cloud videos generated at the same time. The compression efficiency of intra encoding/inter encoding according to the embodiments may depend on the number of neighboring nodes that are referenced. When the bits increase, the operation becomes complicated, but the encoding may be biased to one side, which may increase the compression efficiency. For example, when a 3-bit context is given, coding needs to be performed using 23=8 methods. The part divided for coding affects the complexity of implementation. Accordingly, it is necessary to meet an appropriate level of compression efficiency and complexity.

FIG. 7 illustrates a process of obtaining an occupancy pattern based on the occupancy of neighbor nodes. The point cloud encoder according to the embodiments determines occupancy of neighbor nodes of each node of the octree and obtains a value of a neighbor pattern. The neighbor node pattern is used to infer the occupancy pattern of the node. The left part of FIG. 7 shows a cube corresponding to a node (a cube positioned in the middle) and six cubes (neighbor nodes) sharing at least one face with the cube. The nodes shown in the figure are nodes of the same depth. The numbers shown in the figure represent weights (1, 2, 4, 8, 16, and 32) associated with the six nodes, respectively. The weights are assigned sequentially according to the positions of neighboring nodes.

The right part of FIG. 7 shows neighbor node pattern values. A neighbor node pattern value is the sum of values multiplied by the weight of an occupied neighbor node (a neighbor node having a point). Accordingly, the neighbor node pattern values are 0 to 63. When the neighbor node pattern value is 0, it indicates that there is no node having a point (no occupied node) among the neighbor nodes of the node. When the neighbor node pattern value is 63, it indicates that all neighbor nodes are occupied nodes. As shown in the figure, since neighbor nodes to which weights 1, 2, 4, and 8 are assigned are occupied nodes, the neighbor node pattern value is 15, the sum of 1, 2, 4, and 8. The point cloud encoder may perform coding according to the neighbor node pattern value (for example, when the neighbor node pattern value is 63, 64 kinds of coding may be performed). According to embodiments, the point cloud encoder may reduce coding complexity by changing a neighbor node pattern value (for example, based on a table by which 64 is changed to 10 or 6).

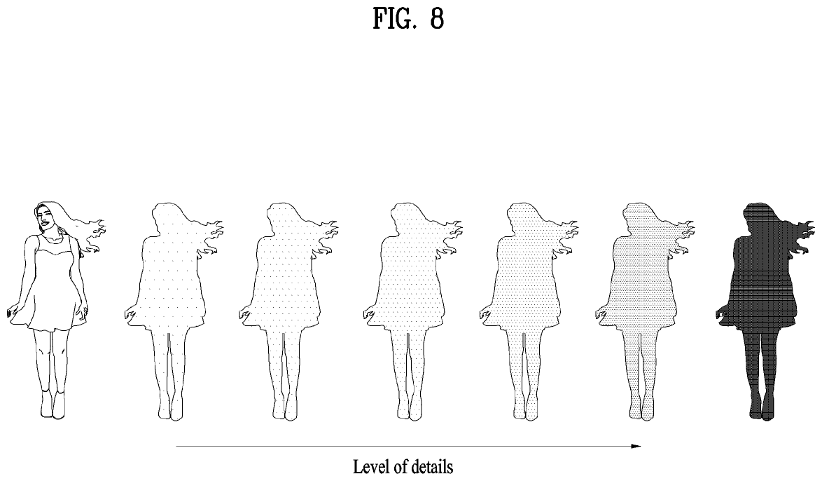

FIG. 8 illustrates an example of point configuration in each LOD according to embodiments.

As described with reference to FIGS. 1 to 7, encoded geometry is reconstructed (decompressed) before attribute encoding is performed. When direct coding is applied, the geometry reconstruction operation may include changing the placement of direct coded points (e.g., placing the direct coded points in front of the point cloud data). When trisoup geometry encoding is applied, the geometry reconstruction process is performed through triangle reconstruction, up-sampling, and voxelization. Since the attribute depends on the geometry, attribute encoding is performed based on the reconstructed geometry.

The point cloud encoder (for example, the LOD generator 40009) may classify (reorganize) points by LOD. The figure shows the point cloud content corresponding to LODs. The leftmost picture in the figure represents original point cloud content. The second picture from the left of the figure represents distribution of the points in the lowest LOD, and the rightmost picture in the figure represents distribution of the points in the highest LOD. That is, the points in the lowest LOD are sparsely distributed, and the points in the highest LOD are densely distributed. That is, as the LOD rises in the direction pointed by the arrow indicated at the bottom of the figure, the space (or distance) between points is narrowed.

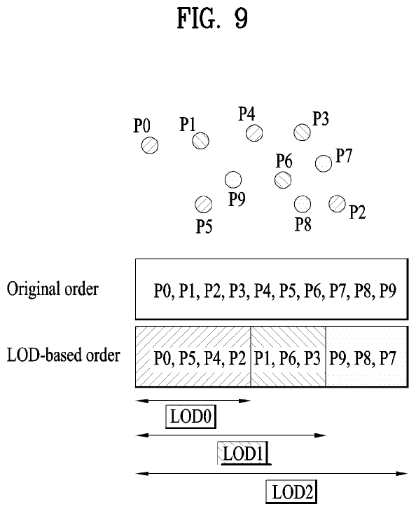

FIG. 9 illustrates an example of point configuration for each LOD according to embodiments.

As described with reference to FIGS. 1 to 8, the point cloud content providing system, or the point cloud encoder (for example, the point cloud video encoder 10002, the point cloud encoder of FIG. 4, or the LOD generator 40009) may generates an LOD. The LOD is generated by reorganizing the points into a set of refinement levels according to a set LOD distance value (or a set of Euclidean distances). The LOD generation process is performed not only by the point cloud encoder, but also by the point cloud decoder.

The upper part of FIG. 9 shows examples (P0 to P9) of points of the point cloud content distributed in a 3D space. In FIG. 9, the original order represents the order of points P0 to P9 before LOD generation. In FIG. 9, the LOD based order represents the order of points according to the LOD generation. Points are reorganized by LOD. Also, a high LOD contains the points belonging to lower LODs. As shown in FIG. 9, LOD0 contains P0, P5, P4 and P2. LOD1 contains the points of LOD0, P1, P6 and P3. LOD2 contains the points of LOD0, the points of LOD1, P9, P8 and P7.

As described with reference to FIG. 4, the point cloud encoder according to the embodiments may perform prediction transform coding, lifting transform coding, and RAHT transform coding selectively or in combination.

The point cloud encoder according to the embodiments may generate a predictor for points to perform prediction transform coding for setting a predicted attribute (or predicted attribute value) of each point. That is, N predictors may be generated for N points. The predictor according to the embodiments may calculate a weight (=1/distance) based on the LOD value of each point, indexing information about neighboring points present within a set distance for each LOD, and a distance to the neighboring points.

The predicted attribute (or attribute value) according to the embodiments is set to the average of values obtained by multiplying the attributes (or attribute values) (e.g., color, reflectance, etc.) of neighbor points set in the predictor of each point by a weight (or weight value) calculated based on the distance to each neighbor point. The point cloud encoder according to the embodiments (for example, the coefficient quantizer 40011) may quantize and inversely quantize the residuals (which may be called residual attributes, residual attribute values, attribute residuals or attribute prediction residuals) obtained by subtracting a predicted attribute (attribute value) from the attribute (attribute value) of each point. The quantization process is configured as shown in the following table.

TABLE 1
Attribute prediction residuals quantization pseudo code

int PCCQuantization(int value, int quantStep) {
if( value>=0) {
return floor(value / quantStep + 1.0 / 3.0);
} else {
return −floor(−value / quantStep + 1.0 / 3.0);
}
}

TABLE 2
Attribute prediction residuals inverse quantization pseudo code

int PCCInverseQuantization(int value, int quantStep) {
if( quantStep ==0) {
return value;
} else {
return value * quantStep;
}
}

When the predictor of each point has neighbor points, the point cloud encoder (e.g., the arithmetic encoder 40012) according to the embodiments may perform entropy coding on the quantized and inversely quantized residual values as described above. When the predictor of each point has no neighbor point, the point cloud encoder according to the embodiments (for example, the arithmetic encoder 40012) may perform entropy coding on the attributes of the corresponding point without performing the above-described operation.

The point cloud encoder according to the embodiments (for example, the lifting transformer 40010) may generate a predictor of each point, set the calculated LOD and register neighbor points in the predictor, and set weights according to the distances to neighbor points to perform lifting transform coding. The lifting transform coding according to the embodiments is similar to the above-described prediction transform coding, but differs therefrom in that weights are cumulatively applied to attribute values. The process of cumulatively applying weights to the attribute values according to embodiments is configured as follows.
1) Create an array Quantization Weight (QW) for storing the weight value of each point. The initial value of all elements of QW is 1.0. Multiply the QW values of the predictor indexes of the neighbor nodes registered in the predictor by the weight of the predictor of the current point, and add the values obtained by the multiplication.
2) Lift prediction process: Subtract the value obtained by multiplying the attribute value of the point by the weight from the existing attribute value to calculate a predicted attribute value.
3) Create temporary arrays called updateweight and update and initialize the temporary arrays to zero.
4) Cumulatively add the weights calculated by multiplying the weights calculated for all predictors by a weight stored in the QW corresponding to a predictor index to the updateweight array as indexes of neighbor nodes. Cumulatively add, to the update array, a value obtained by multiplying the attribute value of the index of a neighbor node by the calculated weight.
5) Lift update process: Divide the attribute values of the update array for all predictors by the weight value of the updateweight array of the predictor index, and add the existing attribute value to the values obtained by the division.
6) Calculate predicted attributes by multiplying the attribute values updated through the lift update process by the weight updated through the lift prediction process (stored in the QW) for all predictors. The point cloud encoder (e.g., coefficient quantizer 40011) according to the embodiments quantizes the predicted attribute values. In addition, the point cloud encoder (e.g., the arithmetic encoder 40012) performs entropy coding on the quantized attribute values.

The point cloud encoder (for example, the RAHT transformer 40008) according to the embodiments may perform RAHT transform coding in which attributes of nodes of a higher level are predicted using the attributes associated with nodes of a lower level in the octree. RAHT transform coding is an example of attribute intra coding through an octree backward scan. The point cloud encoder according to the embodiments scans the entire region from the voxel and repeats the merging process of merging the voxels into a larger block at each step until the root node is reached. The merging process according to the embodiments is performed only on the occupied nodes. The merging process is not performed on the empty node. The merging process is performed on an upper node immediately above the empty node.

The equation below represents a RAHT transformation matrix. In the equation, gₗ_{_{x,y,z}} denotes the average attribute value of voxels at level l. gₗ_{_{x,y,z}} may be calculated based on gₗ₊₁_{_{2x,y,z}} and gₗ₊₁_{_{2x+1,y,z}}. The weights for gₗ_{_{2x,y,z}} and gₗ_{_{2x+1,y,z}} are w1=wₗ_{_{2x,y,z}} and w2=wₗ_{_{2x+1,y,z}}.

$$⌈ \begin{matrix}{g}_{l - {1}_{x , y , z}} \\ {h}_{l - {1}_{x , y , z}}\end{matrix} ⌉ = {T}_{w 1 w 2} ⌈ \begin{matrix}{g}_{{l}_{2 x , y , z}} \\ {g}_{{l}_{2 x + 1 , y , z}}\end{matrix} ⌉ ,$$

$${T}_{w 1 w 2} = \frac{1}{\sqrt{w 1 + w 2}} [ \begin{matrix}\sqrt{w 1} & \sqrt{w 2} \\ - \sqrt{w 2} & \sqrt{w 1}\end{matrix} ]$$

Here, gₗ₋₁_{_{x,y,z}} is a low-pass value and is used in the merging process at the next higher level. hₗ₋₁_{_{x,y,z}} denotes high-pass coefficients. The high-pass coefficients at each step are quantized and subjected to entropy coding (for example, encoding by the arithmetic encoder 400012). The weights are calculated as wₗ_{_{−1 x,y,z}}=wₗ_{_{2 x,y,z}}+wₗ_{_{2x+1,y,z}}. The root node is created through the g₁_{_{0,0,0}} and gₗ_{_{0,0,1}} as follows.

$$⌈ \begin{matrix}gDC \\ {h}_{{0}_{0 , 0 , 0}}\end{matrix} ⌉ = {T}_{w 1000 w 1001} ⌈ \begin{matrix}{g}_{{1}_{0 , 0 , 0 z}} \\ {g}_{{1}_{0 , 0 , 1}}\end{matrix} ⌉$$

The value of gDC is also quantized and subjected to entropy coding like the high-pass coefficients.

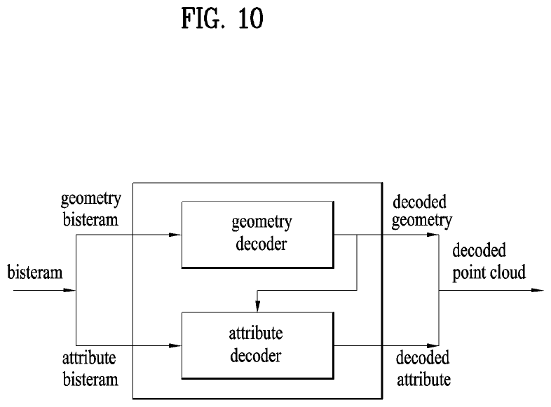

FIG. 10 illustrates a point cloud decoder according to embodiments.

The point cloud decoder illustrated in FIG. 10 is an example of the point cloud video decoder 10006 described in FIG. 1, and may perform the same or similar operations as the operations of the point cloud video decoder 10006 illustrated in FIG. 1. As shown in the figure, the point cloud decoder may receive a geometry bitstream and an attribute bitstream contained in one or more bitstreams. The point cloud decoder includes a geometry decoder and an attribute decoder. The geometry decoder performs geometry decoding on the geometry bitstream and outputs decoded geometry. The attribute decoder performs attribute decoding based on the decoded geometry and the attribute bitstream, and outputs decoded attributes. The decoded geometry and decoded attributes are used to reconstruct point cloud content (a decoded point cloud).

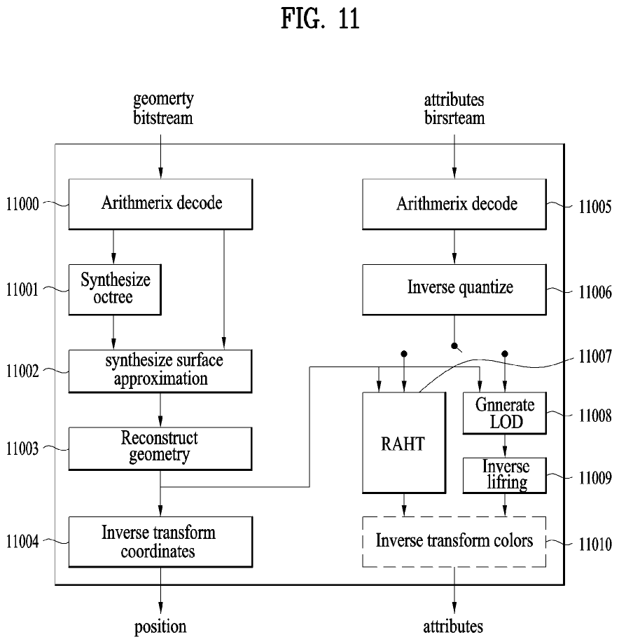

FIG. 11 illustrates a point cloud decoder according to embodiments.

The point cloud decoder illustrated in FIG. 11 is an example of the point cloud decoder illustrated in FIG. 10, and may perform a decoding operation, which is an inverse process of the encoding operation of the point cloud encoder illustrated in FIGS. 1 to 9.

As described with reference to FIGS. 1 and 10, the point cloud decoder may perform geometry decoding and attribute decoding. The geometry decoding is performed before the attribute decoding.

The point cloud decoder according to the embodiments includes an arithmetic decoder (Arithmetic decode) 11000, an octree synthesizer (Synthesize octree) 11001, a surface approximation synthesizer (Synthesize surface approximation) 11002, and a geometry reconstructor (Reconstruct geometry) 11003, a coordinate inverse transformer (Inverse transform coordinates) 11004, an arithmetic decoder (Arithmetic decode) 11005, an inverse quantizer (Inverse quantize) 11006, a RAHT transformer 11007, an LOD generator (Generate LOD) 11008, an inverse lifter (inverse lifting) 11009, and/or a color inverse transformer (Inverse transform colors) 11010.

The arithmetic decoder 11000, the octree synthesizer 11001, the surface approximation synthesizer 11002, and the geometry reconstructor 11003, and the coordinate inverse transformer 11004 may perform geometry decoding. The geometry decoding according to the embodiments may include direct decoding and trisoup geometry decoding. The direct decoding and trisoup geometry decoding are selectively applied. The geometry decoding is not limited to the above-described example, and is performed as an inverse process of the geometry encoding described with reference to FIGS. 1 to 9.

The arithmetic decoder 11000 according to the embodiments decodes the received geometry bitstream based on the arithmetic coding. The operation of the arithmetic decoder 11000 corresponds to the inverse process of the arithmetic encoder 40004.

The octree synthesizer 11001 according to the embodiments may generate an octree by acquiring an occupancy code from the decoded geometry bitstream (or information on the geometry secured as a result of decoding). The occupancy code is configured as described in detail with reference to FIGS. 1 to 9.

When the trisoup geometry encoding is applied, the surface approximation synthesizer 11002 according to the embodiments may synthesize a surface based on the decoded geometry and/or the generated octree.

The geometry reconstructor 11003 according to the embodiments may regenerate geometry based on the surface and/or the decoded geometry. As described with reference to FIGS. 1 to 9, direct coding and trisoup geometry encoding are selectively applied. Accordingly, the geometry reconstructor 11003 directly imports and adds position information about the points to which direct coding is applied. When the trisoup geometry encoding is applied, the geometry reconstructor 11003 may reconstruct the geometry by performing the reconstruction operations of the geometry reconstructor 40005, for example, triangle reconstruction, up-sampling, and voxelization. Details are the same as those described with reference to FIG. 6, and thus description thereof is omitted. The reconstructed geometry may include a point cloud picture or frame that does not contain attributes.

The coordinate inverse transformer 11004 according to the embodiments may acquire positions of the points by transforming the coordinates based on the reconstructed geometry.

The arithmetic decoder 11005, the inverse quantizer 11006, the RAHT transformer 11007, the LOD generator 11008, the inverse lifter 11009, and/or the color inverse transformer 11010 may perform the attribute decoding described with reference to FIG. 10. The attribute decoding according to the embodiments includes region adaptive hierarchical transform (RAHT) decoding, interpolation-based hierarchical nearest-neighbor prediction (prediction transform) decoding, and interpolation-based hierarchical nearest-neighbor prediction with an update/lifting step (lifting transform) decoding. The three decoding schemes described above may be used selectively, or a combination of one or more decoding schemes may be used. The attribute decoding according to the embodiments is not limited to the above-described example.

The arithmetic decoder 11005 according to the embodiments decodes the attribute bitstream by arithmetic coding.

The inverse quantizer 11006 according to the embodiments inversely quantizes the information about the decoded attribute bitstream or attributes secured as a result of the decoding, and outputs the inversely quantized attributes (or attribute values). The inverse quantization may be selectively applied based on the attribute encoding of the point cloud encoder.

According to embodiments, the RAHT transformer 11007, the LOD generator 11008, and/or the inverse lifter 11009 may process the reconstructed geometry and the inversely quantized attributes. As described above, the RAHT transformer 11007, the LOD generator 11008, and/or the inverse lifter 11009 may selectively perform a decoding operation corresponding to the encoding of the point cloud encoder.

The color inverse transformer 11010 according to the embodiments performs inverse transform coding to inversely transform a color value (or texture) included in the decoded attributes. The operation of the color inverse transformer 11010 may be selectively performed based on the operation of the color transformer 40006 of the point cloud encoder.

Although not shown in the figure, the elements of the point cloud decoder of FIG. 11 may be implemented by hardware including one or more processors or integrated circuits configured to communicate with one or more memories included in the point cloud providing device, software, firmware, or a combination thereof. The one or more processors may perform at least one or more of the operations and/or functions of the elements of the point cloud decoder of FIG. 11 described above. Additionally, the one or more processors may operate or execute a set of software programs and/or instructions for performing the operations and/or functions of the elements of the point cloud decoder of FIG. 11.

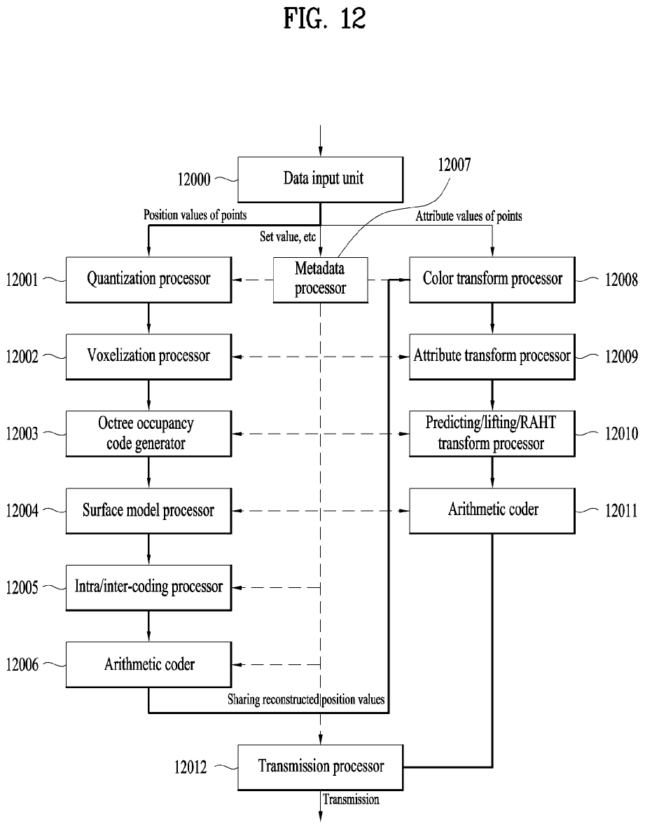

FIG. 12 illustrates a transmission device according to embodiments.

The transmission device shown in FIG. 12 is an example of the transmission device 10000 of FIG. 1 (or the point cloud encoder of FIG. 4). The transmission device illustrated in FIG. 12 may perform one or more of the operations and methods the same as or similar to those of the point cloud encoder described with reference to FIGS. 1 to 9. The transmission device according to the embodiments may include a data input unit 12000, a quantization processor 12001, a voxelization processor 12002, an octree occupancy code generator 12003, a surface model processor 12004, an intra/inter-coding processor 12005, an arithmetic coder 12006, a metadata processor 12007, a color transform processor 12008, an attribute transform processor 12009, a prediction/lifting/RAHT transform processor 12010, an arithmetic coder 12011 and/or a transmission processor 12012.

The data input unit 12000 according to the embodiments receives or acquires point cloud data. The data input unit 12000 may perform an operation and/or acquisition method the same as or similar to the operation and/or acquisition method of the point cloud video acquirer 10001 (or the acquisition process 20000 described with reference to FIG. 2).

The data input unit 12000, the quantization processor 12001, the voxelization processor 12002, the octree occupancy code generator 12003, the surface model processor 12004, the intra/inter-coding processor 12005, and the arithmetic coder 12006 perform geometry encoding. The geometry encoding according to the embodiments is the same as or similar to the geometry encoding described with reference to FIGS. 1 to 9, and thus a detailed description thereof is omitted.

The quantization processor 12001 according to the embodiments quantizes geometry (e.g., position values of points). The operation and/or quantization of the quantization processor 12001 is the same as or similar to the operation and/or quantization of the quantizer 40001 described with reference to FIG. 4. Details are the same as those described with reference to FIGS. 1 to 9.

The voxelization processor 12002 according to the embodiments voxelizes the quantized position values of the points. The voxelization processor 12002 may perform an operation and/or process the same or similar to the operation and/or the voxelization process of the quantizer 40001 described with reference to FIG. 4. Details are the same as those described with reference to FIGS. 1 to 9.

The octree occupancy code generator 12003 according to the embodiments performs octree coding on the voxelized positions of the points based on an octree structure. The octree occupancy code generator 12003 may generate an occupancy code. The octree occupancy code generator 12003 may perform an operation and/or method the same as or similar to the operation and/or method of the point cloud encoder (or the octree analyzer 40002) described with reference to FIGS. 4 and 6. Details are the same as those described with reference to FIGS. 1 to 9.

The surface model processor 12004 according to the embodiments may perform trisoup geometry encoding based on a surface model to reconstruct the positions of points in a specific region (or node) on a voxel basis. The surface model processor 12004 may perform an operation and/or method the same as or similar to the operation and/or method of the point cloud encoder (for example, the surface approximation analyzer 40003) described with reference to FIG. 4. Details are the same as those described with reference to FIGS. 1 to 9.

The intra/inter-coding processor 12005 according to the embodiments may perform intra/inter-coding on point cloud data. The intra/inter-coding processor 12005 may perform coding the same as or similar to the intra/inter-coding described with reference to FIG. 7. Details are the same as those described with reference to FIG. 7. According to embodiments, the intra/inter-coding processor 12005 may be included in the arithmetic coder 12006.

The arithmetic coder 12006 according to the embodiments performs entropy encoding on an octree of the point cloud data and/or an approximated octree. For example, the encoding scheme includes arithmetic encoding. The arithmetic coder 12006 performs an operation and/or method the same as or similar to the operation and/or method of the arithmetic encoder 40004.

The metadata processor 12007 according to the embodiments processes metadata about the point cloud data, for example, a set value, and provides the same to a necessary processing process such as geometry encoding and/or attribute encoding. Also, the metadata processor 12007 according to the embodiments may generate and/or process signaling information related to the geometry encoding and/or the attribute encoding. The signaling information according to the embodiments may be encoded separately from the geometry encoding and/or the attribute encoding. The signaling information according to the embodiments may be interleaved.

The color transform processor 12008, the attribute transform processor 12009, the prediction/lifting/RAHT transform processor 12010, and the arithmetic coder 12011 perform the attribute encoding. The attribute encoding according to the embodiments is the same as or similar to the attribute encoding described with reference to FIGS. 1 to 9, and thus a detailed description thereof is omitted.

The color transform processor 12008 according to the embodiments performs color transform coding to transform color values included in attributes. The color transform processor 12008 may perform color transform coding based on the reconstructed geometry. The reconstructed geometry is the same as described with reference to FIGS. 1 to 9. Also, it performs an operation and/or method the same as or similar to the operation and/or method of the color transformer 40006 described with reference to FIG. 4 is performed. The detailed description thereof is omitted.

The attribute transform processor 12009 according to the embodiments performs attribute transformation to transform the attributes based on the reconstructed geometry and/or the positions on which geometry encoding is not performed. The attribute transform processor 12009 performs an operation and/or method the same as or similar to the operation and/or method of the attribute transformer 40007 described with reference to FIG. 4. The detailed description thereof is omitted. The prediction/lifting/RAHT transform processor 12010 according to the embodiments may code the transformed attributes by any one or a combination of RAHT coding, prediction transform coding, and lifting transform coding. The prediction/lifting/RAHT transform processor 12010 performs at least one of the operations the same as or similar to the operations of the RAHT transformer 40008, the LOD generator 40009, and the lifting transformer 40010 described with reference to FIG. 4. In addition, the prediction transform coding, the lifting transform coding, and the RAHT transform coding are the same as those described with reference to FIGS. 1 to 9, and thus a detailed description thereof is omitted.

The arithmetic coder 12011 according to the embodiments may encode the coded attributes based on the arithmetic coding. The arithmetic coder 12011 performs an operation and/or method the same as or similar to the operation and/or method of the arithmetic encoder 400012.

The transmission processor 12012 according to the embodiments may transmit each bitstream containing encoded geometry and/or encoded attributes and metadata information, or transmit one bitstream configured with the encoded geometry and/or the encoded attributes and the metadata information. When the encoded geometry and/or the encoded attributes and the metadata information according to the embodiments are configured into one bitstream, the bitstream may include one or more sub-bitstreams. The bitstream according to the embodiments may contain signaling information including a sequence parameter set (SPS) for signaling of a sequence level, a geometry parameter set (GPS) for signaling of geometry information coding, an attribute parameter set (APS) for signaling of attribute information coding, and a tile parameter set (TPS) for signaling of a tile level, and slice data. The slice data may include information about one or more slices. One slice according to embodiments may include one geometry bitstream Geom00 and one or more attribute bitstreams Attr00 and Attr10.

A slice refers to a series of syntax elements representing the entirety or part of a coded point cloud frame.

The TPS according to the embodiments may include information about each tile (for example, coordinate information and height/size information about a bounding box) for one or more tiles. The geometry bitstream may contain a header and a payload. The header of the geometry bitstream according to the embodiments may contain a parameter set identifier (geom_parameter_set_id), a tile identifier (geom_tile_id) and a slice identifier (geom_slice_id) included in the GPS, and information about the data contained in the payload. As described above, the metadata processor 12007 according to the embodiments may generate and/or process the signaling information and transmit the same to the transmission processor 12012. According to embodiments, the elements to perform geometry encoding and the elements to perform attribute encoding may share data/information with each other as indicated by dotted lines. The transmission processor 12012 according to the embodiments may perform an operation and/or transmission method the same as or similar to the operation and/or transmission method of the transmitter 10003. Details are the same as those described with reference to FIGS. 1 and 2, and thus a description thereof is omitted.

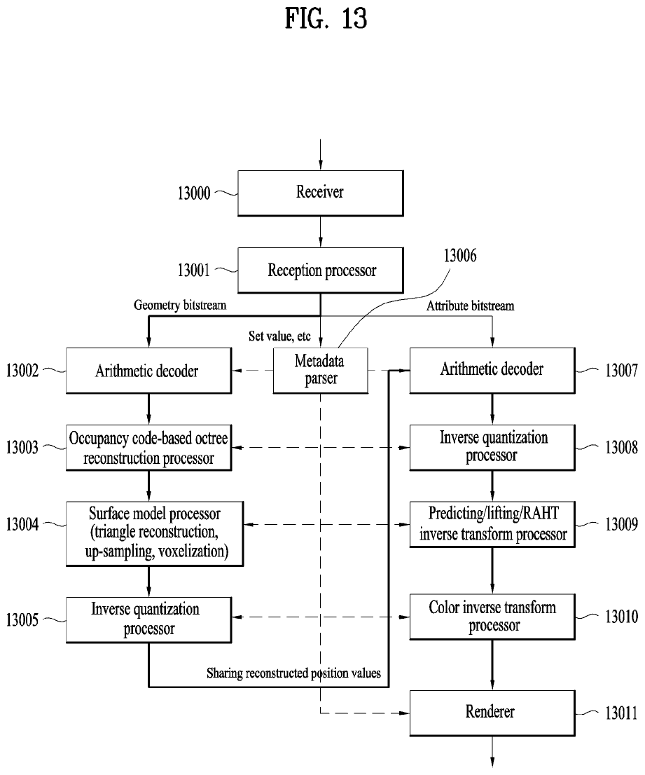

FIG. 13 illustrates a reception device according to embodiments.

The reception device illustrated in FIG. 13 is an example of the reception device 10004 of FIG. 1 (or the point cloud decoder of FIGS. 10 and 11). The reception device illustrated in FIG. 13 may perform one or more of the operations and methods the same as or similar to those of the point cloud decoder described with reference to FIGS. 1 to 11.

The reception device according to the embodiment includes a receiver 13000, a reception processor 13001, an arithmetic decoder 13002, an occupancy code-based octree reconstruction processor 13003, a surface model processor (triangle reconstruction, up-sampling, voxelization) 13004, an inverse quantization processor 13005, a metadata parser 13006, an arithmetic decoder 13007, an inverse quantization processor 13008, a prediction/lifting/RAHT inverse transform processor 13009, a color inverse transform processor 13010, and/or a renderer 13011. Each element for decoding according to the embodiments may perform an inverse process of the operation of a corresponding element for encoding according to the embodiments.

The receiver 13000 according to the embodiments receives point cloud data. The receiver 13000 may perform an operation and/or reception method the same as or similar to the operation and/or reception method of the receiver 10005 of FIG. 1. The detailed description thereof is omitted.

The reception processor 13001 according to the embodiments may acquire a geometry bitstream and/or an attribute bitstream from the received data. The reception processor 13001 may be included in the receiver 13000.

The arithmetic decoder 13002, the occupancy code-based octree reconstruction processor 13003, the surface model processor 13004, and the inverse quantization processor 13005 may perform geometry decoding. The geometry decoding according to embodiments is the same as or similar to the geometry decoding described with reference to FIGS. 1 to 10, and thus a detailed description thereof is omitted.

The arithmetic decoder 13002 according to the embodiments may decode the geometry bitstream based on arithmetic coding. The arithmetic decoder 13002 performs an operation and/or coding the same as or similar to the operation and/or coding of the arithmetic decoder 11000.

The occupancy code-based octree reconstruction processor 13003 according to the embodiments may reconstruct an octree by acquiring an occupancy code from the decoded geometry bitstream (or information about the geometry secured as a result of decoding). The occupancy code-based octree reconstruction processor 13003 performs an operation and/or method the same as or similar to the operation and/or octree generation method of the octree synthesizer 11001. When the trisoup geometry encoding is applied, the surface model processor 13004 according to the embodiments may perform trisoup geometry decoding and related geometry reconstruction (for example, triangle reconstruction, up-sampling, voxelization) based on the surface model method. The surface model processor 13004 performs an operation the same as or similar to that of the surface approximation synthesizer 11002 and/or the geometry reconstructor 11003.

The inverse quantization processor 13005 according to the embodiments may inversely quantize the decoded geometry.

The metadata parser 13006 according to the embodiments may parse metadata contained in the received point cloud data, for example, a set value. The metadata parser 13006 may pass the metadata to geometry decoding and/or attribute decoding. The metadata is the same as that described with reference to FIG. 12, and thus a detailed description thereof is omitted.

The arithmetic decoder 13007, the inverse quantization processor 13008, the prediction/lifting/RAHT inverse transform processor 13009 and the color inverse transform processor 13010 perform attribute decoding. The attribute decoding is the same as or similar to the attribute decoding described with reference to FIGS. 1 to 10, and thus a detailed description thereof is omitted.

The arithmetic decoder 13007 according to the embodiments may decode the attribute bitstream by arithmetic coding. The arithmetic decoder 13007 may decode the attribute bitstream based on the reconstructed geometry. The arithmetic decoder 13007 performs an operation and/or coding the same as or similar to the operation and/or coding of the arithmetic decoder 11005.

The inverse quantization processor 13008 according to the embodiments may inversely quantize the decoded attribute bitstream. The inverse quantization processor 13008 performs an operation and/or method the same as or similar to the operation and/or inverse quantization method of the inverse quantizer 11006.

The prediction/lifting/RAHT inverse transformer 13009 according to the embodiments may process the reconstructed geometry and the inversely quantized attributes. The prediction/lifting/RAHT inverse transform processor 13009 performs one or more of operations and/or decoding the same as or similar to the operations and/or decoding of the RAHT transformer 11007, the LOD generator 11008, and/or the inverse lifter 11009. The color inverse transform processor 13010 according to the embodiments performs inverse transform coding to inversely transform color values (or textures) included in the decoded attributes. The color inverse transform processor 13010 performs an operation and/or inverse transform coding the same as or similar to the operation and/or inverse transform coding of the color inverse transformer 11010. The renderer 13011 according to the embodiments may render the point cloud data.

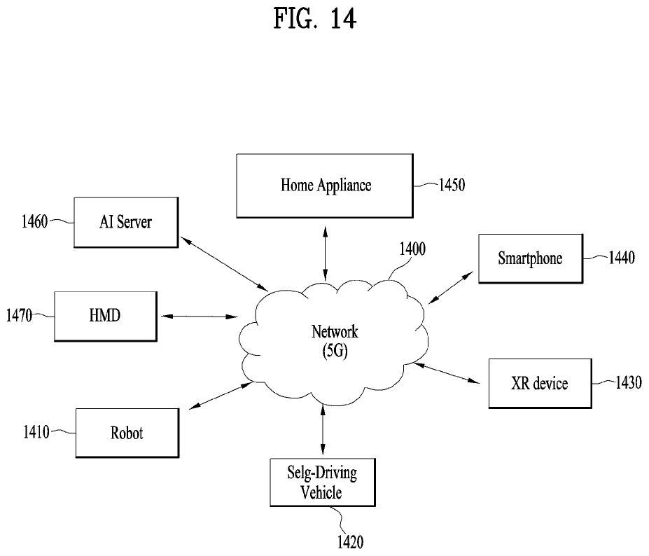

FIG. 14 illustrates an exemplary structure operable in connection with point cloud data transmission/reception methods/devices according to embodiments.

The structure of FIG. 14 represents a configuration in which at least one of a server 1460, a robot 1410, a self-driving vehicle 1420, an XR device 1430, a smartphone 1440, a home appliance 1450, and/or a head-mount display (HMD) 1470 is connected to the cloud network 1400. The robot 1410, the self-driving vehicle 1420, the XR device 1430, the smartphone 1440, or the home appliance 1450 is called a device. Further, the XR device 1430 may correspond to a point cloud data (PCC) device according to embodiments or may be operatively connected to the PCC device.

The cloud network 1400 may represent a network that constitutes part of the cloud computing infrastructure or is present in the cloud computing infrastructure. Here, the cloud network 1400 may be configured using a 3G network, 4G or Long Term Evolution (LTE) network, or a 5G network.

The server 1460 may be connected to at least one of the robot 1410, the self-driving vehicle 1420, the XR device 1430, the smartphone 1440, the home appliance 1450, and/or the HMD 1470 over the cloud network 1400 and may assist in at least a part of the processing of the connected devices 1410 to 1470.

The HMD 1470 represents one of the implementation types of the XR device and/or the PCC device according to the embodiments. The HMD type device according to the embodiments includes a communication unit, a control unit, a memory, an I/O unit, a sensor unit, and a power supply unit.

Hereinafter, various embodiments of the devices 1410 to 1450 to which the above-described technology is applied will be described. The devices 1410 to 1450 illustrated in FIG. 14 may be operatively connected/coupled to a point cloud data transmission device and reception according to the above-described embodiments.

<PCC+XR>

The XR/PCC device 1430 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 1430 may analyze 3D point cloud data or image data acquired through various sensors or from an external device and generate position data and attribute data about 3D points. Thereby, the XR/PCC device 1430 may acquire information about the surrounding space or a real object, and render and output an XR object. For example, the XR/PCC device 1430 may match an XR object including auxiliary information about a recognized object with the recognized object and output the matched XR object.

<PCC+XR+Mobile Phone>

The XR/PCC device 1430 may be implemented as a mobile phone 1440 by applying PCC technology.

The mobile phone 1440 may decode and display point cloud content based on the PCC technology.

<PCC+Self-Driving+XR>

The self-driving vehicle 1420 may be implemented as a mobile robot, a vehicle, an unmanned aerial vehicle, or the like by applying the PCC technology and the XR technology.

The self-driving vehicle 1420 to which the XR/PCC technology is applied may represent a self-driving vehicle provided with means for providing an XR image, or a self-driving vehicle that is a target of control/interaction in the XR image. In particular, the self-driving vehicle 1420 which is a target of control/interaction in the XR image may be distinguished from the XR device 1430 and may be operatively connected thereto.

The self-driving vehicle 1420 having means for providing an XR/PCC image may acquire sensor information from sensors including a camera, and output the generated XR/PCC image based on the acquired sensor information. For example, the self-driving vehicle 1420 may have an HUD and output an XR/PCC image thereto, thereby providing an occupant with an XR/PCC object corresponding to a real object or an object present on the screen.

When the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap an object on the screen. For example, the self-driving vehicle 1220 may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only CG images of real-world objects, backgrounds, and the like. On the other hand, the AR technology refers to a technology that shows a virtually created CG image on the image of a real object. The MR technology is similar to the AR technology described above in that virtual objects to be shown are mixed and combined with the real world. However, the MR technology differs from the AR technology in that the AR technology makes a clear distinction between a real object and a virtual object created as a CG image and uses virtual objects as complementary objects for real objects, whereas the MR technology treats virtual objects as objects having equivalent characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to any of the VR, AR, MR, and XR technologies. The encoding/decoding based on PCC, V-PCC, and G-PCC techniques is applicable to such technologies.

The PCC method/device according to the embodiments may be applied to a vehicle that provides a self-driving service.

A vehicle that provides the self-driving service is connected to a PCC device for wired/wireless communication.

When the point cloud data (PCC) transmission/reception device according to the embodiments is connected to a vehicle for wired/wireless communication, the device may receive/process content data related to an AR/VR/PCC service, which may be provided together with the self-driving service, and transmit the same to the vehicle. In the case where the PCC transmission/reception device is mounted on a vehicle, the PCC transmission/reception device may receive/process content data related to the AR/VR/PCC service according to a user input signal input through a user interface device and provide the same to the user. The vehicle or the user interface device according to the embodiments may receive a user input signal. The user input signal according to the embodiments may include a signal indicating the self-driving service.

As described with reference to FIGS. 1 to 14, point cloud data is composed of a set of points, and each of the points may have geometry data (geometry information) and attribute data (attribute information). The geometry data is a three-dimensional position (e.g., coordinate values on x, y, and z axes) of each point. That is, the position of each point is represented by parameters of a coordinate system representing a three-dimensional space (e.g., parameters x, y, and z for three axes representing the space, such as the X-axis, Y-axis, and Z-axis). In addition, the attribute information may represent a color (RGB, YUV, etc.), reflectance, normal vectors transparency, and the like of a point. The attribute information may be expressed as a scalar or a vector.

According to embodiments, the point cloud data may be classified into category 1 of static point cloud data, category 2 of dynamic point cloud data, and category 3, which is acquired through dynamic movement, according to the type and acquisition method of the point cloud data. Category 1 is composed of a point cloud of a single frame with a high density of points for an object or space. The data of category 3 may be divided into frame-based data having multiple frames acquired through movement and fused data of a single frame obtained by matching a point cloud acquired through a LiDAR sensor and a color image acquired as a 2D image for a large space.

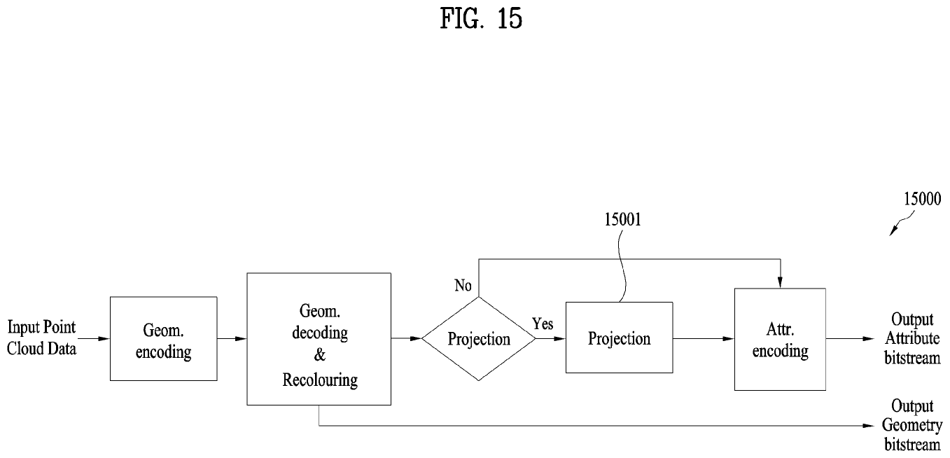

FIG. 15 is an exemplary block diagram illustrating a point cloud data transmission method according to embodiments. In the present embodiment, a projection process for point cloud data may be performed as a preprocessing for compressing attributes of the point cloud data. That is, geometry information related to input point cloud data is encoded. In the case of lossy coding, attribute information is matched with changed geometry information through geometry decoding and recoloring. Attribute encoding is then performed. Point cloud data projection may be performed by preprocessing when attribute encoding efficiency increases through changes in geometry information (when a certain pattern of data is acquired, such as, for example, LiDAR data).

This figure illustrates a point cloud data transmission method 15000 for a point cloud data transmission device (e.g., the point cloud data transmission device of FIG. 1, 2, 4, 11, or 12) according to embodiments. The point cloud data transmission device according to the embodiments may perform the same or similar operation as the encoding operation described with reference to FIGS. 1 to 14.

The point cloud data transmission method 15000 includes encoding geometry information related to point cloud data and encoding attribute information related to the point cloud data. The transmission method 15000 also includes transmitting a bitstream containing the point cloud data. The encoding of the attribute information may include determining whether to project the geometry information and projecting the geometry information (15001).

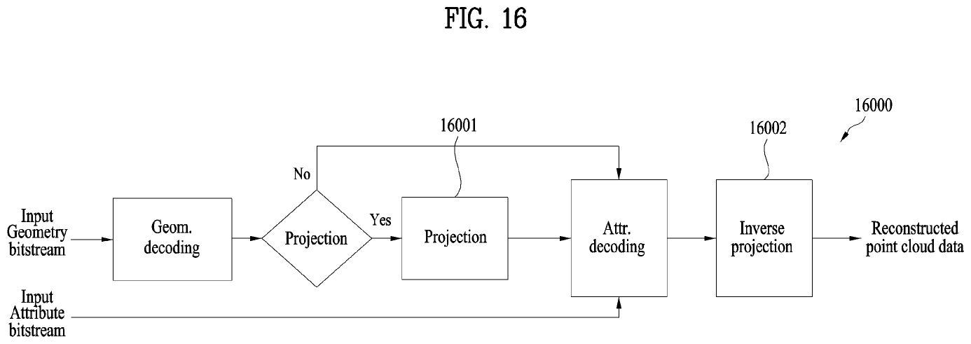

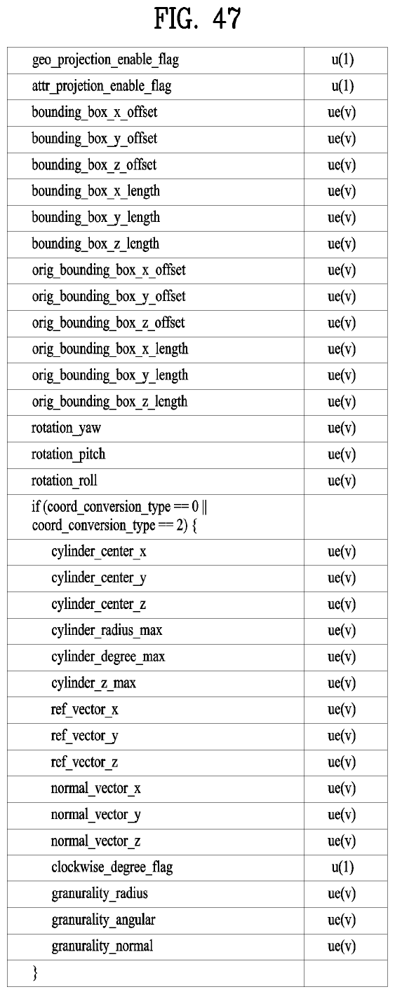

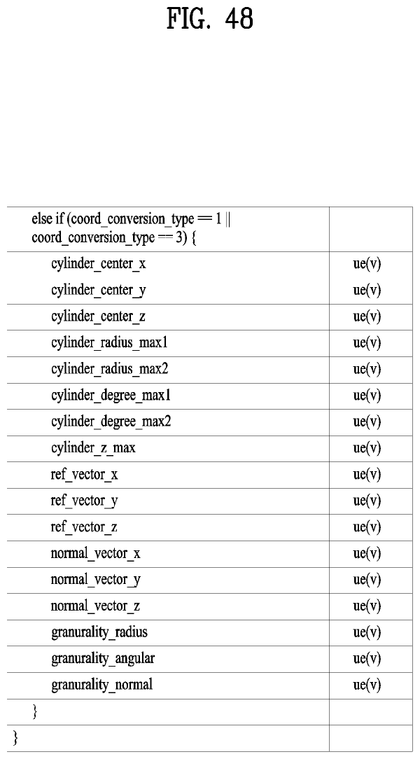

The point cloud data transmission device according to the embodiments may encode the point cloud data. The point cloud data transmission device according to the embodiments includes a geometry encoder configured to encode a geometry indicating a position of one or more points of the point cloud data and an attribute encoder configured to encode an attribute of the one or more points. The point cloud data transmission device may further include a projector configured to project positions of points for at least one of the geometry encoder and the attribute encoder. The geometry encoder according to the embodiments may perform the same or similar operation as the geometry encoding described with reference to FIGS. 1 to 14. The attribute encoder according to the embodiments may perform the same or similar operation as the attribute encoding operation described with reference to FIGS. 1 to 14. The projector may perform the projection operation in FIGS. 16 to 54, which will be described later.

The projection according to the embodiments may include converting coordinates indicating the positions of the points presented in the first coordinate system and presenting the converted coordinates in a second coordinate system, and projecting the positions of the points based on the converted coordinates indicating the positions of the points and presented in the second coordinate system. The projection 15001 of FIG. 15 may include converting the coordinates indicating the positions of the points presented in the first coordinate system and presenting the converted coordinates in the second coordinate system. The projection 15001 of FIG. 15 may include projecting the positions of the points based on the converted coordinates indicating the positions of the points and presented in the second coordinate system. The first coordinate system and the second coordinate system are the same as or similar to the first coordinate system and the second coordinate system in FIGS. 16 to 54, which will be described later. The first coordinate system according to embodiments may include a Cartesian coordinate system, and the second coordinate system may include a spherical coordinate system, a cylindrical coordinate system, or a fan-shaped coordinate system. The operation of projecting the positions of the points may be based on the coordinates indicating the positions of the points converted into the second coordinate system and a scale value. The scale value according to the embodiments is the same as or similar to the scale value for each axis described with reference to FIGS. 16 to 54.

The point cloud data transmission device according to the embodiments may transmit a bitstream containing the encoded point cloud data. The bitstream may contain signaling information about the projection operation.

FIG. 16 is an exemplary block diagram illustrating a point cloud data reception method 16000 according to embodiments. In the reception method 16000, geometry information is decoded and then attribute information is decoded. When the projection is performed on the transmitting side, the result of the attribute decoding corresponds to information matching the projected point cloud data. Accordingly, as a preprocessing operation in the attribute decoding, projection may be performed on the decoded geometry information, and the decoded attribute information may be matched with the projected geometry information. In the projection space, point cloud data in which geometry and attributes are matched may be converted into the original space positions through inverse projection.

This figure illustrates a method of receiving point cloud data by a point cloud data reception device (e.g., the point cloud data reception device of FIGS. 1, 2, 10, and 13) according to embodiments. The point cloud data reception device according to the embodiments may perform an operation the same as or similar to the decoding operation described with reference to FIGS. 1 to 35.

The point cloud data reception method 16000 includes receiving a bitstream containing point cloud data. The bitstream according to the embodiments may contain signaling information about inverse projection.

The point cloud data reception method 16000 according to embodiments includes decoding point cloud data. Specifically, the reception method 16000 includes decoding geometry information related to the point cloud data and decoding attribute information. The reception method 16000 may include an operation 16001 of projecting the geometry information and an operation 16002 of performing inverse projection in decoding and reconstructing the point cloud data. In this case, the projection 16001 and the inverse projection 16002 may be performed based on signaling information transmitted from the transmission device according to the embodiments.

From the perspective of the device corresponding to the above-described reception method 16000 and, the point cloud data reception device according to the embodiments may decode the point cloud data. The point cloud data reception device according to the embodiments may include a geometry decoder configured to decode a geometry indicating a position of one or more points of the point cloud data and an attribute decoder configured to decode an attribute of the one or more points. The point cloud data reception device according to the embodiments may further include an inverse projector configured to inversely project the positions of the points for at least one of the geometry decoder and the attribute decoder. The geometry decoder may perform an operation the same as or similar to the geometry decoding described with reference to FIGS. 1 to 54. The attribute decoder according to the embodiments may perform an operation the same as or similar to the attribute decoding described with reference to FIGS. 1 to 54. The inverse projector according to embodiments may perform an operation the same as or similar to the operation of the inverse projector described with reference to FIGS. 15 to 54.

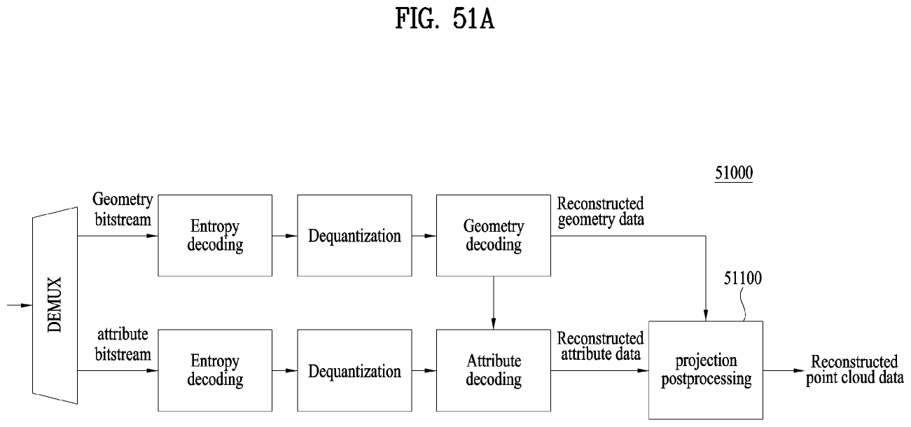

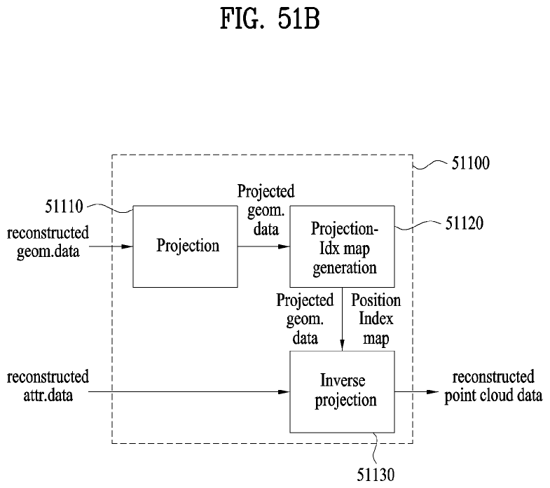

The inverse projection according to the embodiments may include inversely projecting the positions of points based on coordinates indicating the positions of the points and converting the coordinates indicating the positions of the points presented in a second coordinate system into a first coordinate system. The coordinates indicating the positions of the inverse-projected points described above may be presented in the first coordinate system. The coordinate inverse projector 51130 of FIG. 51B may perform the inverse projection of the positions of the points based on the coordinates indicating the positions of the points. The inverse projector 51130 of FIG. 51B may perform convert the coordinates indicating the positions of the points presented in the second coordinate system into the first coordinate system. The first coordinate system and the second coordinate system according to the embodiments may be the same as or similar to the first coordinate system and the second coordinate system described with reference to FIGS. 15 to 54. The first coordinate system according to the embodiments may include a Cartesian coordinate system, and the second coordinate system may include a spherical coordinate system, a cylindrical coordinate system, or a fan-shaped coordinate system. The second coordinate system may include a fan-shaped spherical coordinate system and a fan-shaped cylindrical coordinate system. The inverse projection of the positions of the points according to the embodiments may be based on the coordinates indicating the positions of the points presented in the second coordinate system and a scale value.

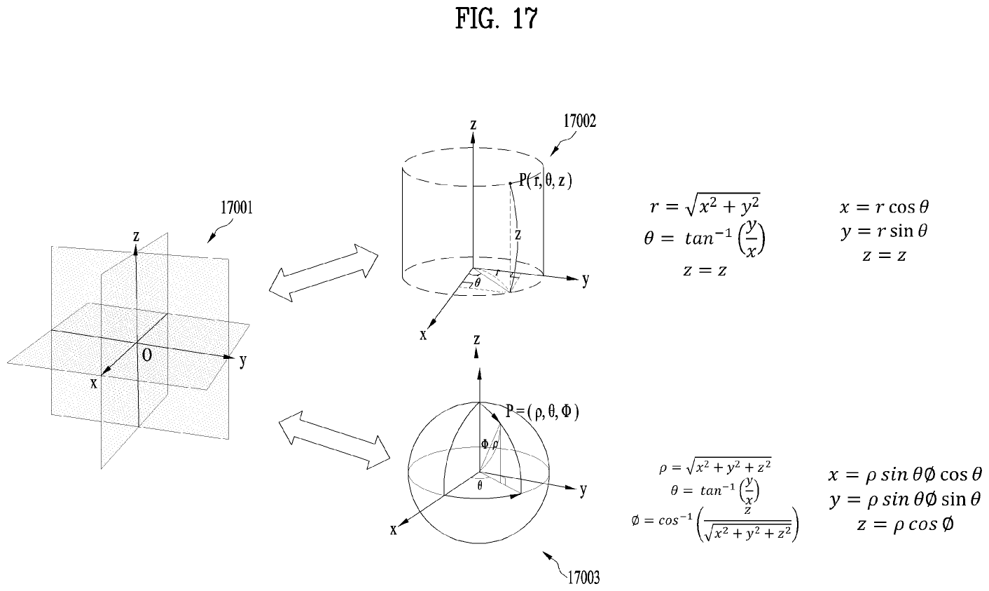

FIG. 17 illustrates an example of coordinate conversion of point cloud data according to embodiments.

This figure illustrates an example of the projection 15001 in the transmission method 15000 of FIG. 15 by the point cloud data transmission device (e.g., the point cloud video encoder 10002 of FIG. 1) according to the embodiments.

The point cloud data transmission device (e.g., the point cloud video acquirer 10001 of FIG. 1) according to the embodiments may acquire point cloud video (e.g., the point cloud video of FIG. 1). The transmission device according to the embodiments may acquire a point cloud video using LiDAR. The transmission device according to the embodiments may acquire a point cloud video through an outward-facing technique (e.g., the outward-facing technique of FIG. 3) using LiDAR.

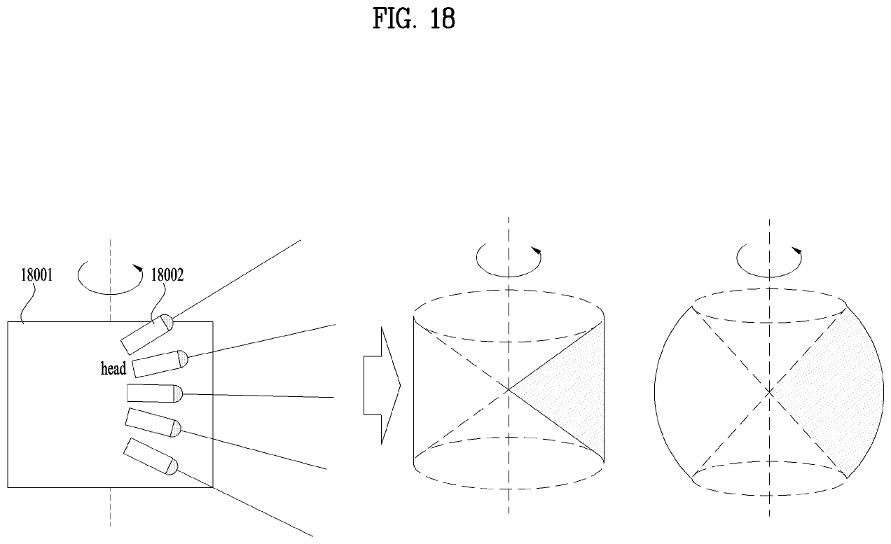

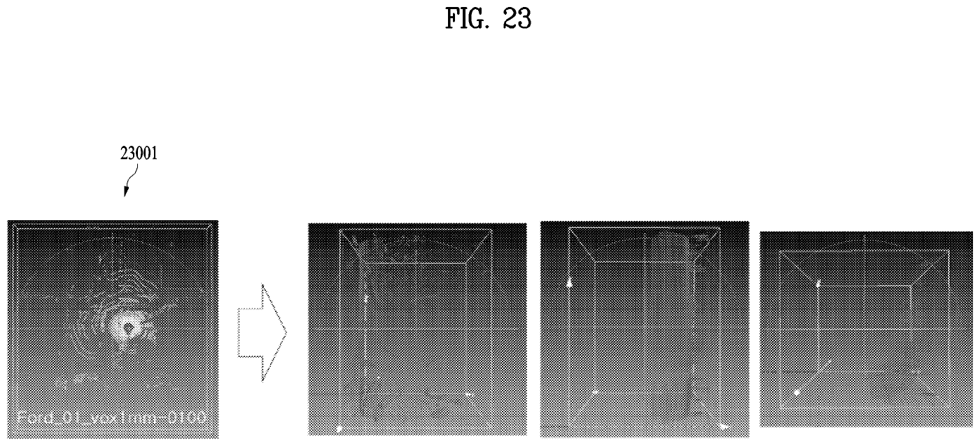

Point cloud data acquired through the LiDAR according to embodiments may be referred to as LiDAR data. The view 23001 on the left side of FIG. 23 exemplarily shows LiDAR data. The structure of the LiDAR according to the embodiments is schematically illustrated in the left view 18001 of FIG. 18 and FIGS. 21 and 22. The LiDAR according to the embodiments may acquire LiDAR data based on reflection of light emitted from one or more lasers arranged in a spinning LiDAR header. Accordingly, the LiDAR data may be configured in a cylindrical shape or a spherical shape. The distance between the light rays emitted by the one or more lasers increases as the distance from the LiDAR increases. Accordingly, the LiDAR data according to the embodiments may have a cylindrical shape in which points are sparsely distributed as the distance from the LiDAR header increases. When the encoding operation is performed based on the geometry of unevenly distributed points, coding efficiency may be degraded. For example, in the case where the encoding operation is performed based on the geometry of the unevenly distributed points, the transmission device may fail to search for points distributed at a close distance from a specific point.

Accordingly, the transmission device according to the embodiments may project may uniformly distribute the points of the point cloud data (e.g., LiDAR data) by projecting the points of the point cloud data (converting the positions thereof).

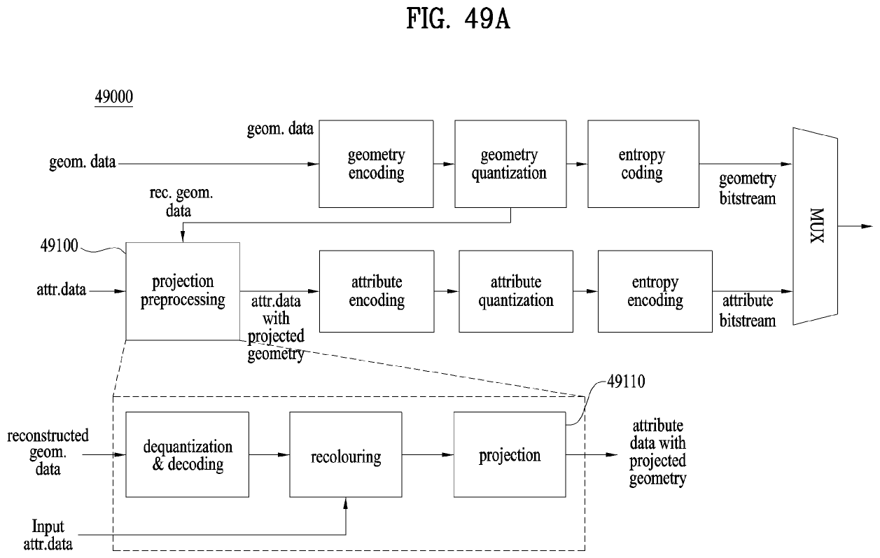

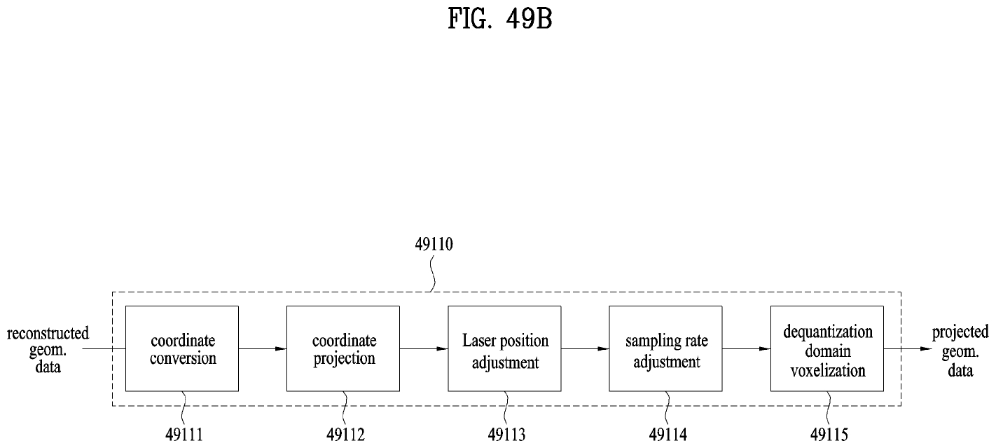

FIG. 17 illustrates converting coordinate by a transmission device (e.g., FIG. 49a) or a transmission method (FIG. 15) according to embodiments to perform a projection operation. In other words, FIG. 17 shows converting coordinates indicating positions of points presented in a first coordinate system (e.g., a Cartesian coordinate system 17001) into a second coordinate system (e.g., spherical coordinates 17003 or cylindrical coordinates 17002). The positions of the points of point cloud data (e.g., LiDAR data) acquired by the transmission device according to the embodiments may be represented by Cartesian coordinates. Accordingly, the positions of the points of the point cloud data acquired by the transmission device according to the embodiments may be expressed by parameters representing the Cartesian coordinate system (e.g., the coordinates on the x-axis, y-axis, and z-axis). The transmission device according to the embodiments may convert the coordinates indicating the positions of the points presented in the Cartesian coordinate system into cylindrical coordinates or spherical coordinates.

The transmission device according to the embodiments may convert the coordinates indicating the positions of the points presented in the Cartesian coordinate system into cylindrical coordinates. That is, the transmission device may convert the coordinates indicating the positions of the points represented as parameters representing the Cartesian coordinate system (e.g., the coordinates on the x-axis, y-axis, and z-axis) into parameters (e.g., r, θ, and z) representing cylindrical coordinates. For example, the operation of the transmission device converting the x-axis value, the y-axis value, and the z-axis value in the Cartesian coordinate system into values of r, θ, and z in the cylindrical coordinate system may be represented as follows.

$$r = \sqrt{{x}^{2} + {y}^{2}} ;$$

$$θ = {tan}^{- 1} ( \frac{y}{x} ) ;$$

$$z = z .$$

The transmission device according to the embodiments may convert the coordinates indicating the positions of the points presented in the Cartesian coordinate system into spherical coordinates. In other words, the transmission device according to the embodiments may convert the coordinates indicating the positions of the points represented by parameters representing the Cartesian coordinate system (e.g., the coordinates on the x-axis, y-axis, and z-axis) into parameters (e.g., τ, Φ and θ) representing the spherical coordinate system. For example, the operation of the transmission device converting the x-axis value, the y-axis value, and the z-axis value in the Cartesian coordinate system into values of ρ, Φ and θ in the spherical coordinate system may be represented as follows.

$$ρ = \sqrt{{x}^{2} + {y}^{2} + {z}^{2}} ;$$

$$θ = {tan}^{- 1} ( \frac{y}{x} ) ;$$

$$Φ = {cos}^{- 1} ( \frac{y}{\sqrt{{x}^{2} + {y}^{2} + {z}^{2}}} ) .$$

The projection operation (15001 in FIG. 15) according to the embodiments may include converting coordinates and projecting positions of points based on the converted coordinates indicating the positions of the points. The projection operation according to the embodiments may be performed by the projector 49110 of the transmission device (FIG. 49A) according to the embodiments.

FIG. 18 shows an example of a fan-shaped coordinate system according to embodiments.

The fan-shaped coordinate system according to the embodiments may be an additional option for coordinate conversion in addition to the cylindrical coordinate system and the spherical coordinate system. The fan-shaped coordinate system is based on that lasers arranged vertically in the LiDAR rotate horizontally to acquire data. The lasers are vertically disposed at a certain angle on the LiDAR head and horizontally rotate around a vertical axis to acquire data. In order to widen the data acquisition range, the disposed lasers are often disposed to spread radially. The fan-shaped coordinate system adopted considering this arrangement is intended for conversion based on a point on the central axis of a cylinder or sphere. The shape of the fan-shaped coordinate system corresponds to a portion of the cylinder or sphere that overlaps a figure formed by horizontally rotating, around the vertical axis, a fan-shaped plane the cylindrical or spherical shape having the origin thereof on the vertical axis and arranged parallel to the vertical axis. The elevation of the fan-shaped cylindrical coordinate system and the fan-shaped spherical coordinate system may be limited to a predetermined range.

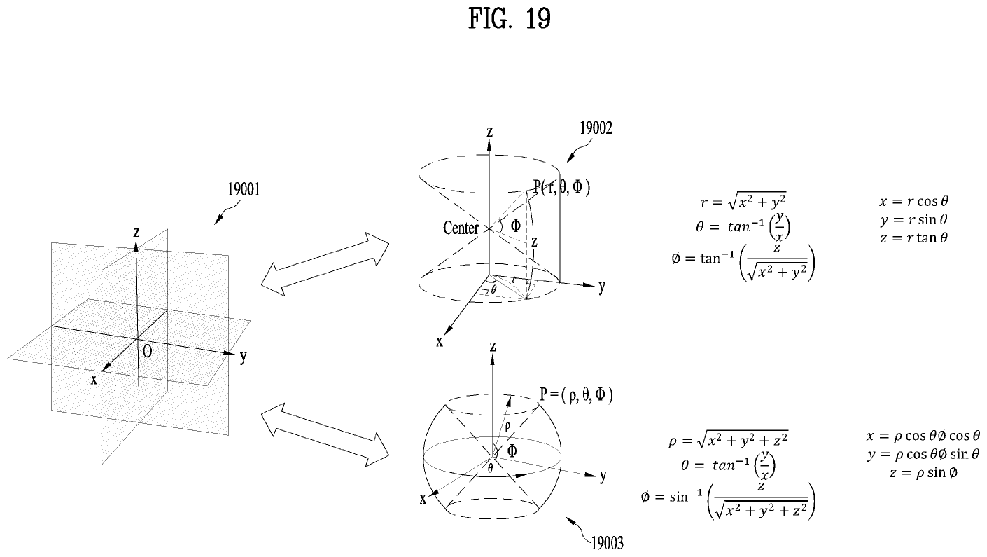

FIG. 19 illustrates an example of coordinate conversion of fan-shaped coordinates of point cloud data according to embodiments. FIG. 19 illustrates coordinate conversion performed by the transmission device (e.g., FIG. 49a) or the transmission method (FIG. 15) to perform the projection operation according to the embodiments. In other words, FIG. 19 illustrates an operation of converting coordinates indicating positions of points presented in a first coordinate system (e.g., Cartesian coordinate system 19001 into a second coordinate system (e.g., fan-shaped spherical coordinates 19003 or fan-shaped cylindrical coordinates 19002). Positions of points of point cloud data (e.g., LiDAR data) acquired by the transmission device according to embodiments may be presented as Cartesian coordinates. Accordingly, the positions of the points of the point cloud data acquired by the transmission device according to the embodiments may be represented by parameters representing the Cartesian coordinate system (e.g., coordinates on the x-axis, y-axis, and z-axis). The transmission device according to the embodiments may convert the coordinates indicating the positions of the points presented in the Cartesian coordinate system into fan-shaped cylindrical coordinates or fan-shaped spherical coordinates.

The transmission device according to the embodiments may convert the coordinates indicating the positions of the points presented in the Cartesian coordinate system into fan-shaped cylindrical coordinates. In other words, the transmission device according to the embodiments may convert the coordinates indicating the positions of the points represented by parameters representing the Cartesian coordinate system (e.g., the coordinates on the x-axis, y-axis, and z-axis) into parameters representing the fan-shaped cylindrical coordinates (e.g., r, θ, and Φ). For example, the operation of the transmission device converting the x-axis value, the y-axis value, and the z-axis value in the Cartesian coordinate system into values of r, 0, and z in the fan-shaped cylindrical coordinate system may be represented as follows.

$$r = \sqrt{{x}^{2} + {y}^{2}} ;$$

$$θ = {tan}^{- 1} ( \frac{y}{x} ) ;$$

$$Φ = {tan}^{- 1} ( \frac{z}{\sqrt{{x}^{2} + {y}^{2}}} ) .$$

The transmission device according to the embodiments may convert the coordinates indicating the positions of the points presented in the Cartesian coordinate system into fan-shaped spherical coordinates. In other words, the transmission device according to the embodiments may convert the coordinates indicating the positions of the points represented by parameters representing the Cartesian coordinate system (e.g., the coordinates on the x-axis, y-axis, and z-axis) into parameters representing the fan-shaped spherical coordinates (e.g., ρ, θ, and Φ). For example, the operation of the transmission device converting the x-axis value, the y-axis value, and the z-axis value in the Cartesian coordinate system into values of ρ, θ, and Φ in the cylindrical coordinate system may be represented as follows.

$$ρ = \sqrt{{x}^{2} + {y}^{2} + {z}^{2}} ;$$

$$θ = {tan}^{- 1} ( \frac{y}{x} ) ;$$

$$Φ = {sin}^{- 1} ( \frac{z}{\sqrt{{x}^{2} + {y}^{2} + {z}^{2}}} ) .$$

The projection operation (15001 in FIG. 15) according to the embodiments may include converting coordinates and projecting positions of points based on the converted coordinates indicating the positions of the points. The projection operation according to the embodiments may be performed by the projector 49110 of the transmission device (FIG. 49A) according to the embodiments.

The coordinate conversion may include selecting coordinates and applying the coordinate conversion. In the coordinate selection, coordinate conversion information is induced. The coordinate conversion information may include whether to perform coordinate conversion or coordinate information. The coordinate conversion information may be signaled per sequence, frame, tile, slice, or block. In addition, the coordinate conversion information may be derived based on coordinate conversion of a neighboring block, the size of the block, the number of points, the quantization value, the depth of block partition, the position of the unit, and the distance between the unit and the origin.

In the applying of the coordinate conversion, the coordinate conversion is performed based on the selected coordinate system. In the applying of the coordinate conversion, the coordinate conversion may be performed based on the coordinate conversion information. Alternatively, the coordinate conversion may not be performed based on the coordinate conversion information.

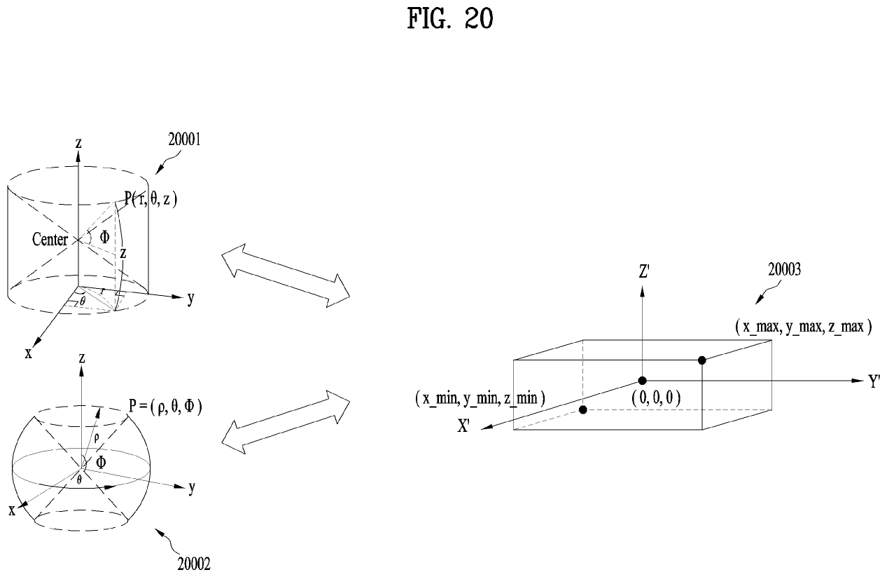

FIG. 20 illustrates an example of coordinate projection of point cloud data according to embodiments. This is an example of point cloud data projection by a point cloud data transmission device (e.g., the point cloud video encoder 10002 of FIG. 1) according to embodiments.

In order to compress point cloud data represented by converted coordinates, projection in a compressible form is required. FIG. 20 illustrates an operation of converting fan-shaped cylindrical or fan-shaped spherical coordinates into a cuboid space according to embodiments. Fan-shaped cylindrical or fan-shaped spherical coordinates (r, θ, Φ) or (ρ, θ, Φ) are converted into (X′, Y′, Z′). In the figure, (x_max, y_max, z_max) and (x_min, y_min, z_min) indicate the maximum and minimum values on each axis. (r, θ, Φ) or (ρ, θ, Φ) may correspond to each axis of X′, Y′, and Z′, or may be subjected to separate conversion. In the case of fan-shaped cylindrical coordinates, the range of Φ is limited, and compression efficiency may be increased by grouping the mapped values for the Z′ axis using tangent.

When the coordinates indicating the positions of the points presented in the Cartesian coordinate system in FIG. 20 are converted into fan-shaped cylindrical coordinates 20001 or fan-shaped spherical coordinates 20002, the transmission device (e.g., the projector 49110) according to the embodiments may project the points (i.e., convert the positions) based on the converted coordinates. For example, the transmission device may convert the positions of the points by matching the axes of the Cartesian coordinate system with r, θ, and Φ of the coordinates presented in the fan-shaped cylindrical coordinate system. The transmission device according to the embodiments may present coordinates indicating the positions of the projected points in a new coordinate system. For example, the transmission device may present the coordinates indicating the positions of the projected points as parameters representing a new Cartesian coordinate system (e.g., coordinates on each of the X′-axis, Y′-axis, and Z′-axis). The new Cartesian coordinate system according to the embodiments may be referred to as a third coordinate system. The new Cartesian coordinate system according to the embodiments may include origin (0, 0, 0), a pole (r_max (e.g., the maximum value of r), 3600 (e.g., a value corresponding to 2π [rad]), z_max (e.g., the maximum value of z]), X′-axis, Y′-axis, and Z′-axis. The X′, Y′, and Z′ axes of the new Cartesian coordinate system according to the embodiments may be orthogonal to each other at the origin (0, 0, 0). The operation of projecting points (converting positions) by the transmission device according to the embodiments is configured as follows.

1) Fan-Shaped Cylindrical Coordinate Projection 1

$${f}_{x} ( r ) = r = \sqrt{{( x - {x}_{c} )}^{2} + {( y - {y}_{c} )}^{2}} , ;$$

$${f}_{y} ( θ ) = θ = {tan}^{- 1} ( \frac{y - {y}_{c}}{x - {x}_{c}} ) ,$$

$${f}_{z} ( ϕ ) = ϕ = {tan}^{- 1} ( \frac{z - {z}_{c}}{\sqrt{{( x - {x}_{c} )}^{2} + {( y - {y}_{c} )}^{2}}} ) .$$

2) Fan-Shaped Cylindrical Coordinate Projection 2

It is a method that minimizes the calculation of the trigonometric function in consideration of the convenience of calculation.

$${f}_{x} ( r ) = {r}^{2} = {( x - {x}_{c} )}^{2} + {( y - {y}_{c} )}^{2} ,$$

$${f}_{y} ( θ ) = {cos}^{2} \frac{θ}{2} = \frac{1 + cos θ}{2} = [ 1 + \frac{x - {x}_{c}}{\sqrt{{( x - {x}_{c} )}^{2} + {( y - {y}_{c} )}^{2}}} ] / 2 = \frac{r + x - {x}_{c}}{2 r} ,$$

$${f}_{z} ( ϕ ) = tan ϕ = \frac{z - {z}_{c}}{\sqrt{{( x - {x}_{c} )}^{2} + {( y - {y}_{c} )}^{2}}} = \frac{z - {z}_{c}}{r}$$

Projection may be performed for fan-shaped spherical coordinates in a similar manner.

1) Fan-Shaped Spherical Coordinate Projection 1

$${f}_{x} ( ρ ) = ρ = \sqrt{{( x - {x}_{c} )}^{2} + {( y - {y}_{c} )}^{2} + {( z - {z}_{c} )}^{2}} ,$$

$${f}_{y} ( θ ) = θ = {tan}^{- 1} ( \frac{y - {y}_{c}}{x - {x}_{c}} ) ,$$

$${f}_{z} ( ϕ ) = ϕ = {sin}^{- 1} ( \frac{z - {z}_{c}}{\sqrt{{( x - {x}_{c} )}^{2} + {( y - {y}_{c} )}^{2} + {( z - {z}_{c} )}^{2}}} )$$

2) Fan-Shaped Spherical Coordinate Projection 2

$${f}_{x} ( ρ ) = {ρ}^{2} = {( x - {x}_{c} )}^{2} + {( y - {y}_{c} )}^{2} + {( z - {z}_{c} )}^{2} ,$$

$${f}_{y} ( θ ) = {cos}^{2} \frac{θ}{2} = \frac{1 + cos θ}{2} = [ 1 + \frac{x - {x}_{c}}{\sqrt{{( x - {x}_{c} )}^{2} + {( y - {y}_{c} )}^{2}}} ] / 2 = \frac{r + x - {x}_{c}}{2 r} ,$$

$${f}_{z} ( ϕ ) = sin ϕ = \frac{z - {z}_{c}}{\sqrt{{( x - {x}_{c} )}^{2} + {( y - {y}_{c} )}^{2} + {( z - {z}_{c} )}^{2}}} = \frac{z - {z}_{c}}{ρ} .$$

In the equations given above, (x_{c}, y_{c}, z_{c}) may denote the center position in the coordinate system before conversion, and may mean the head position of the LiDAR (e.g., xyz coordinates in the world coordinate system).

Hereinafter, projection adjustment considering the laser position of the LiDAR will be described.

The projection adjustment considering the laser position may be performed by hardware including one or more processors or integrated circuits configured to communicate with the transmission device 10000 in FIG. 1, the transmission device in FIG. 4, the transmission device in FIG. 12, the XR device 1430 in FIG. 14, the transmission device 15000 in FIG. 15, the transmission device 49000 in FIG. 49, and/or one or more memories, software, firmware, or a combination thereof. Specifically, the operation may be performed by the projector 49110 of the transmission device 49000 according to the embodiments.

In addition, the projection adjustment considering the laser position may be performed by hardware including one or more processors or integrated circuits configured to communicate with the reception device 10004 in FIG. 1, the reception device in FIG. 11, the reception device in FIG. 13, the XR device 1430 in FIG. 14, the reception device 16000 in FIG. 16, the reception device 51000 in FIG. 51, and/or one or more memories, software, firmware, or a combination thereof. Specifically, the operation may be performed by the reprojector 51110 of the reception device 51000 according to the embodiments.

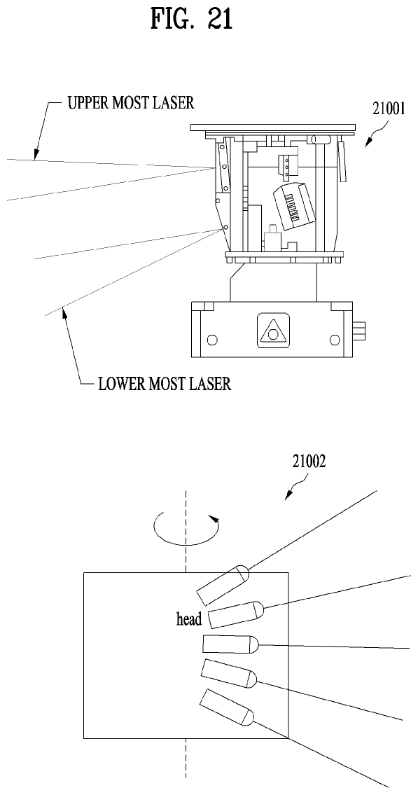

FIG. 21 schematically illustrates a LiDAR structure for acquiring point cloud data according to embodiments. In the structure of the LiDAR, a plurality of lasers is virtually arranged on the LiDAR head. In addition, as shown on the left side of FIG. 21, lasers may be disposed on the upper and lower portions of the LiDAR head, respectively, to acquire more point cloud data. In this case, a difference in position between the lasers may occur and may cause a decrease in accuracy of projection. Accordingly, a method of adjusting the projection in consideration of the positions of the lasers may be used.

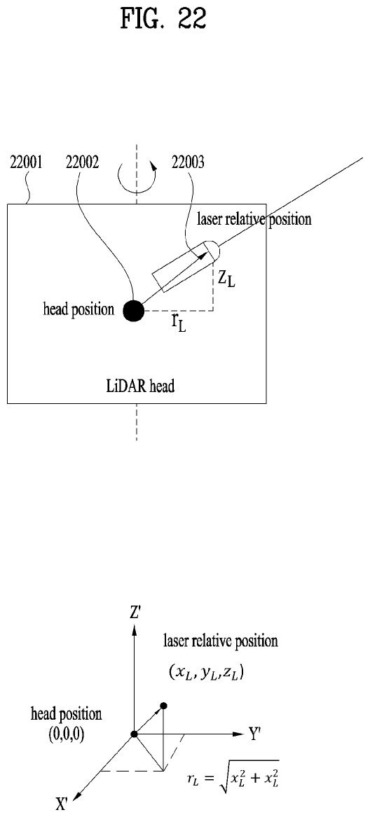

FIG. 22 shows a head position of LiDAR will and a relative position of a laser according to embodiments. In FIG. 22, the position of the laser disposed in a vertical plane is spaced apart from the head position (x_{c}, y_{c}, z_{c}) by r_{L} in the horizontal direction and by z_{L} in the vertical direction. Assuming that the head position is (0, 0, 0), the laser may be positioned at (x_{L}, y_{L}, z_{L}) in the xyz coordinate system, and (x_{L}, y_{L}) may be obtained from the following equation having r_{L}.

x_{L}=r_{L}·cos θ. y_{L}=r_{L}·sin θ

When the structure of the LiDAR is known, (x_{L}, y_{L}, z_{L}) may be directly signaled or obtained.

As described above, when the relative position of the laser, each laser starts at the head position according to the following equations.

1) Fan-Shaped Cylindrical Coordinate Conversion Considering the Laser Position

$${r}_{L} = \sqrt{{( x - {x}_{c} - {x}_{L} )}^{2} + {( y - {y}_{c} - {y}_{L} )}^{2}} = \sqrt{{( x - {x}_{c} )}^{2} + {( y - {y}_{c} )}^{2}} - {r}_{L} ,$$

$${θ}_{L} = {tan}^{- 1} ( \frac{y - {y}_{c} - {y}_{L}}{x - {x}_{c} - {x}_{L}} ) ,$$

$${ϕ}_{L} = {tan}^{- 1} ( \frac{z - {z}_{c} - {z}_{L}}{\sqrt{{( x - {x}_{c} - {x}_{L} )}^{2} + {( y - {y}_{c} - {y}_{L} )}^{2}}} ) .$$

Fan-Shaped Spherical Coordinate Conversion Considering the Laser Position

$${ρ}_{L} = \sqrt{{( x - {x}_{c} - {x}_{L} )}^{2} + {( y - {y}_{c} - {y}_{L} )}^{2} + {( z - {z}_{c} - {z}_{L} )}^{2}} ,$$

$${θ}_{L} = {tan}^{- 1} ( \frac{y - {y}_{c} - {y}_{L}}{x - {x}_{c} - {x}_{L}} ) ,$$

$${ϕ}_{L} = {sin}^{- 1} ( \frac{z - {z}_{c} - {z}_{L}}{\sqrt{{( x - {x}_{c} - {x}_{L} )}^{2} + {( y - {y}_{c} - {y}_{L} )}^{2} + {( z - {z}_{C} - {z}_{L} )}^{2}}} ) .$$

Hereinafter, the projection adjustment considering the sampling characteristics of the LiDAR will be described.

The projection adjustment considering the sampling characteristics may be performed by hardware including one or more processors or integrated circuits configured to communicate with the transmission device 10000 in FIG. 1, the transmission device in FIG. 4, the transmission device in FIG. 12, the XR device 1430 in FIG. 14, the transmission device 15000 in FIG. 15, the transmission device 49000 in FIG. 49, and/or one or more memories, software, firmware, or a combination thereof. Specifically, the operation may be performed by the projector 49110 of the transmission device 49000 according to the embodiments.

In addition, the projection adjustment considering the sampling characteristics may be performed by hardware including one or more processors or integrated circuits configured to communicate with the reception device 10004 in FIG. 1, the reception device in FIG. 11, the reception device in FIG. 13, the XR device 1430 in FIG. 14, the reception device 16000 in FIG. 16, the reception device 51000 in FIG. 51, and/or one or more memories, software, firmware, or a combination thereof. Specifically, the operation may be performed by the reprojector 51110 of the reception device 51000 according to the embodiments.

Additional adjustment may be required to use the projected point cloud data for point cloud compression. Point cloud compression assumes that X, Y, and Z data are all positive integers when Morton code sorting is used. Therefore, it is necessary to convert all the projected point cloud data to have a positive integer value. To this end, voxelization may be performed. In this regard, when all points are distinguishable, ideal lossless compression may be implemented. However, the distance between the points is short, loss may occur during the voxelization. Accordingly, adjustment for improving compression performance is needed. In this regard, the range of the point cloud projection value and the characteristics of the data acquisition device may be considered. Since r or p represents the distance from the center, it is greater than or equal to 0. Also, the frequency may be determined depending on the resolution according to the distance of the laser and the analytical ability of the acquisition device. θ denotes an azimuthal angle by which spinning about the vertical axis is performed, and may have a range of 0° to 360° in the case of a typical LiDAR, and the frequency is determined according to the amount of data acquired per 1° as the LiDAR spins. φ, which denotes an elevation angle and is highly related to a single laser angle, may have a range of −π/2 to π/2, and the frequency of data may be determined by the number of lasers, the vertical positions of the lasers, and the accuracy of the lasers. Next, a method for adjusting the projection based on the above-described characteristics is disclosed. In this case, adjustment for each axis may be defined by a scaling factor. Hereinafter, scaling for r, θ, and φ will be described, and the application method thereof may be equally applied to ρ, θ, φ, or another projection method.

fₛ(r_{L})=sᵣ·f(r_{L}), fₛ(θₛ)=s_{θ}·f(θ_{L}), fₛ(ϕₛ)=s_{ϕ}·f(ϕ_{L})

In an embodiment, a scaling factor may be defined based on mechanical characteristics of the point cloud data acquisition device. For example, when a device with N lasers arranged in a vertical plane detects M laser reflections per 1° while spinning horizontally, and the radius of a spot generated by each laser light source is D, the scaling factor may be defined as follows. kᵣ, k_{θ}, and k_{ϕ} represent constants.

sᵣ=kᵣ, s_{θ}=k_{θ}M, s_{ϕ}=k_{ϕ}D.

In an embodiment, when the minimum distance between data acquired per one laser light source is known in a vertical direction, a horizontal direction, and a radial direction, the following scaling factors may be defined. In this case, dᵣ, d_{θ}, and d_{ϕ} may denote a radial distance, an azimuthal distance, and an elevation distance, and min( ) may denote the minimum value in the point cloud data or a minimum value according to physical characteristics.

sᵣ=kᵣ/min(dᵣ), s_{θ}=k_{θ}/min(d_{θ}), s_{ϕ}=k_{ϕ}/min(d_{ϕ})

In an embodiment, a scaling factor may be defined as a function of the density along each axis. In other words, a large scaling factor may be assigned to an axis having a high density per unit length, and a relatively small scaling factor may be assigned to an axis having a low density per unit length. For example, when the maximum number of points in a direction parallel to each axis is N and the length of each axis is D, scaling factors may be defined as follows.

sᵣ=kᵣNᵣ/Dᵣ, s_{θ}=k_{θ}N_{θ}/D_{θ}, s_{ϕ}=k_{ϕ}N_{ϕ}/D_{ϕ}

In an embodiment, different scaling factors may be defined according to importance. For example, information close to the origin may be considered as important information, and different weights may be applied depending on the distance from the origin (or center). In addition, larger weights may be applied to front information with respect to the azimuthal angle or the elevation angle or information close to the horizon. In this case, the weight may be assigned stepwise according to the range of the important portions, or may be given as an inverse of the exponential.

sᵣ=kᵣ/g(r), s_{θ}=k_{θ}/g(θ), s_{ϕ}=k_{ϕ}/g(ϕ)

In an embodiment, each axis may be moved to start from the origin to ensure that the projected point cloud data is composed of positive numbers. Attribute coding may use Morton code order (prediction-lift), or octree-based geometry information (RAHT), and the length of each axis may be set to be power of 2 to uniformly widen the distribution within the range of available positions. In addition, in order to increase compression efficiency, the lengths of the three axes may be set equal to each other. The adjustment considering these details may be represented as follows.

$${f}_{s} ( {r}_{L} ) = \frac{{2}^{nr} - 1}{{max}_{r}} [ {s}_{r} \cdot f ( {r}_{L} ) - {min}_{r} ] ,$$

$${f}_{s} ( {θ}_{s} ) = \frac{{2}^{n θ} - 1}{{max}_{θ}} [ {s}_{θ} \cdot f ( {θ}_{L} ) - {min}_{θ} ] ,$$

$${f}_{s} ( {ϕ}_{s} ) = \frac{{2}^{n ϕ} - 1}{{max}_{ϕ}} [ {s}_{ϕ} \cdot f ( {ϕ}_{L} ) - {min}_{ϕ} ]$$

if sampling_adjustment_cubic_flag=1,

$${f}_{s}^{′} ( {r}_{L} ) = \frac{max}{{max}_{r}} {f}_{s} ( {r}_{L} ) ,$$

$${f}_{s}^{′} ( {θ}_{L} ) = \frac{max}{{max}_{θ}} {f}_{s} ( {θ}_{L} ) ,$$

$${f}_{s}^{′} ( {ϕ}_{L} ) = \frac{max}{{max}_{ϕ}} {f}_{s} ( {ϕ}_{L} ) ,$$

where max may denote max (maxᵣ, max_{θ}, max_{ϕ}). Alternatively, it may be the nearest 2\hat{ }n−1 among numbers greater than max (maxᵣ, max_{θ}, max_{ϕ}).

As described above, the point cloud data transmission device according to the embodiments may change the positions of points in consideration of characteristics (e.g., distribution of points) of the acquired point cloud data. In addition, the transmission device according to the embodiments may change the positions of points based on a scale value for each axis according to the distribution of the points. When the scale value for each axis according to the embodiments is greater than 1, the positions of the projected points may be sparser than the positions of the points before being projected. On the contrary, when the scale value for each axis according to the embodiments is less than 1, the positions of the projected points may be denser than the positions of the points before being projected. For example, when the points of the acquired point cloud data are densely distributed along the x-axis and y-axis and sparsely distributed along the z-axis, the transmission device may project the points to be uniformly distributed, based on α and β, which are greater than 1, and γ, which is less than 1.

The point cloud data transmission device according to the embodiments may perform coding based on the positions (or geometry) of the projected points. Accordingly, the point cloud data transmission device according to the embodiments may increase coding efficiency by using the projected geometry (e.g., geometry with a uniform distribution), thereby securing a higher coding gain.

Hereinafter, voxelization will be described.

The voxelization may be performed by hardware including one or more processors or integrated circuits configured to communicate with the transmission device 10000 in FIG. 1, the transmission device in FIG. 4, the transmission device in FIG. 12, The XR device 1430 in FIG. 14, the transmission device 15000 in FIG. 15, the transmission device 49000 in FIG. 49, and/or one or more memories, sortware, firmware, or a combination thereof.

In addition, the voxelization may be performed by hardware including one or more processors or integrated circuits configured to communicate with the reception device 10004 in FIG. 1, the reception device in FIG. 11, the reception device in FIG. 13, the XR device 1430 in FIG. 14, the reception device 16000 in FIG. 16, the reception device 51000 in FIG. 51, and/or one or more memories, software, firmware, or a combination thereof. Specifically, the operation may be performed by the reprojector 51110 of the reception device 51000 according to the embodiments.

Through the above-described operation, point cloud data represented by X, Y, and Z coordinates may be converted into coordinates efficient for compression, such as a distance and an angle. Through the voxelization, the converted data may be converted into integer position information for applying point cloud compression technology.

FIG. 23 illustrates projected point cloud data according to embodiments. In the figure, the leftmost part shows the data before projection and the right part shows the projected data. The right parts show point cloud data projected onto the r-θ, φ-θ, and φ-r planes, respectively.

Hereinafter, inverse projection will be described.

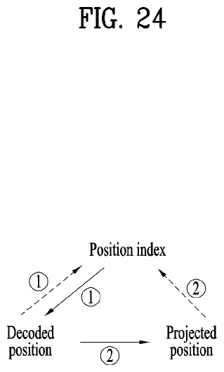

FIG. 24 illustrates a method of using position index information in inverse projection according to embodiments.

The inverse projection may be performed by hardware including one or more processors or integrated circuits configured to communicate with the reception device 10004 in FIG. 1, the reception device in FIG. 11, the XR device 1430 in FIG. 14, the reception device 16000 in FIG. 16, the reception device 51000 in FIG. 51, and/or one or more memories, software, firmware, or a combination thereof. Specifically, the operation may be performed by the inverse projector 51130 of the reception device 51000 according to the embodiments.

The inverse projection may be performed in the same manner as the projection of point cloud data. In the inverse projection, point cloud data in a projected coordinate system may be converted to an original coordinate system using an inverse conversion-related equation. When the projection is applied to attribute coding, reconstructed geometry information may be linked with corresponding attribute information such that the attribute information may be restored by being matched with appropriate values.

To connect the projected geometry information with the geometry information given before being projected, the geometry information may be indexed. That is, the reception device according to the embodiments may sort the reconstructed geometry information in a certain manner (e.g., Morton code order, x-y-z zigzag order, etc.) and then assign indexes thereto in order.

In an embodiment, as in relationship 1 in FIG. 24, an index-to-decoded position map and a decoded position-to-index map may be generated based on the relationship between the positions and the indexes established before projection. Projection is performed on the position information assigned indexes. In this operation, a decoded position to projected position map may be generated as shown in relationship 2 in FIG. 24, and a projected position to index map may be generated by the relationship between the decoded positions and indexes.

After attribute decoding, the projected points have attribute values. Original positions may be found based on the projected positions using the projected position to index map and the index to position map. In this way, the reconstructed geometry information and the restored attribute information may be mutually matched.

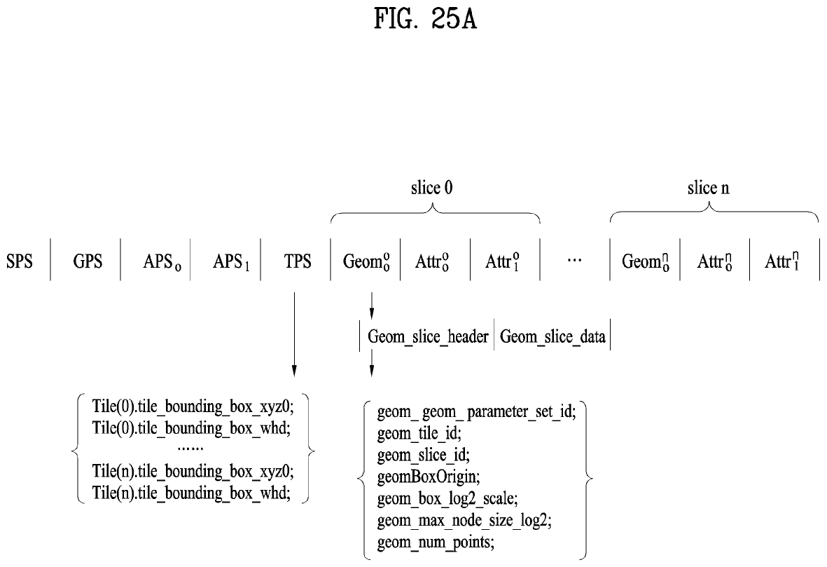

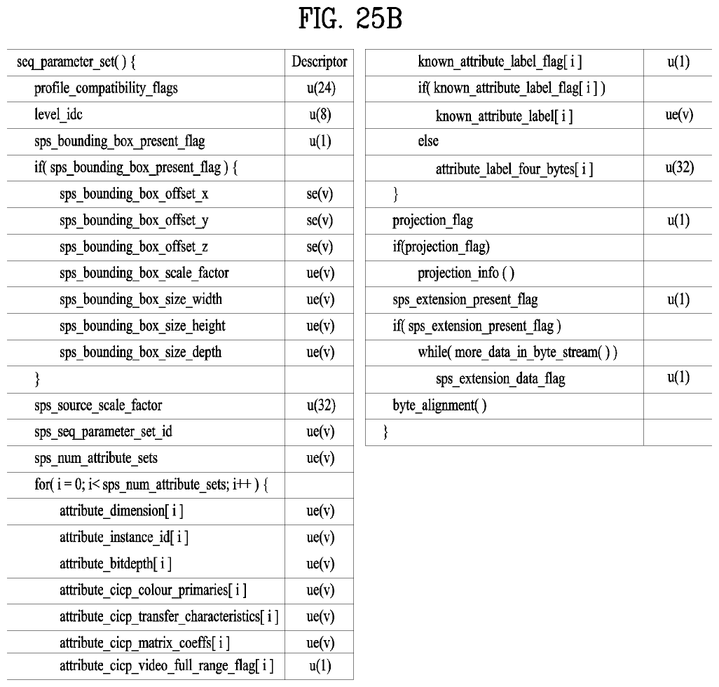

FIG. 25A shows an example of encoded point cloud data according to embodiments.

The point cloud video encoder 10002 according to the embodiments may encode point cloud data in the operation of the encoding 20001, and the transmitter 10003 according to the embodiments may transmit a bitstream containing the encoded point cloud data to the reception device 10004.

The encoded point cloud data (bitstream) according to the embodiments may be generated by hardware including one or more processors or integrated circuits configured to communicate with the point cloud video encoder 10002 in FIG. 1, the encoding 20001 in FIG. 2, the encoder in FIG. 4, the transmission device in FIG. 12, the XR device 1430 in FIG. 14, the transmission device in FIG. 21, and/or one or more memories, software, firmware, or a combination thereof.

In addition, the encoded point cloud data (bitstream) according to the embodiments may be decoded by hardware including one or more processors or integrated circuits configured to communicate with the point cloud video decoder 10006 in FIG. 1, the decoding 20003 in FIG. 2, the decoder in FIG. 11, the reception device in FIG. 13, the XR device 1430 in FIG. 14, the reception device in FIG. 22, and/or one or more memories, software, firmware, or a combination thereof.

The abbreviations shown in FIG. 25A have the following meanings.
SPS: Sequence Parameter Set
GPS: Geometry Parameter Set
APS: Attribute Parameter Set
TPS: Tile Parameter Set
Geom: Geometry bitstream=geometry slice header+geometry slice data
Attr: Attribute bitstream=attribute brick header+attribute brick data

Referring to FIG. 25A, projection-related information according to the embodiments may be defined in a sequence parameter set, an attribute parameter set, and an SEI message. The sequence parameter set may inform that projection is performed, and detailed information may be delivered to the reception device according to the embodiments by projection_info( ). In addition, all or part of related information may be carried in the sequence parameter set, and some of the remaining information may be delivered to the reception device by the geometry parameter set, attribute parameter set, tile parameter set, slice header, or SEI message. Depending on the application or system, a corresponding position or a separate position may be defined, and the application range and application method of the delivered information may be set differently. In addition, when the defined syntax element is applicable to a plurality of point cloud data streams as well as a point cloud data stream, the related information may be delivered to the reception device by a higher-level parameter set.

Hereinafter, parameters (metadata, signaling information, etc.) according to the embodiments may be generated in the process of the transmission device or transmission method according to the embodiments, and transmitted to the reception device according to the embodiments so as to be used in reconstructing point cloud data. For example, the parameters according to the embodiments may be generated by a metadata processor (or metadata generator) of the transmission device according to the embodiments, and acquired by a metadata parser of the reception device according to the embodiments.

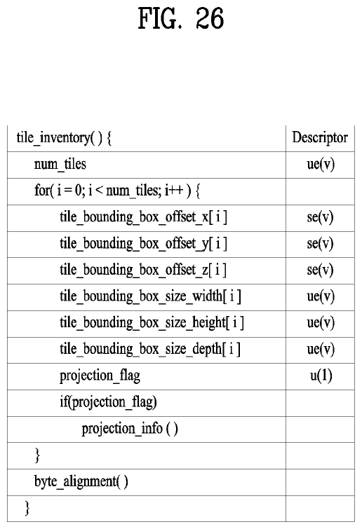

FIG. 25B shows an example in which projection-related information is defined in the SPS, and FIG. 26 shows an example of syntax of a tile inventory and a slice header. The information may be used when projection is performed after dividing tiles or slices, and the projection may be applied to either geometry or attributes. Bounding box information and the like may be transmitted through each piece of information or may employ information in projection_info defined according to embodiments.

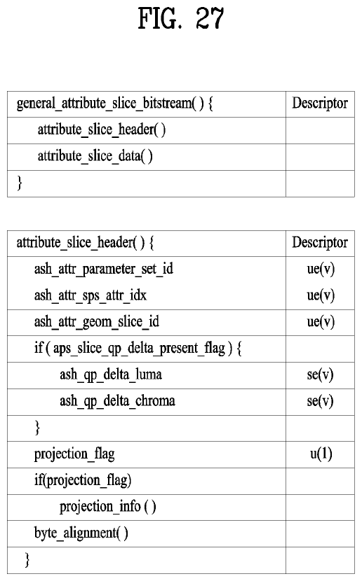

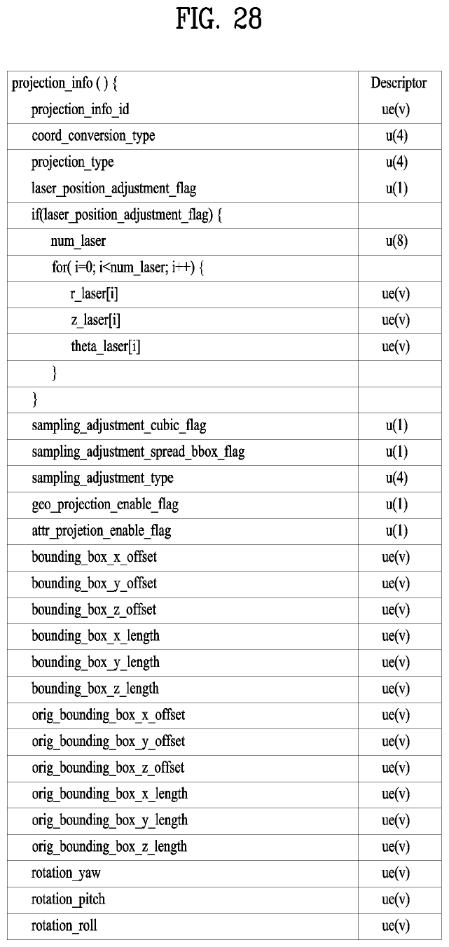

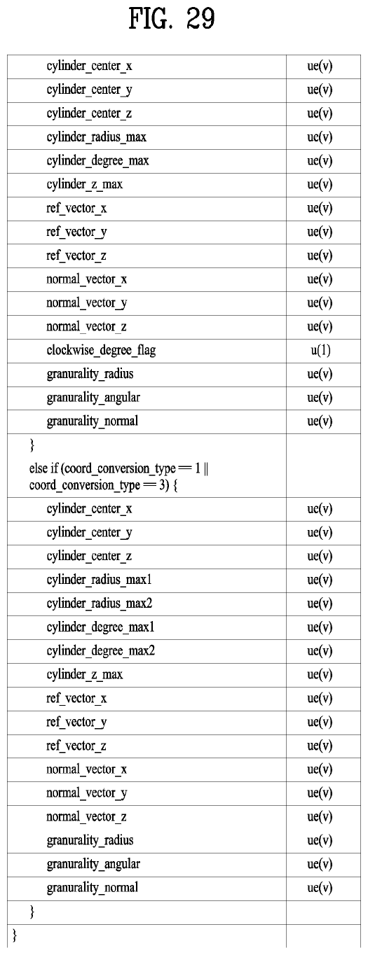

FIG. 27 shows an example of syntax of a general attribute slice bitstream and an attribute slice header according to embodiments, and FIGS. 28 and 29 show an example of syntax of projection info according to embodiments.

projection_flag equal to 1 indicates that an operation of reprojection or inverse projection of the decoded data into the XYZ coordinate space is required in the post-processing of the decoder. When projection_flag is equal to 1, projection info may be transmitted such that the reception device may identify specific information for reprojection or inverse projection.

projection_info_id is an indicator indicating projection info.

Among the values of coordinate_conversion_type, 0 may indicate a cylindrical coordinate system, 1 may indicate a spherical coordinate system, 2 may indicate a fan-shaped cylindrical coordinate system with a triangular pyramid removed, and 3 may indicate a fan-shaped spherical coordinate system formed by rotating a fan shaped-area.

projection_type indicates a type of projection used for the coordinate conversion type. For example, when coordinate_conversion_type is equal to 2, x, y, and z may be defined to match r, θ, and ϕ if projection_type is equal to 0, and to match r2, cos 2θ/2, tan ϕ. projection_type may be defined for each axis when necessary.

laser_position_adjustment_flag equal to 1 may be indicated projection adjustment considering the laser position. num_laser indicates the total number of lasers. r_laser indicates the horizontal distance from the central axis of the laser. z_laser indicates the vertical distance from the horizontal center of the laser. theta_laser indicates an elevation angle of the laser. In this way, r_laser, z_laser, and theta_laser, or x_laser, y_laser, and z_laser may be provided as laser position information.

When sampling_adjustment_cubic_flag is equal to 1, the lengths of the three axes are equal in performing adjustment on a basis of the sampling characteristics.

When sampling_adjustment_spread_bbox_flag is equal to 1, a method of uniformly widening the distribution within the bounding box may be used in performing sampling adjustment.

sampling_adjustment_type indicates a sampling adjustment method. Among the values thereof, 0 may be defined as adjustment based on mechanical characteristics, 1 may be defined as adjustment based on the minimum axial distance between points, 2 may be defined as adjustment based on the density on each axis, 3 may be defined as adjustment according to importance of points.

geo_projection_enable_flag or attr_projection_enable_flag set to 1 indicates that the converted coordinates are used during geometry or attribute coding.

(bounding_box_x_offset, bounding_box_y_offset, bounding_box_z_offset) indicates a starting point of a range including coordinate-converted point cloud data. For example, when projection_type is 0, the starting point may be indicated as (0, 0, 0). When projection_type is 1, the starting point may be indicated as (−r_max1, 0, 0).

bounding_box_x_length, bounding_box_y_length, and bounding_box_z_length may indicate a range including coordinate-converted point cloud data. When projection_type is 0, r_max, 360, and z_max may be matched. When projection_type is 1, r_max1+r_max2, 180, and z_max may be matched.

orig_bounding_box_x_offset, orig_bounding_box_y_offset, and orig_bounding_box_z_offset may indicate a starting point of a range including point cloud data given before coordinate conversion.

orig_bounding_box_x_length, orig_bounding_box_y_length, and orig_bounding_box_z_length may indicate a range including point cloud data before coordinate conversion.

rotation_yaw, rotation_pitch, and rotation_roll are rotation information used in coordinate conversion.

cylinder_center_x, cylinder_center_y, and cylinder_center_z indicate the center position of a cylindrical column in the original XYZ coordinate system.

cylinder_radius_max, cylinder_degree_max, and cylinder_z_max indicate the maximum values of the radius, degree, and height of a cylindrical column in the original XYZ coordinate system.

ref_vector_x, ref_vector_y, ref_vector_z indicate the direction of a vector that is the basis of projection of the cylindrical column as a direction of (x, y, z) from the center. They may correspond to the x-axis of a converted bounding box.

normal_vector_x, normal_vector_y, and normal_vector_z indicate the direction of a normal vector of the cylindrical column as a direction of (x, y, z) from the center. It may correspond to the z-axis of the converted bounding box.

clockwise_degree_flag indicates a direction in which a cylindrical angle is obtained. The flag set to 1 indicates a clockwise direction in the top view, and the flag set to 0 indicates a counterclockwise direction in the top view. It may correspond to the directionality of the y-axis of the converted bounding box. (In this embodiment, the flag is 0.)

granularity_angular, granularity_radius, and granularity_normal are parameters indicating the resolutions for the angle, the distance from the center in the circular plane, and the distance from the center in the direction of the normal vector. They may correspond to the scaling factors α, β, and γ used in performing cylindrical coordinate conversion.

Coordinate conversion may be proposed to improve the performance of G-PCC attribute coding for data acquired by LiDAR. In this method, the position of each point distributed in a cylindrical coordinate system may be converted into a cuboid coordinate system whose axes is a function of radius, azimuthal angle (horizontal angle), and elevation angle (vertical angle). Given a point position (x, y, z) in the XYZ coordinate system, the corresponding position in the cylindrical coordinate system is derived as follows.

$${r}_{L} = \sqrt{{( x - {x}_{c} - {x}_{L} )}^{2} + {( y - {y}_{c} - {y}_{L} )}^{2}} ,$$

$${θ}_{L} = {tan}^{- 1} ( \frac{y - {y}_{c} - {y}_{L}}{x - {x}_{c} - {x}_{L}} ) ,$$

$${ϕ}_{L} = {tan}^{- 1} ( \frac{z - {z}_{c} - {z}_{L}}{\sqrt{{( x - {x}_{c} - {x}_{L} )}^{2} + {( y - {y}_{c} - {y}_{L} )}^{2}}} ) ,$$

where (x_{c}, y_{c}, z_{c}) and (x_{L}, y_{L}, z_{L}) denote the position of each LiDAR head center and the relative position of the laser, respectively. Coordinate conversion may be performed using (r_{L}, θ_{L}, ϕ_{L}) as follows.

x′=sᵣ·r_{L}, y′=s_{θ}·θ_{L}, z′=s_{ϕ}·tan ϕ_{L},

Here, the parameters sᵣ, se, and so are derived as the maximum length of a bounding box edge normalized with the lengths of the bounding box edges on each axis.

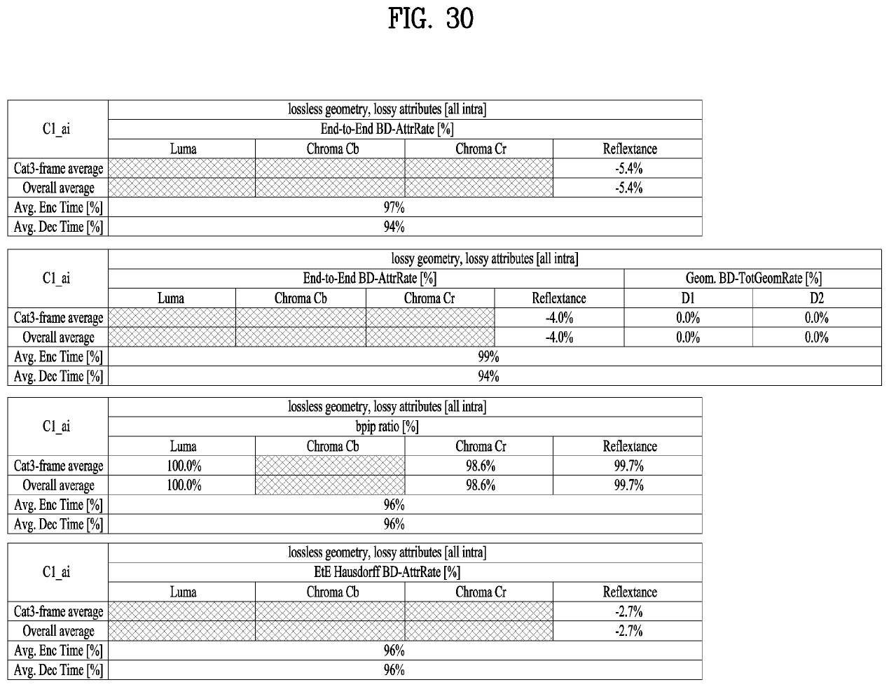

FIG. 30 shows a summary of BD rate and BD PSNR of coordinate conversion for the pre-lift coding scheme. Overall averages of reflectance gain are 5.4%, 4.0%, 1.4%, and 2.7% for the conditions of C1, C2, CW, and CY.

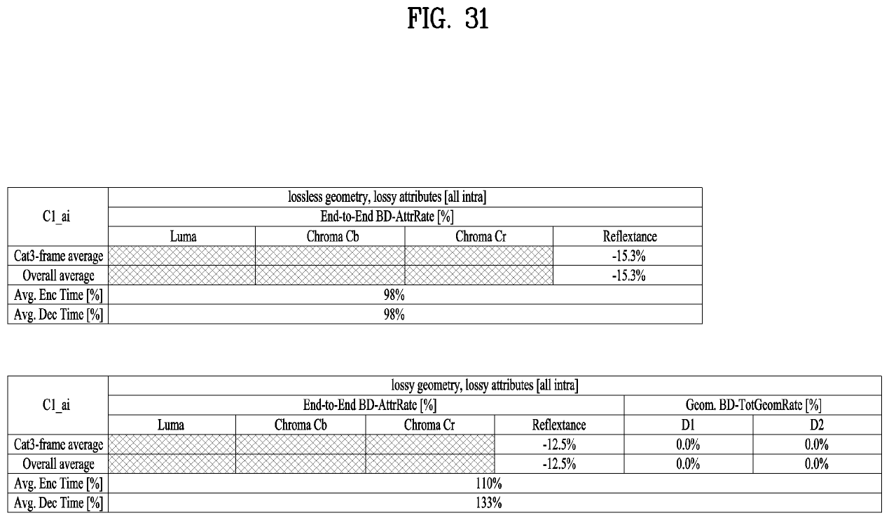

The proposed coordinate conversion may also be applied to the RAHT attribute coding scheme, and FIG. 31 shows the summarized results. In the case of the RAHT attribute coding, the average performance improvement of Cat3-frame data has increased significantly by 15.3% and 12.5% on the conditions of C1 and C3, respectively.

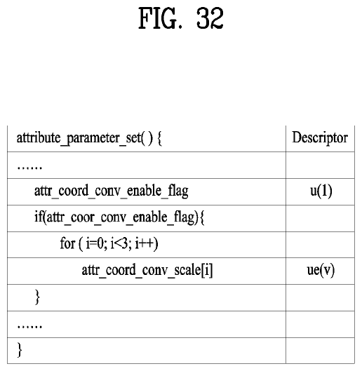

FIG. 32 shows an example of syntax of an attribute parameter set according to embodiments.

attr_coord_conv_enable_flag equal to 1 indicates that point cloud conversion is performed in the attribute coding process. attr_coord_conv_enable_flag equal to 0 indicates that point cloud conversion is not performed in the attribute coding process.

coord_conv_scale_present_flag equal to 1 indicates that the coordinate conversion scale factors scale_x, scale_y, and scale_z are present. coord_conv_scale_present_flag equal to 0 indicates that the coordinate conversion scale factors are not present, and scale_x, scale_y, and scale_z are the maximum distances for all axes normalized by the maximum distances of the x, y, and z axes.

attr_coord_conv_scale specifies the scale factor of the coordinate converted axis in units of 2-8.

The array ScaleAxis, with ScaleAxis[i] for i in the range of 0 to 2, is derived as follows.

ScaleAxis[0]=attr_coord_conv_scale[0]

ScaleAxis[1]=attr_coord_conv_scale[1]

ScaleAxis[2]=attr_coord_conv_scale[2]

When attr_coord_conv_enabled_flag is equal to 1, the coordinate conversion process is invoked as the pre-processing for the attribute decoding and the output PointPos is used in the subsequent attribute decoding process. After conducting the attribute decoding process, the post-processing of coordinate conversion s invoked to match attribute with the point position in the Cartesian coordinate system.

Hereinafter, the pre-processing of coordinate conversion for the attribute decoding will be described.

The inputs to this process are:
the array PointPos specifying the point position represented in the Cartesian coordinate;
an indicator attr_coord_conv_enabled_flag specifying the use of coordinate conversion in the attribute coding process;
a variable number_lasers specifying the number of lasers;
a variable LaserAngle specifying the tangent of the elevation angle of lasers;
a variable specifying the (x, y, z) coordinates of the origin of lasers;
a variable ScaleAxis specifying the scale factors for coordinate conversion of each axis;
a variable LaserCorrection for correction of the laser position relative to the geomAngularOrigin.

The outputs of this process is the modified array PointPos and PointPosCart may specify the linkage between the positions before and after the coordinate conversion.

Hereinafter, a process of determining the laser index will be described.

This process applies only when attr_coord_conv_enabled_flag is equal to 1. This process determines laserIndex[pointIdx] with pointIdx in the range of 0 to PointCount−1 for a point that undergoes coordinate conversion.

First, the estimate laserIndexEstimate[pointIdx] is computed by determining a node angle PointTheta. The operation may be described as follows.

sPoint=(PointPos[pointIdx][0]−geomAngularOrigin[0])<<8

tPoint=(PointPos[pointIdx][1]−geomAngularOrigin[1])<<8

r2=sPoint×sPoint+tPoint×tPoint

rInvLaser=1÷Sqrt(r2)

PointTheta=((PointPos[pointIdx][2]−geomAngularOrigin[2])×rInvLaser)>>14

Then, the laser angle LaserAngle[laserIndexEstimate[pointIdx]] closest to this point is determined. The operation may be described as follows.

```
start = 0
end = number_lasers − 1
for (int t = 0; t <= 4; t++) {
  mid = (start + end) >> 1
  if (LaserAngle[mid] > PointTheta)
    end = mid
  else
    start = mid
}
minDelta = Abs(LaserAngle[start] − PointTheta)
laserIndex[pointIdx] = start
for (j = start + 1; j <= end; j++) {
  delta = Abs(LaserAngle[j] − PointTheta)
  if (delta < minDelta) {
    minDelta = delta
    laserIndex[pointIdx] = j
  }
}
```

Hereinafter, the coordinate conversion process will be described.

At the beginning of the process, the position in the array of point positions in Cartesian coordinates is copied to PointPosCart[pointIdx] with pointIdx in the range of 0 to PointCount−1. The process may be described as follows.

PointPosCart[pointIdx][0]=PointPos[pointIdx][0]

PointPosCart[pointIdx][1]=PointPos[pointIdx][1]

PointPosCart[pointIdx][2]=PointPos[pointIdx][2]

The following process is applied to a point to convert the coordinate axis from the Cartesian coordinate to the cylindrical coordinate where ConvPointPos[pointIdx] specifies the point position of the converted cylindrical coordinate system with pointIdx in the range of 0 to PointCount−1. The process may be described as follows.

ConvPointPos[pointIdx][0]=Sqrt(r2)>>8;

ConvPointPos[pointIdx][1]=(atan 2(tPoint,sPoint)+3294199)>>8;

ConvPointPos[pointIdx][2]=((PointPos[pointIdx][2]−geomAngularOrigin[2]−LaserCorrection[laserIndex[pointIdx]])×rInvLaser)>>22.

The updated PointPos may be specified as multiples of the scale factor on each axis. If ScaleAxis is a non-zero positive value, the updated PointPos may be derived as follows.

PointPos[pointIdx][0]=((ConvPointPos[pointIdx][0]−MinPointPos[0])×ScaleAxis[0])>>8;

PointPos[pointIdx][1]=((ConvPointPos[pointIdx][1]−MinPointPos[1])×ScaleAxis[1])>>8;

PointPos[pointIdx][2]=((ConvPointPos[pointIdx][2]−MinPointPos[2])×ScaleAxis[2])>>8,
where MinPointPos is the minimum point position of ConvPointPos[pointIdx], where pointIdx is in the range of 0 to pointCount−1.

If at least one of the elements of ScaleAxis is equal to 0, ScaleAxis is derived by the bounding box. Let MaxPointPos be the maximum point position of the given ConvPointPos, and the length of the bounding box along the axis LengthBbox may be defined as:

LengthBbox[0]=MaxPointPos[0]−MinPointPos[0];

LengthBbox[1]=MaxPointPos[1]−MinPointPos[1];

LengthBbox[2]=MaxPointPos[2]−MinPointPos[2].

The maximum length among the three is defined.

MaxLengthBbox=Max(LengthBbox[0],Max(LengthBbox[1],LengthBbox[2]))

Then, ScaleAxis may be derived as follows.

ScaleAxis[0]=MaxLengthBbox+LengthBbox[0]

ScaleAxis[1]=MaxLengthBbox+LengthBbox[1]

ScaleAxis[2]=MaxLengthBbox+LengthBbox[2]

Hereinafter, a post-processing of coordinate conversion for attribute decoding will be described.

The inputs to this process are:
an indicator attr_coord_conv_enabled_flag specifying the use of coordinate conversion in the attribute coding process;
the array PointsAttr with elements PointsAttr[pointIdx][cIdx], where pointIdx is in the range of 0 to PointCount−1, and cIdx is in the range of 0 to AttrDim−1;
the array PointPosCart with elements PointPosCart[pointIdx] with pointIdx in the range of 0 to PointCount−1.

The output of this process is the array PointsAttr with elements PointsAttr[pointIdx][cIdx] where each element with index pointIdx of PointsAttr is associated with a position given by the array PointPosCart with the same index pointIdx.

In a process of performing projection according to embodiments, projection_type may be defined for each axis when necessary. In this case, the projection_type defined for each axis may be represented by projection_type_x, projection_type_y, and projection_type_z.

projection_type_x equal to 0 indicates that projection is not performed (that is, the value of x is used without conversion). projection_type_x equal to 1 indicates the first converted value of the coordinate system indicated by coordinate_conversion_type (e.g., the radius of the cylindrical coordinate system). projection_type_x equal to 2, indicates a simplified converted value (e.g., the value of x*x+y*y simplified by removing square root for the radius of the cylindrical coordinate system). projection_type_x equal to 3 may indicate a simplified sum of distance (e.g., the sum of the position information about the axes, x+y or x+y+z). projection_type_x equal to 4 may indicate a converted value by a predetermined function (e.g., log_2(x)).

projection_type_y equal to 0 indicates that projection is not performed (that is, the value of y is used without conversion). projection_type_y equal to 1 indicates that the second converted value of the coordinate system indicated by the coordinate_conversion_type (e.g., the azimuthal angle of the cylindrical coordinate system). projection_type_y equal to 2 indicates a simplified converted value (e.g., angle value, wherein the tangent value may be obtained to reduce computation of inverse tangent for obtaining an angle, wherein tan_phi=phi may be assumed). projection_type_y equal to 3 may indicate a simplified distance (e.g., the difference in position information between the axes, x−y, y−x−z, or the like). projection_type_y equal to 4 may indicate a converted value by a predetermined function (e.g., log_2(y)).

projection_type_z equal to 0 indicates projection is not performed (that is, the value of z is used without conversion). projection_type_z equal to 1 indicates the third converted value of the coordinate system indicated by the coordinate_conversion_type (e.g., the elevation angle of the cylindrical coordinate system). projection_type_z equal to 2 indicates a simplified converted value (e.g., angle value, wherein a tangent value may be obtained to reduce the inverse tangent computation for obtaining an angle). The laser index may be used as a simplified converted value by inferring the laser used for data acquisition based on the number of lasers and the position of the uniformly distributed lasers. projection_type_z equal to 3 may indicate a simplified distance (e.g., the difference in position information between the axes, z−y, z−x−y, or the like). projection_type_z equal to 4 may indicate a converted value by a predetermined function (e.g., log_2(z)).

projection_type applied to each axis may be defined for one coordinate conversion, and different coordinate conversion types (coordinate_conversion_type) may be signaled for the respective axes. That is, this means that different projections are applied to the respective axes and may be used as a method of signaling different conversion methods. An example is described below.

When coordinate_conversion_type=1, projection_type_x=1, projection_type_y=1, and projection_type_z=1, the radius, azimuth angle, and elevation angle of the cylindrical coordinate system may be indicated.

When coordinate_conversion_type=2, projection_type_x=1, projection_type_y=1, and projection_type_z=1, the radius, azimuth angle, and elevation angle of the spherical coordinate system may be indicated.

When coordinate_conversion_type=1, projection_type_x=0, projection_type_y=0, and projection_type_z=0, it may be indicated that projection does not occur (there is only scaling change for each axis by granularity_radius, granularity_angular, and granularity_normal).

coordinate_conversion_type=2, projection_type_x=0, projection_type_y=0, and projection_type_z=1 may indicate conversion to the x-axis, the y-axis and the elevation angle of the spherical coordinate system.

coordinate_conversion_type=1, projection_type_x=0, projection_type_y=0, and projection_type_z=2 may indicate conversion to the x-axis, the y-axis and the laser index.

coordinate_conversion_type=1, projection_type_x=2, projection_type_y=2, and projection_type_z=2 may indicate conversion to a simplified radius, simplified azimuth angle and laser index considering hardware (HW) implementation in the cylindrical coordinate system).

coordinate_conversion_type and projection_type may be used to specify a coordinate conversion type according to sequence characteristics. For example, for A type sequence, (radius, azimuthal angle, laser index) may be used as the projection type while using cylindrical coordinate conversion. For B type sequence, (x, y, laser index) may be used as the projection type while using cylindrical coordinate conversion. For C type sequence, projection type used, (radius, azimuthal angle, elevation angle) may be used as the projection type while using spherical coordinate conversion.

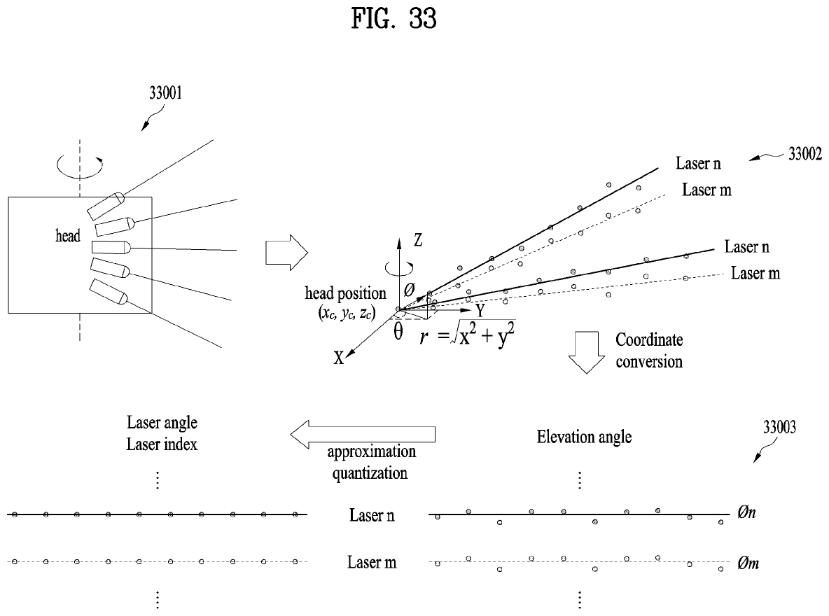

FIG. 33 illustrates an example of converting point cloud data into indexes according to embodiments. When projection_type_z is equal to 2, an elevation angle may be represented as a laser index.

As shown in FIG. 33, the LiDAR rotates horizontally around the head (33001), and the position of an object may be estimated based on the difference between the transmission time when the light is emitted from the laser and the reception time when light reflected on an object is received. The acquired points are positioned on the trajectory of the laser. However, due to the influence of noise, points are positioned slightly higher or lower than the laser trajectory (33002). That is, the elevation angle of each point is slightly greater or less than the laser angle. Therefore, when the elevation angles of points are approximated or adjusted, the elevation angle of each point may be considered as a laser angle or a laser index associated therewith. That is, the difference between the elevation angle and the laser angle is discarded and the points are considered to be positioned on the laser. Therefore, the elevation angle of each point is the same as the laser angle, and the points may be considered to be sorted according to the laser index.

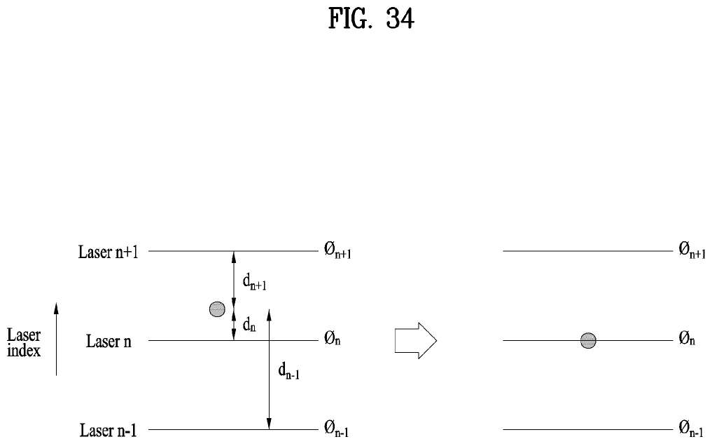

FIG. 34 shows an example of a method of adjusting point cloud data according to embodiments. Referring to FIG. 34, the laser angle corresponding to the n-th laser is ϕₙ, and the laser angles of adjacent lasers are ϕₙ₋₁ and ϕₙ₊₁. In this case, the elevation angle ϕ of a point may be matched to laser n on the following condition.

0.5*ϕₙ+0.5*ϕₙ₋₁≤ϕ<0.5*ϕₙ+0.5*ϕₙ₊₁

In addition, the differences between the current point and the elevation angles of respective lasers, d, =|ϕ−ϕₙ|, dₙ₊₁=|ϕ−ϕₙ₊₁|, dₙ₋₁=|ϕ−ϕₙ₋₁| may be calculated, and a laser having the smallest difference may be defined as a laser that has acquired a corresponding point.

When the total number of lasers is N, points matched with adjacent lasers through the above-described process may be divided into N groups. That is, the points may be adjusted by laser angle or laser index, divided into N groups, and quantized. In this case, scaling factors for each axis represented as granularity_radius, granularity_angular, and granularity_normal may have another meaning. That is, they may serve as a separator for distinguishing N quantized groups. For example, in coordinate conversion consisting of (radius, azimuthal angle, laser index), when the scaling factor is 1, the radius distance equal to 1 has the same meaning as the laser distance equal to 1. Also, went neighbor points are searched for, it may be determined that adjacent laser indexes are excessively closer than in reality. As a result, cross laser index points are more likely to be found in neighbor search. Therefore, in order to address this issue, the distance between laser indexes may be kept constant by using the signal described as granularity_normal, and points having different laser indexes may be prevented from being subjected to neighbor search. That is, when searching for neighbors between points in the process of encoding point cloud data, the probability of searching for similar points may be increased.

When use laser index or laser angle

$$granularity\_normal >= minimum inter - laser distance >= maximum k - th neighbor distance in a laser plan : \\ ( \sqrt{{( {x}_{k} ( n ) - {x}_{l} ( n ) )}^{2} + {( {y}_{k} ( n ) - {y}_{l} ( n ) )}^{2} + {( {z}_{k} ( n ) - {z}_{l} ( n ) )}^{2}} )$$

where (xₖ (n), yₖ (n), zₖ (n)) and (xₗ(n), yₗ (n), zₗ (n)) denote xyz positions of neighbor points belonging to laser n.

Here, the laser plane may mean a plane to which points associated with one laser belong or a plane scanned by one laser. The maximum neighbor distance in a laser plane may mean the longest distance among the k-th neighbors in obtaining neighbors for points in the laser plane when k neighbors are to be obtained. A scaling factor corresponding to granularity_normal may be defined based on the maximum value for the maximum k-th neighbor distance in a laser plane for each laser plane, and different scaling factors may be adaptively defined for each plane. The maximum neighbor distance in a laser plane may be measured according to each sequence by the encoder according to the embodiments, or a predetermined value may be signaled to the decoder according to the embodiments through an experiment. Thus, by providing spacing between the lasers, independent compression or identification of neighbor characteristics may be implemented in each laser plane. Alternatively, for the maximum neighbor distance in a laser plane, a predetermined value may be used by the decoder according to the embodiments.

The minimum laser distance may be equally applied between all lasers, or different distances may be used between lasers or for the same laser depending on the distance from the center according to the characteristics of the lasers.

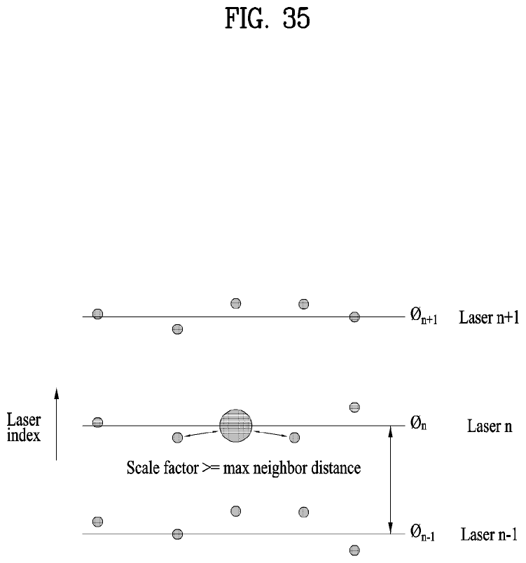

FIG. 35 illustrates an example of a method of maintaining an index interval based on a scale factor for point cloud data according to embodiments. That is, FIG. 35 illustrates preventing a neighbor search error by maintaining an interval between laser indexes based on a scaling factor. The maximum neighbor distance for determining the scaling factor may be a value defined through experiments or may be defined according to a sequence characteristic after the encoder according to the embodiments measures a neighbor distance within a laser index, and then be signaled.

The coordinates converted to laser indexes may be efficiently used without signaling. In neighbor search for a point, only points having the same laser index or laser angle may be searched for or only points within a certain range of the laser index or laser angle may be searched for.

nearest neighbor=minimum distance point within the same laser index

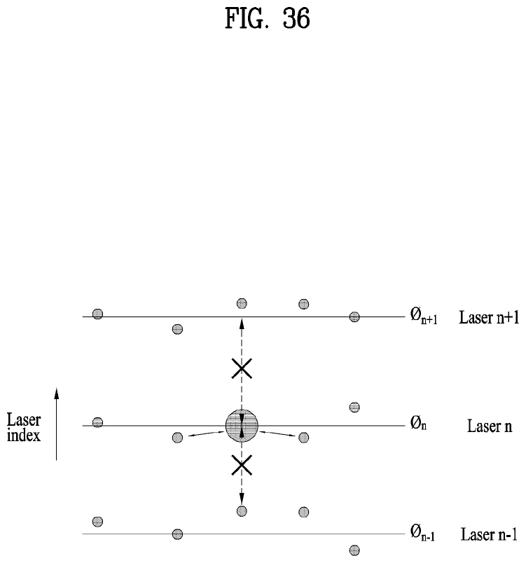

FIG. 36 illustrates an example of a laser index-based neighbor point search method for point cloud data according to embodiments. FIG. 36 illustrates that point cloud data according to embodiments undergoes coordinate conversion into a radius, an azimuth angle, and a laser index and then arranged in the vertical direction according to the laser index with respect to a radius/azimuth plane. For a point belonging to the n-th laser, neighbor points may be searched for based on the distance, considering only points included in the same laser without considering points having another laser index or laser angle.

This index-based neighbor point search may be applied in a nearest neighbor search of predictive-lifting attribute coding or may be applied in predictive attribute coding. In addition, it may be used as a condition for collecting points acquired from a single laser by prioritizing sorting points having the same laser index into groups in the point sorting process.

When a laser index or a laser angle is used, corresponding information may be included for each point. That is, laser index or laser angle information may be added to previously added xyz position information. Alternatively, laser index or laser angle information may be used by replacing or converting one or more axis values. When the acquired data does not include laser index or laser angle information, the laser index or laser angle of each point may be inferred based on related information (overall laser angle, laser head position, and related laser position of the image acquisition device).

The aforementioned laser index or laser angle may be used for adjustment of points sampled according to elevation angles in a cylindrical coordinate system or a spherical coordinate system.

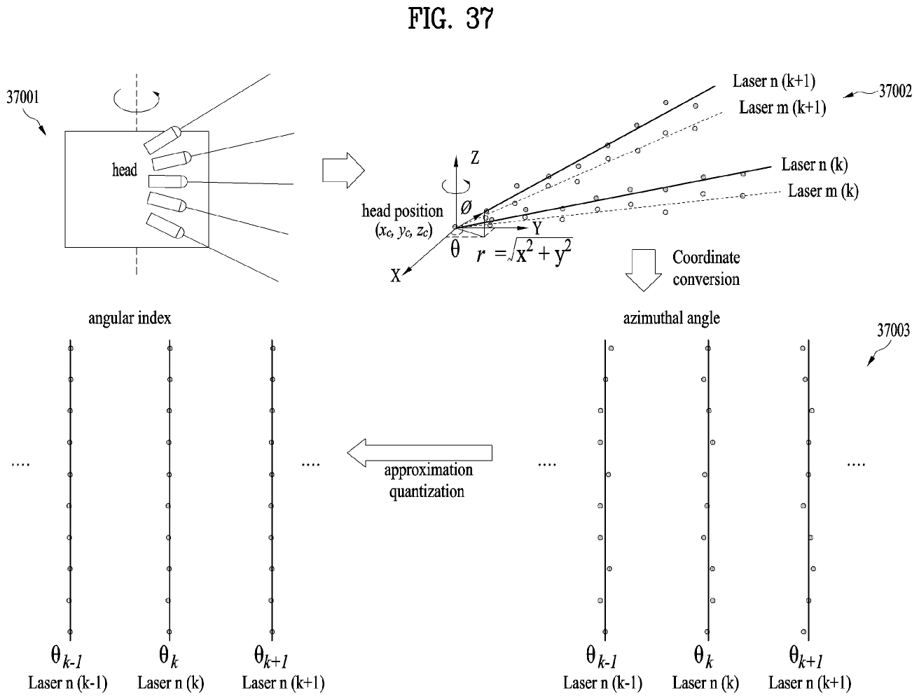

FIG. 37 illustrates an example of adjusting point cloud data performed by converting an azimuthal angle into an index according to embodiments. The azimuthal index may be used for sampling adjustment for an azimuthal angle in a cylindrical coordinate system, a spherical coordinate system, or a fan-shaped coordinate system.

Referring to FIG. 37, while a plurality of lasers arranged in a vertical direction rotate in a horizontal direction (37001), point cloud data is acquired. When positions sampled by the lasers are represented as a line, the sampled points should theoretically be positioned on the line. However, points may be sampled at positions deviating from the line due to sampling noise, quantization error, laser interference, and the like (37002). FIG. 37 shows points of a k-th sampling of an n-th laser among a plurality of lasers arranged in the vertical direction and sampling (k−1-th sampling and k+1-th sampling) adjacent thereto (37003). The positions of points sampled by the k-th beam and the k+1-th and k+1-th beams are distributed with errors around the trajectory of the laser beam. The position of a point having an error in the azimuth angle may be approximated with an index and adjusted so as to be positioned on the line trajectory of the laser.

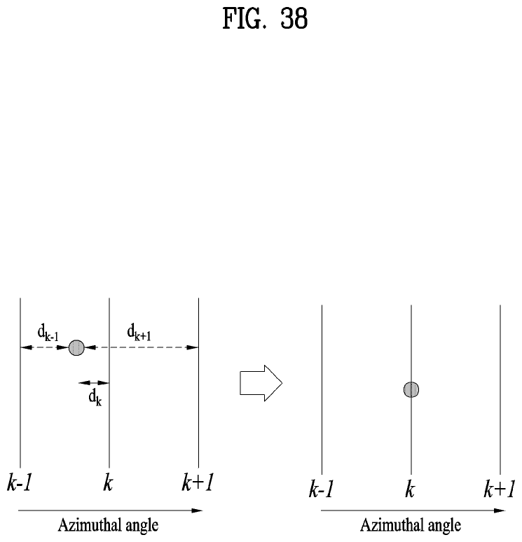

FIG. 38 illustrates an example of a method of adjusting an azimuthal angle of a point of point cloud data according to embodiments.

Let the azimuthal angle sampled in the k-th sampling by the n-th laser be θₖ, and the azimuthal angles sampled in the k−1-th sampling and k+1-th sampling adjacent thereto are θₖ₋₁ and θₖ₊₁, respectively. In this case, the azimuthal angle θ of the point may match the k-th sampling angle of the n-th laser on the following condition.

0.5*θₖ+0.5*θₖ₋₁≤θ<0.5*θₖ+0.5*θₖ₊₁

That is, when 0 is within the range of the above mathematical condition, the azimuthal angle θ of the point may be adjusted to the azimuthal angle θₖ of the k-th sampling by the n-th laser.

In addition, the azimuthal angle of a point may be approximated and adjusted to the azimuthal angle of the laser at which differences between the azimuthal angle θ of the point and the azimuthal angle θₖ, θₖ₋₁, and θₖ₊₁ sampled by the laser are minimized may be approximated to adjust the azimuthal angle of the point adjusted by approximating.

Referring to FIG. 38, the position of a point close to the k-th laser beam is adjusted to be positioned the trajectory of the k-th laser beam. In this case, the information about the azimuthal angles θₖ, θₖ₋₁, and θₖ₊₁ may be directly delivered as parameters or may be delivered in the form may be calculated by the transmission device or reception device according to the embodiments. In addition, when it is assumed that the spinning speed of LiDAR is constant, the information on the azimuthal angle may be calculated based on the sampling number per turn N (number_phi_per_turn) and the sampling start position of the n-th laser Δθ₀ (offset) as follows (unit: radian).

θₖ=k/N*2π+Δθ₀

The offset may have the same value for all laser indexes or similar values within an error range, or may have different values depending on the laser index. When the horizontal positions of the lasers are different, more accurate grouping may be implemented by considering the offset.

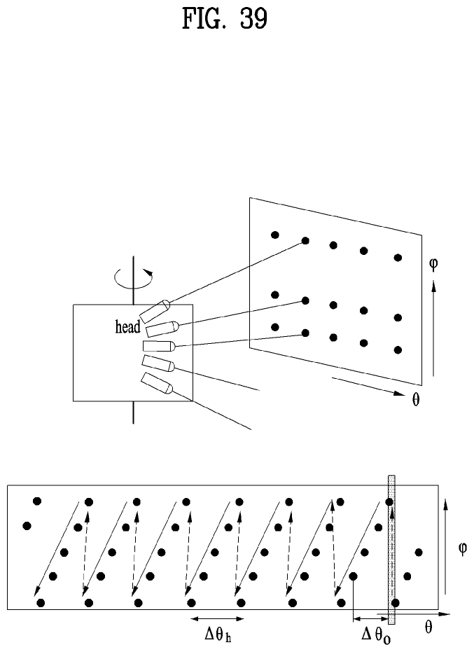

FIG. 39 illustrate that the azimuthal angles of lasers included in a LiDAR according to embodiments are different from each other.

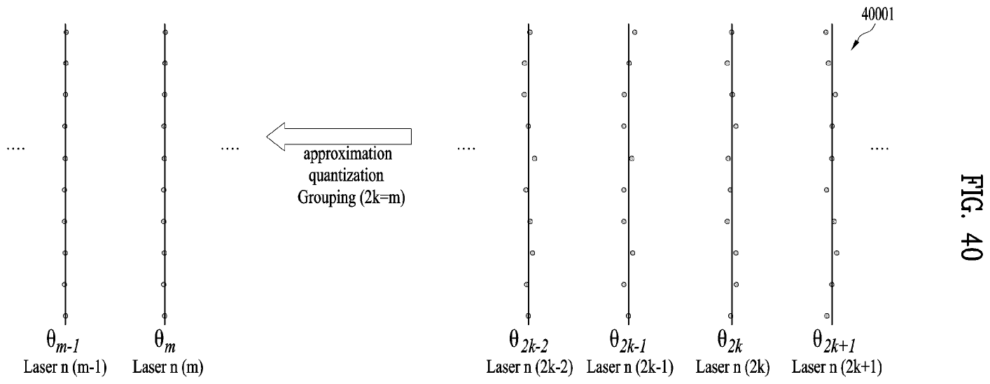

FIG. 40 illustrates an example of a method of grouping point cloud data according to embodiments. FIG. 40 illustrates that two horizontally adjacent sampling positions are grouped into one. That is, the 2k−2-th and 2k−1-th sampled points are grouped into m−1, and the 2k-th and 2k+1-th sampled points are grouped into m. When the horizontal samples are dense, the sampling rate may be lowered. Thereby, the similarity between adjacent points may be further considered.

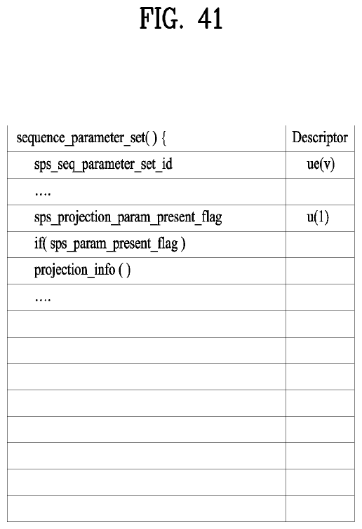

FIG. 41 shows an example of syntax of a sequence parameter set according to embodiments. The device and method for transmitting point cloud data according to embodiments may signal projection-related information to a reception device according to embodiments.

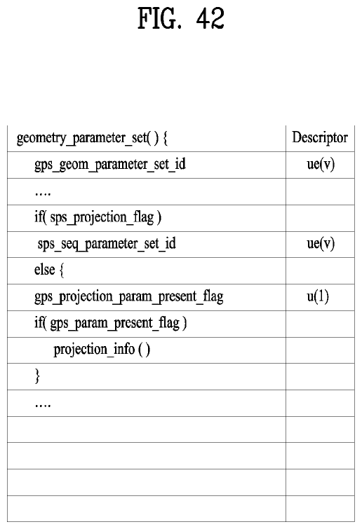

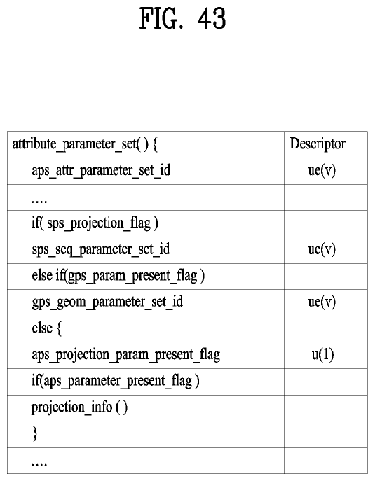

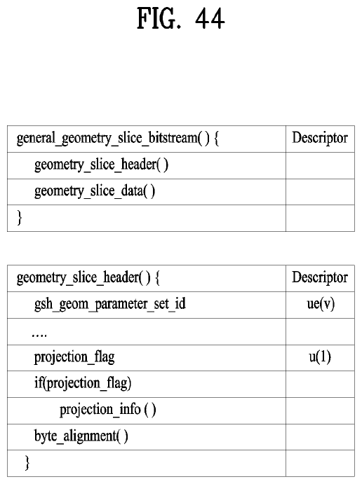

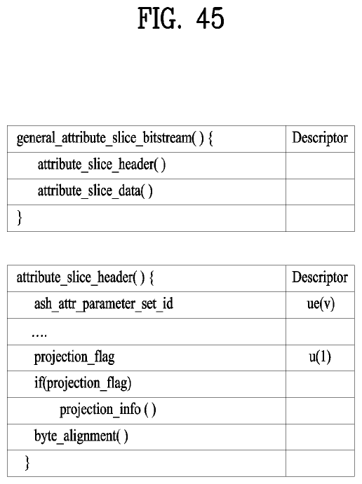

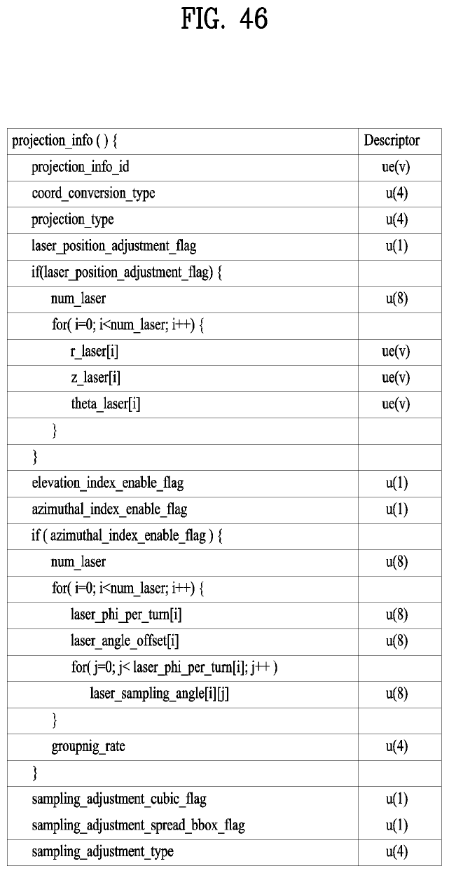

FIG. 42, which is related to FIG. 41, shows an example of syntax of a geometry parameter set according to embodiments. FIG. 43 shows an example of syntax of an attribute parameter set according to embodiments, and FIG. 44 shows an example of syntax of a general geometry slice bitstream and a geometry slice header according to embodiments. FIG. 45 shows an example of syntax of a general attribute slice bitstream and an attribute slice header according to embodiments, and FIGS. 46 to 48 show an example of syntax of projection info according to embodiments.

Information related to coordinate conversion (projection) may be defined in parameter sets and an SEI message. In addition, a sequence parameter set, a geometry parameter set, an attribute parameter set, and a slice header may indicate whether independent projection is performed, and specific information about the projection may be carried in projection_info( ).

projection_flag may be carried in each of the SPS, GPS, and APS to indicate whether projection is performed. projection_flag may be defined in the sets at the same time on a slice-by-slice basis to indicate whether projection is performed on a slice-by-slice basis. In addition, all or part of related information may be carried in the sequence parameter set, and the remaining information may be carried in the geometry parameter set, attribute parameter set, tile parameter set, slice header, or SEI message.

Signaling information (parameters, metadata, etc.) has different meanings depending on the position at which the information is carried. Defining signaling information in the SPS means that the signaling information is applied to the entire sequence. Defining signaling information in the GPS means that the signaling information is used for geometry (position) reconstruction. Defining signaling information in the APS means that the signaling information is applied to attribute restoration. Defining signaling information in the TPS means that the signaling is applied to points within a tile. Defining signaling information in a slice level means that the signaling information is applied to the corresponding slice. Signaling information may be defined in a corresponding position or a separate position depending on an application or system such that the range and method to be applied may be used differently. In addition, when the defined syntax element is applicable to a plurality of point cloud data streams as well as the current point cloud data stream, the signaling information may be carried in a higher-level parameter set.

Hereinafter, parameters (metadata, signaling information, etc.) according to embodiments may be generated during a process of a transmission device according to embodiments to be described later, and may be transmitted to a reception device according to embodiments and used in a reconstruction process. For example, the parameters may be generated by a metadata processor (or metadata generator) of the transmission device according to the embodiments to be described later, and acquired by a metadata parser of the reception device according to the embodiments.

Hereinafter, the related syntax will be described. A description of parts of the syntax which are the same as those in FIG. 25B is omitted.

sps_projection_param_present_flag, gps_projection_param_present_flag, or aps_projection_param_present_flag set to 1 indicates a projection related parameter is carried in the sequence parameter set, geometry parameter set, or attribute parameter set. When the flag is set to 0, the parameter may be delivered on a slice-by-slice basis.

When coordinate projection is performed and related parameters are transmitted in the sps or gps, sps_seq_parameter_set_id and gps_seq_parameter_set_id are indicators of the corresponding parameter set

For example, when coordinate conversion is used for attribute coding, a related parameter may be carried in the gps (when parameters used for coordinate conversion are used in common in the coding scheme used for geometry coding). In this case, a parameter set indicator that may refer to the parameter may be directly delivered. When the parameter is defined in the SPS to indicate that the parameter is applied to the entire point cloud data sequence or simultaneously to geometry and attributes, the sequence parameter set indicator may be directly indicated. Therefore, among a plurality of parameter sets, a parameter set containing a required parameter may be referred to. When parameters defined in the APS are used for geometry (position) reconstruction, an APS indicator may be defined in the GPS.

elevation_index_enable_flag or azimuthal_index_enable_flag set to 1 indicates whether an index of an elevation angle or an index of an azimuthal angle is used for a coordinate converted point position.

If (elevation_index_enable_flag==0, azimuthal_index_enable_flag==0)

(x,y,z)->(radius,azimuthal angle,elevation angle)

else If (elevation_index_enable_flag==0, azimuthal_index_enable_flag==1)

(x,y,z)->(radius,angular index,elevation angle)

else If (elevation_index_enable_flag==1, azimuthal_index_enable_flag==0)

(x,y,z)->(radius,azimuthal angle,laser index)

else if (elevation_index_enable_flag==1, azimuthal_index_enable_flag==1)

(x,y,z)->(radius,angular index,laser index)

laser_phi_per_turn[i] indicates the number of times of sampling per horizontal turn for the i-th laser. Default values may be used for specific values such as −1, 0, and 1 (e.g., when the default value is 200 when sampling is performed 800 times, 4 samples may be grouped into one), or it may be indicated that the azimuthal index is not used (azimuthal_index_enable_flag=0).

laser_angle_offset[i] indicates a difference in horizontal sampling position of the i-th laser in order to adjust a sampling position difference between a plurality of lasers. For example, it may indicate the angle of the first sample.

laser_sampling_angle[i][j] indicates horizontal sampling angle of the i-th laser. It may be used to indicate each sampling angle when the sampling position of the laser is not uniform.

grouping_rate may indicate the frequency of grouping of horizontal indexes. grouping_rate equal to 1 indicates the same sampling number equal to laser_phiper_turn. grouping_rate greater than 1 indicates that a plurality of laser sampling positions is grouped and considered as one. grouping_rate less than 1 may indicate that a virtual laser sampling position is added. It may be used in the sense of a scale in terms of widening the interval between laser sampling positions.

FIGS. 49A and 49B are block diagrams illustrating a point cloud data transmission device 49000 according to embodiments.

The transmission device 49000 according to the embodiments may acquire, encoded, and transmit point cloud data by hardware including one or more processors or integrated circuits configured to communicate with the transmission device 10000 in FIG. 1, the transmission device in FIG. 4, the transmission device in FIG. 12, the XR device 1430 in FIG. 14, the transmission device 15000 in FIG. 15, and/or one or more memories, software, firmware, or a combination thereof.

The transmission device 49000 includes an encoder configured to encode the point cloud data and a transmitter configured to transmit a bitstream containing the encoded point cloud data. The encoder may include a geometry encoder configured to encode a geometry indicating a position of one or more points of the point cloud data, and an attribute encoder configured to encode an attribute of the one or more points.

The encoder may also include a projector 49100 configured to project the points of the point cloud data. The projector 49100 of the transmission device 49000 may convert coordinates representing the positions of the points into another coordinate system and project the points based on the coordinates of the coordinate-converted points. For example, the projector 49100 may convert the coordinates of a point presented in a Cartesian coordinate system or xyz orthogonal coordinate system (first coordinate system) into at least one of a cylindrical coordinate system, a spherical coordinate system, or a fan-shaped coordinate system (second coordinate system) (FIG. 19). Then, the projector 49100 projects the point onto a Cartesian coordinate system (20003 in FIG. 20) having X′, Y′, and Z′ axes based on the coordinates of the point presented in the second coordinate system. As a result, as the point is positioned in the Cartesian coordinate system (X′, Y′, Z′) based on the converted values (e.g., r, theta, phi) in the second coordinate system, the position of the point in the existing spatial coordinate system and the position in the spatial coordinate system of X′, Y′, and Z′ are different. The first coordinate system or the second coordinate system may include at least one of a Cartesian coordinate system, a cylindrical coordinate system, a spherical coordinate system, or a fan-shaped coordinate system.

The geometry information projected by the projector 49100 may be delivered to the attribute encoder. That is, the geometry information to be used for attribute coding may be projected. In addition, sub-sampled attribute data may be encoded based on the sub-sampled geometry. The projector 49100 may generate related information (e.g., geo_projection_enable_flag, attr_projetion_enable_flag) according to an application range of projection and transmit the generated information to the reception device according to the embodiments. Projection of the point cloud data may be applied to geometry coding and/or attribute coding.

FIG. 49B is a block diagram illustrating the projector 49100 in more detail according to embodiments. The projector 49100 according to the embodiments may include a coordinate converter 49111, a coordinate projector 49112, a laser position adjuster 49113, a sampling rate adjuster 49114, or a voxelizer 49115.

The coordinate converter 49111 converts coordinates representing the positions of the input point cloud data. For example, the positions of points presented in an XYZ orthogonal coordinate system (e.g., a Cartesian coordinate system) may be converted into a cylindrical coordinate system, a spherical coordinate system, or a fan-shaped coordinate system. In this case, information about the distribution range of the input point cloud data (e.g., orig_bounding_box_x_offset, orig_bounding_box_y_offset, orig_bounding_box_z_offset, orig_bounding_box_x_length, orig_bounding_box_y_length, orig_bounding_box_z_length) may be generated and transmitted to the reception device according to the embodiments. In addition, as information about the converted coordinate system, information about the center position, a distribution range of data in the converted coordinate system, and the like (e.g., cylinder_center_x/y/z, cylinder_radius_max, cylinder_degree_max, cylinder z_max, ref_vector_x/y/z, normal_vector_x/y/z, clockwise_degree_flag) may be generated and transmitted to the reception device according to the embodiments.

The coordinate projector (Coordinate projection) 49112 is a component to project the points of the coordinate-converted point cloud data. The coordinate projector (Coordinate projection) 49112 may generate information about the range and scaling of the projected point cloud data (e.g., bounding_box_x/y/z_length, granularity_radius/angular/normal) to the reception device according to the embodiments.

FIGS. 15 to 20 illustrate the coordinate conversion and projection, and related operations may be performed by the coordinate converter 49111 or the coordinate projector 49112 described above.

The laser position adjuster (Laser position adjustment) 49113 performs an adjustment operation based on the positional characteristics of the lasers in the LIDAR structure. When laser_position_adjustment_flag is equal to 1, the laser position adjuster 49113 may generate information required for adjustment, such as num_laser, r_laser, z_laser, and theta_laser, and deliver the same to the reception device according to the embodiments. FIGS. 21 and 22 illustrate projection adjustment in consideration of the position of the laser, and related operations may be performed by the laser position adjuster 49113.

The sampling rate adjuster (Sampling rate adjustment) 49114 may perform sampling rate adjustment for each axis. The sampling rate adjuster 49114 may generate sampling adjustment related information (e.g., sampling_adjustment_cubic_flag, sampling_adjustment_spread_bbox_flag, sampling_adjustment_type) and transmit the information to the reception device according to the embodiments. Also, the sampling rate adjuster 49114 may convert an azimuthal angle or an elevation angle into an azimuth index or a laser index. That is, the sampling rate adjuster may perform adjustment by approximation or quantization of the azimuthal angle or elevation angle of the points. FIGS. 33 to 38 illustrate adjustment through index conversion, approximation, or quantization of the azimuthal angle or elevation angle of points of the point cloud data, and the sampling rate adjuster 49114 according to the embodiments may perform related operations. That is, the projector 49110 according to the embodiments may perform coordinate conversion, projection, and sampling adjustment through index conversion, approximation or quantization of the point cloud data.

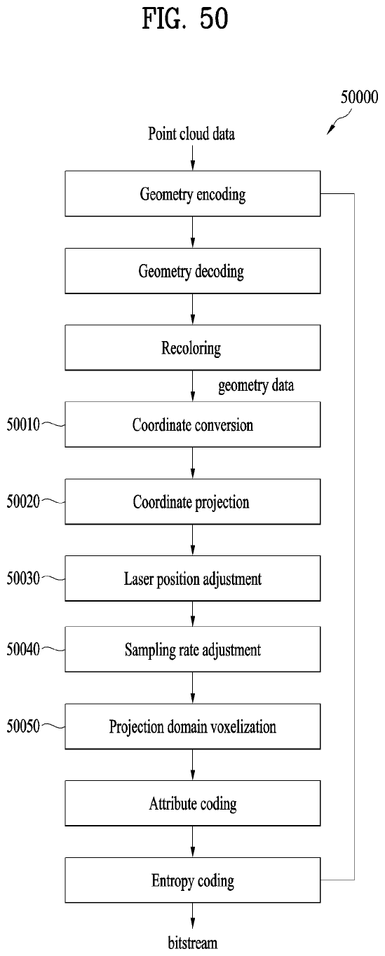

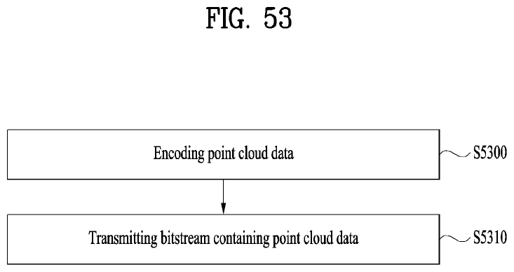

FIGS. 50 and 53 illustrate an example of a point cloud data transmission method according to embodiments. The point cloud data transmission method according to the embodiments includes encoding point cloud data (S5300) and transmitting a bitstream containing the encoded point cloud data (S5310).

The method of transmitting point cloud data according to the embodiments may correspond to the operations of acquisition, encoding, and transmission of point cloud data performed by hardware including one or more processors or integrated circuits configured to communicate with the transmission device 10000 in FIG. 1, the transmission device in FIG. 4, the transmission device in FIG. 12, the XR device 1430 in FIG. 14, the transmission device 15000 in FIG. 15, and/or one or more memories, software, firmware, or a combination thereof.

Step S5300 of encoding the point cloud data is to encode the point cloud data by hardware including one or more processors or integrated circuits configured to communicate with the point cloud video encoder 10002 in FIG. 1, the encoding 20001 in FIG. 2, the encoder in FIG. 4, the transmission device in FIG. 12, the XR device 1430 in FIG. 14, the transmission device 1500 in FIG. 15, and/or one or more memories, software, firmware, or a combination thereof.

Step S2910 of transmitting the bitstream containing the point cloud data is to transmit the point cloud data as in the transmission 20002 in FIG. 2 by hardware including one or more processors or integrated circuits configured to communicate with the transmitter 10003 in FIG. 1, the transmission processor 12012 in FIG. 12, the XR device 1430 in FIG. 14, the transmission device 1500 in FIG. 15, and/or one or more memories, software, firmware, or a combination thereof.

FIG. 50 illustrates step S5300 of encoding point cloud data. The encoding of the point cloud data includes encoding a geometry of a point of the point cloud data and encoding an attribute of the point of the point cloud data.

The encoding of the point cloud data includes projecting the point of the point cloud data, wherein the projecting includes converting coordinates indicating a position of the point presented in a first coordinate system into a second coordinate system (50010), and projecting the point based on the coordinates of the point converted into the second coordinate system and (50020).

Step S0010 of converting the coordinate system corresponds to the operation performed by the coordinate converter 49111, and the projection 50020 corresponds to the operation performed by the coordinate projector 49112. Also, the projection may further include adjusting the point cloud data based on a position of a laser (50030) and adjusting a sampling rate (50040). Step S0030 of adjustment based on the position of the laser may correspond to the operation performed by the laser position adjuster 49113 according to the embodiments, and step S0040 of adjusting the sampling rate may correspond to the operation performed by the sampling rate adjuster 49114 according to the embodiments. The operation corresponding to each step may correspond to the operations performed by the components of the transmission device 49000. The operations performed by each component are described with reference to FIGS. 15 to 49.

The projecting of the point of the point cloud data may further include adjusting an azimuthal angle of the point based on an azimuthal angle of a laser that has acquired the point.

In the step of adjusting the azimuthal angle of the point, the azimuthal angle of the points may be adjusted to the azimuthal angle of a laser having a minimum difference from the azimuthal angles of the points among the azimuthal angles of a plurality of points sampled by the laser. That is, the azimuthal angle of the point may be adjusted to the azimuthal angle of the laser whose value is closest to the azimuthal angle of the point.

In addition, in the step of adjusting the azimuthal angle of the points, the azimuthal angles of points greater than or equal to the average of the k−1st and kth sampling azimuthal angles of the laser and less than the average of the k-th and k+1-th sampling azimuthal angles of the laser may be adjusted to the k-th sampling azimuthal angle of the laser.

Such adjustment of the azimuthal angle may be performed by the projector 49110 of the transmission device according to the embodiments. FIG. 38 illustrates related details.

FIGS. 51A and 51B are block diagrams illustrating a point cloud data reception device 51000 according to embodiments.

The reception device 51000 according to the embodiments may receive and decode point cloud data by hardware including one or more processors or integrated circuits configured to communicate with the reception device 10004 in FIG. 1, the reception device in FIG. 11, the XR device 1430 in FIG. 14, the reception device 16000 in FIG. 16, and/or one or more memories, software, firmware, or a combination thereof.

The reception device 51000 according to the embodiments includes a receiver configured to receive a bitstream containing point cloud data and a decoder configured to decode the point cloud data. Also, the decoder may include a geometry decoder configured to decode a geometry indicating a position of one or more points of the point cloud data, and an attribute decoder configured to decode an attribute of the one or more points.

Referring to FIG. 51B, the decoder includes a reprojector 51110 configured to project projected point cloud data. The reprojector 51110 may include a coordinate converter and a coordinate projector.

The coordinate projector projects points of the point cloud data. The coordinate projector may re-convert the decoded point cloud data (X′Y′Z′ coordinates) in a 3-dimensional space according to the coordinate conversion type (coordinate_conversion_type), and may receive and identify the range and scaling information about the projected data (e.g., cylinder_center_x/y/z, cylinder_radius_max, cylinder_degree_max, cylinder z_max, ref_vector_x/y/z, normal_vector_x/y/z, clockwise_degree_flag).

The coordinate converter is a component to convert the coordinate system of points of the point cloud data. For example, it may convert a cylindrical coordinate system into an XYZ orthogonal coordinate system (Cartesian coordinate system), and may receive a projection type (projection_type) and acquire a method used for projection. In this case, the distribution range of the output point cloud data may be identified through related information (e.g., orig_bounding_box_x/y/z_offset, orig_bounding_box_x/y/z_length). In addition, the coordinate converter may identify information about the coordinate system to which the data is to be converted (e.g., cylinder_center_x/y/z, cylinder_radius_max, cylinder_degree_max, cylinder_z_max, ref_vector_x/y/z, normal_vector_x/y/z, clockwise_degree_flag) through signaling information.

The reprojector 51110 may or may not perform coordinate conversion and projection depending on whether the received point cloud data has been projected. The received point cloud data may be point cloud data projected by the transmission device according to embodiments, or may be projected data. The coordinate system where the position of the point of the point cloud data is presented may be at least one of a Cartesian coordinate system, a cylindrical coordinate system, a spherical coordinate system, or a fan-shaped coordinate system, and the position of the point of the point cloud data may be presented in another coordinate system through coordinate conversion. Also, the position of the point of the point cloud data may be projected based on values presented in the converted coordinate system.

The reprojector 51110 may further include a laser position adjuster (not shown) and a sampling rate adjuster (not shown).

The laser position adjuster (Laser position adjustment) performs an adjustment operation based on the positional characteristics of the lasers in the LIDAR structure. When laser_position_adjustment_flag is equal to 1, the laser position adjuster may acquire information required for adjustment, such as num_laser, r_laser, z_laser, and theta_laser. FIGS. 21 and 22 illustrate projection adjustment in consideration of the position of the laser, and related operations may be performed by the laser position adjuster.

The sampling rate adjuster (Sampling rate adjustment) may perform sampling rate adjustment for each axis. The sampling rate adjuster may receive sampling adjustment related information (e.g., sampling_adjustment_cubic_flag, sampling_adjustment_spread_bbox_flag, sampling_adjustment_type). Also, the sampling rate adjuster may convert an azimuthal angle or an elevation angle into an azimuth index or a laser index. That is, the sampling rate adjuster may perform adjustment by approximation or quantization of the azimuthal angle or elevation angle of the points. FIGS. 33 to 38 illustrate adjustment through index conversion, approximation, or quantization of the azimuthal angle or elevation angle, and the sampling rate adjuster according to the embodiments may perform related operations. That is, the reprojector according to the embodiments may perform coordinate conversion, projection, and adjustment through index conversion, approximation or quantization of the point cloud data.

The decoder may further include an index map generator 51120 and an inverse projector 51130.

The index map generator 51120 may generate an index map for reconstructed geometry (position) information. FIG. 24 illustrates generating a map between positions of projected points, position indexes, and decoded positions, and a related operation may be performed by the index map generator 51120.

The inverse projector 51130 is a component to change attribute information reconstructed as an attribute for the projected geometry back into the domain for the reconstructed geometry information. Inverse projection may perform the projection process of point cloud data in the same manner. The inverse projection may convert the position of a point of the point cloud data from a projected coordinate system to an existing coordinate system using an inverse transform equation. When projection is applied to attribute coding, attribute information is matched to an appropriate value and restored by connecting the reconstructed geometry information and the corresponding attribute information.

The decoder may further include an inverse projector 51130 configured to inversely project the positions of the projected points of the point cloud data.

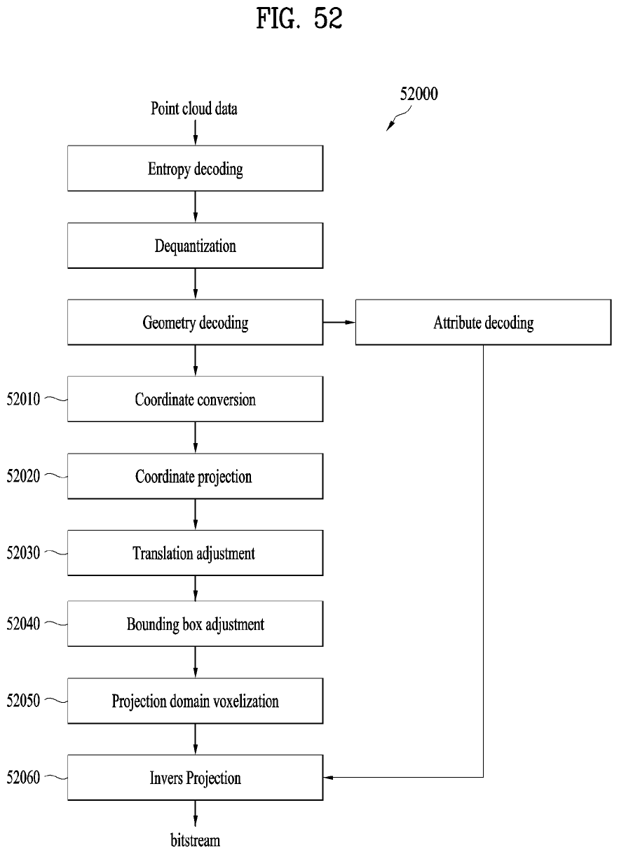

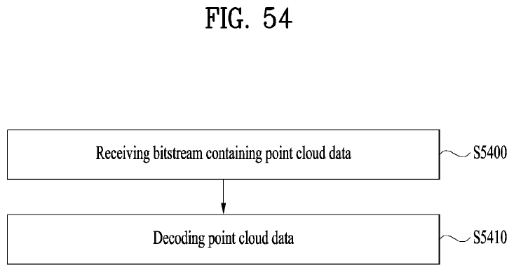

FIGS. 52 and 54 show an example of a point cloud data reception method according to embodiments. Referring to FIG. 54, the point cloud data reception method according to the embodiments may include receiving a bitstream containing point cloud data (S5400) and decoding the point cloud data (S5410).

In the reception method according to the embodiments, hardware including one or more processors or integrated circuits configured to communicate with the reception device 10004 in FIG. 1, the reception device in FIG. 11, the XR device 1430 in FIG. 14, the reception device 16000 in FIG. 16, and/or one or more memories, software, firmware, or a combination thereof may receive and decode point cloud data.

In the receiving S5400 of a bitstream containing point cloud data, point cloud data is received by hardware including one or more processors or integrated circuits configured to communicate with the reception device 10004 in FIG. 1, the reception device in FIGS. 10 and 11, the receiver 13000 in FIG. 13 the XR device 1430 in FIG. 14, the reception device 16000 in FIG. 16, and/or one or more memories, software, firmware, or a combination thereof.

In the decoding S5410 of the point cloud data, the point cloud data is decoded by hardware including one or more processors or integrated circuits configured to communicate with the point cloud video decoder 10006 in FIG. 1, the reception device in FIGS. 10, 11, and 13, the XR device 1430 in FIG. 14, the reception device 16000 in FIG. 16, and/or one or more memories, software, firmware, or a combination thereof.

FIG. 52 shows the operation 52000 of decoding point cloud data according to the embodiments. The decoding includes decoding a geometry indicating a position of a point of the point cloud data and decoding an attribute of the point.

The decoding further includes converting coordinates and projecting the coordinates. In the converting of the coordinates, coordinates of a point of the point cloud data may be converted. The operation performed in the step of converting the coordinates corresponds to the operation performed by the coordinate converter of the reception device 51110. In the projecting of the coordinates, the point of the point cloud data is projected. The operation performed in the step of projecting the coordinates corresponds to the operation performed by the coordinate projector of the reception device 51110.

The decoding may further include adjusting the projection in consideration of a position of a laser and adjusting the projection in consideration of a sampling rate. The operations performed in each step correspond to the operations performed by the laser position adjuster (not shown) and the sampling rate adjuster (not shown) of the reception device 51110 according to the embodiments. Related details have been described about and thus a description thereof is omitted.

The decoding may further include inverse projection. In the inverse projection, attribute information restored as an attribute of the projected geometry is changed into a domain for the reconstructed geometry information. The operation performed in the inverse projection step corresponds to the operation performed by the inverse projector 51130 of the receiver 51110 according to the embodiments.

The transmission device according to the embodiments may rearrange the point cloud data based on distribution characteristics of the data. Accordingly, inefficiently arranged data (e.g., a data type having a density lowered with an increase in distance from the center) may be uniformly distributed through projection, and then the data may be compressed and transmitted with higher efficiency.

The method/device for transmitting and receiving point cloud data according to the embodiments may attribute-code the point cloud data based on a projection technique. In in regard, a projection coordinate system configuration and projection method based on characteristics of an acquisition device, and/or parameter setting in consideration of sampling characteristics may be carried out.

Accordingly, the transmission and reception methods/devices according to the embodiments may increase the compression performance of the data by resorting the data based on the characteristics of the data distribution/acquisition device based on a combination of the embodiments and/or related signaling information. Also, the reception method/device according to the embodiments may efficiently reconstruct the point cloud data.

The projection method according to the embodiments may be applied as a pre/post-processing process independently of attribute coding. When the method is applied to geometry coding, a prediction-based geometry coding method may be applied based on the pre-processing process of the prediction-based geometry coding method or the converted positions.

Embodiments have been described from the method and/or device perspective, and descriptions of methods and devices may be applied so as to complement each other.

Although the accompanying drawings have been described separately for simplicity, it is possible to design new embodiments by merging the embodiments illustrated in the respective drawings. Designing a recording medium readable by a computer on which programs for executing the above-described embodiments are recorded as needed by those skilled in the art also falls within the scope of the appended claims and their equivalents. The devices and methods according to embodiments may not be limited by the configurations and methods of the embodiments described above. Various modifications can be made to the embodiments by selectively combining all or some of the embodiments. Although preferred embodiments have been described with reference to the drawings, those skilled in the art will appreciate that various modifications and variations may be made in the embodiments without departing from the spirit or scope of the disclosure described with reference to the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same.

Executable instructions for performing the method/operations of the device according to the embodiments may be stored in a non-transitory CRM or other computer program products configured to be executed by one or more processors, or may be stored in a transitory CRM or other computer program products configured to be executed by one or more processors.

In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this specification, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.” Further, in this specification, the term “or” should be interpreted as indicating “and/or.” For instance, the expression “A or B” may mean 1) only A, 2) only B, or 3) both A and B. In other words, the term “or” used in this document should be interpreted as indicating “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signals unless context clearly dictates otherwise.

The terms used to describe the embodiments are used for the purpose of describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to be interpreted, when a specific condition is satisfied, to perform the related operation or interpret the related definition according to the specific condition.

Operations according to the embodiments described with reference to this specification may be performed by a transmission/reception device including a memory and/or a processor according to embodiments. The memory may store programs for processing/controlling the operations according to the embodiments, and the processor may control various operations described with reference to this specification. The processor may be referred to as a controller or the like. In embodiments, operations may be performed by firmware, software, and/or a combination thereof. The firmware, software, and/or a combination thereof may be stored in the processor or the memory.

The operations according to the above-described embodiments may be performed by the transmission device and/or the reception device according to the embodiments. The transmission/reception device includes a transmitter/receiver configured to transmit and receive media data, a memory configured to store instructions (program code, algorithms, flowcharts and/or data) for a process according to embodiments, and a processor configured to control operations of the transmission/reception device.

The processor may be referred to as a controller or the like, and may correspond to, for example, hardware, software, and/or a combination thereof. The operations according to the above-described embodiments may be performed by the processor. In addition, the processor may be implemented as an encoder/decoder for the operations of the above-described embodiments.

As described above, related contents have been described with reference to the best mode for carrying out the embodiments.

As described above, the embodiments may be fully or partially applied to the point cloud data transmission/reception device and system. It will be apparent to those skilled in the art that various changes or modifications can be made to the embodiments within the scope of the embodiments. Thus, it is intended that the embodiments cover the modifications and variations of this disclosure provided they come within the scope of the appended claims and their equivalents.

What is claimed is:

1. A method of transmitting point cloud data, the method comprising:
encoding point cloud data; and
transmitting a bitstream containing the encoded point cloud data,
wherein the encoding of the point cloud data comprises:
encoding a geometry of the point cloud data; and
encoding an attribute of the point cloud data.

2. The method of claim 1, wherein the encoding of the point cloud data further comprises:
projecting at least one point of the point cloud data;
wherein the projection comprises:
converting coordinates of the point presented in a first coordinate system into a second coordinate system; and
projecting the point based on the coordinates of the point converted to the second coordinate system.

3. The method of claim 2, wherein at least one of the coordinates is presented as an azimuthal angle in the second coordinate system,
wherein the projection further comprises:
adjusting the azimuthal angle of the point,
wherein the adjustment comprises:
adjusting the azimuthal angle of the point based on azimuthal angles of a laser.

4. The method of claim 3, wherein the first coordinate system comprises a Cartesian coordinate system,
wherein the second coordinate system comprises at least one of a spherical coordinate system, a cylindrical coordinate system, or a fan-shaped coordinate system.

5. The method of claim 3, wherein the adjustment comprises:
adjusting the azimuthal angle of the point to an azimuthal angle of the laser having a value closest to the azimuthal angle of the point.

6. The method of claim 3, wherein the adjustment comprises:
based on the azimuthal angle of the point being greater than an average of k−1-th and k-th azimuthal angles of the laser and less than an average of k-th and k+1-th azimuthal angles of the laser, adjusting the azimuthal angle of the point to the k-th azimuthal angle of the laser.

7. A device for transmitting point cloud data, the device comprising:
an encoder configured to encode point cloud data; and
a transmitter configured to transmit a bitstream containing the encoded point cloud data,
wherein the encoder comprises:
a geometry encoder configured to encode a geometry of a point of the point cloud data; and
an attribute encoder configured to encode an attribute of the point of the point cloud data.

8. The device of claim 7, wherein the encoder further comprises:
a projector configured to project the point of the point cloud data;
wherein the projector is configured to:
convert coordinates of the point presented in a first coordinate system into a second coordinate system; and
project the point based on the coordinates of the point converted to the second coordinate system.

9. The device of claim 8, wherein at least one of the coordinates is presented as an azimuthal angle in the second coordinate system,
wherein the projector adjusts the azimuthal angle of the point based on azimuthal angles of a laser.

10. The device of claim 9, wherein the projector adjusts the azimuthal angle of the point to an azimuthal angle of the laser having a value closest to the azimuthal angle of the point.

11. The device of claim 9, wherein, based on the azimuthal angle of the point being greater than an average of k−1-th and k-th azimuthal angles of the laser and less than an average of k-th and k+1-th azimuthal angles of the laser, the projector adjusts the azimuthal angle of the point to the k-th azimuthal angle of the laser.

12. A method of receiving point cloud data, the method comprising:
receiving a bitstream containing point cloud data; and
decoding the point cloud data,
wherein the decoding of the point cloud data comprises:
decoding a geometry of a point of the point cloud data; and
decoding an attribute of the point of the point cloud data,

13. The method of claim 12, wherein the decoding of the point cloud data further comprises:
projecting the point of the point cloud data,

14. The method of claim 13, wherein the projection comprises:
converting coordinates of the point presented in a first coordinate system into a second coordinate system; and
projecting the point based on the coordinates of the point converted to the second coordinate system,
wherein at least one of the coordinates is presented as an azimuthal angle in the second coordinate system.

15. The method of claim 14, wherein the first coordinate system comprises a Cartesian coordinate system,
wherein the second coordinate system comprises at least one of a spherical coordinate system, a cylindrical coordinate system, or a fan-shaped coordinate system.

16. The method of claim 14, wherein the projection comprises:
adjusting the azimuthal angle of the point based on azimuthal angles of a laser.

17. The method of claim 14, wherein the projection comprises:
adjusting the azimuthal angle of the point to an azimuthal angle of the laser having a value closest to the azimuthal angle of the point.

18. The method of claim 14, wherein the projection comprises:
based on the azimuthal angle of the point being greater than an average of k−1-th and k-th azimuthal angles of the laser and less than an average of k-th and k+1-th azimuthal angles of the laser, adjusting the azimuthal angle of the point to the k-th azimuthal angle of the laser.

19. A device for receiving point cloud data, the device comprising:
a receiver configured to receive a bitstream containing point cloud data; and
a decoder configured to decode the point cloud data,
wherein the decoder comprises:
a geometry decoder configured to decode a geometry of the point cloud data; and
an attribute decoder configured to decode an attribute of the point cloud data,

20. The device of claim 19, wherein the decoder further comprises:
a reprojector configured to project a point of the point cloud data,
wherein the reprojector is configured to:
convert coordinates of the point presented in a first coordinate system into a second coordinate system; and
project the point based on the coordinates of the point converted to the second coordinate system,
wherein at least one of the coordinates is presented as an azimuthal angle in the second coordinate system.

21. The device of claim 20, wherein the reprojector adjusts the azimuthal angle of the point based on azimuthal angles of a laser.

22. The device of claim 21, wherein the reprojector adjusts the azimuthal angle of the point to an azimuthal angle of the laser having a value closest to the azimuthal angle of the point.

23. The device of claim 21, wherein, based on the azimuthal angle of the point being greater than an average of k−1-th and k-th azimuthal angles of the laser and less than an average of k-th and k+1-th azimuthal angles of the laser, the reprojector adjusts the azimuthal angle of the point to the k-th azimuthal angle of the laser.
